(19) United States
(12) Patent Application Publication
(10) Pub. No.: US 2018/0300433 A1
(43) Pub. Date: Oct. 18, 2018

(54) COMPUTER AIDED DESIGN SYSTEM FOR MODULAR WALL DESIGN AND MANUFACTURING

(71) Applicant: Emagispace, Inc., Larkspur, CO (US)

(72) Inventors: Clark Leroy Maxam, Larkspur, CO (US); Noel Roger Maxam, Los Angeles, CA (US)

(21) Appl. No.: 15/936,795

(22) Filed: Mar. 27, 2018

Related U.S. Application Data
(60) Provisional application No. 62/485,200, filed on Apr. 13, 2017.

(51) Int. Cl. G06F 17/50; G06T 17/10; G06T 15/08; G06T 19/00

(52) U.S. Cl. CPC G06F 17/5004; G06T 17/10; G06F 2217/12; G06T 19/006; G06T 15/08

(57) ABSTRACT

Computer aided design systems and methods are disclosed. A computer aided design (CAD) system provide a user interface comprising a wall drawing tool, a window module placement tool, a door unit placement tool, and a working area. A user selection of the wall drawing tool is detected. A user start wall indication provided at a first coordinate and a user end wall indication provided at a second coordinate are detected, and a wall is drawn between the first and second coordinates. A wall height and dimensional information for pre-defined wall module types having different dimensions are accessed. Selection and position determinations of wall module types are performed. A rendering of an assembly for the wall is generated indicating the position of the selected module-types used to form the drawn wall.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field of the Invention

The present invention is generally related to computer aided design of physical structures.

### Description of the Related Art

Conventional computer aided design systems aid in the complex process of design physical structures, such as buildings, houses, and walls. However, such conventional systems lack the ability to adequately simply the process of designing structures using modular components while reducing material waste.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An aspect of this disclosure relates to systems and methods that provide computer aided design of structures (e.g., walls, structures that incorporate walls, etc.). An aspect of the disclosure relates to computer aided design systems and methods that facilitate the design of structures using predefined building modules and/or customized building modules. Optionally, building modules may be configured to removably interconnect one with another. Optionally, the modules may be of predefined dimensions and/or may be of customized dimensions.

An aspect of this disclosure relates to a computer-implemented method of designing a structure, the method comprising: providing, by a computer aided design (CAD) system comprising hardware, a user interface (e.g., comprising: a wall drawing tool, a window module placement tool, a door unit placement tool, and a working area); detecting a user selection of the wall drawing tool; detecting a user start wall indication provided at a first coordinate in the work area; detecting a user end wall indication provided at a second coordinate in the work area; causing a wall to be drawn in the work area between the first coordinate and the second coordinate; accessing a wall height; accessing dimensional information for a plurality of pre-defined wall module types having predefined dimensions, including a first wall module type having a first length and a second wall module type having a second length; selecting and determining positioning of one or more wall module types from the pre-defined wall module types to provide a model of an assembly of the wall with the accessed wall height; generating a rendering of the model of the assembly for the wall, the rendering of the model of the assembly indicating the position of the selected module-types used to form the drawn wall; generating a parts list comprising a quantity of each of the selected module-types; and enabling the parts list to be utilized to package and ship parts in the parts list.

An aspect of this disclosure relates to computer-implemented method of designing a structure, the method comprising: providing, by a computer system comprising hardware, a user interface comprising: a wall drawing tool; a working area; detecting a user selection of the wall drawing tool; detecting a user start wall indication provided at a first coordinate in the work area; detecting a user end wall indication provided at a second coordinate in the work area; causing a wall to be drawn between the first coordinate and the second coordinate; accessing a wall height; accessing dimensional information for a plurality of pre-defined wall module types having predefined dimensions, including a first wall module type having a first length and a second wall module type having a second length; selecting and determining positioning of one or more wall module types from the pre-defined wall module types to provide a model of an assembly of the drawn wall with the accessed wall height; generating a drawing of the model of the assembly for the drawn wall, the drawing of the model of the assembly indicating the position of the selected module-types used to form the drawn wall; and generating a parts list comprising a quantity of each of the selected module-types.

An aspect of this disclosure relates to a system comprising: at least one computing device; non-transitory memory that stores program instructions that when executed by the at least one computing device cause the same system to perform operations comprising; provide a user interface comprising: a wall drawing tool; a working area; detect a user selection of the wall drawing tool; detect a user drawing of a wall within the working area utilizing the wall drawing tool and cause the wall to be rendered within the working area; access a wall height; select one or more wall module types from a plurality of wall module types having one or more different dimensions and determine positioning of the selected wall module types; generate a rendering of the wall utilizing the selected wall module types and determined wall module positions; and generate a parts list comprising a quantity of each of the selected module-types.

An aspect of this disclosure relates to a CAD system configured to provide a user interface comprising a structure drawing tool and a working area. The CAD system is further configured to detect a user selection of the structure drawing tool, detect a user drawing of a structure within the working area utilizing the structure drawing tool and cause the structure to be rendered within the working area. The CAD system determines, at least in part, which module types are to be used to form the structure. The CAD system is configured to determine positioning of the selected module types. Optionally, the CAD system is configured to generate a rendering of the structure (or a portion thereof) utilizing the selected module types and determined module positions. Optionally, the CAD system is configured to generate a parts list comprising a quantity of respective selected module-types. The structure may optionally comprise one or more walls.

### BRIEF DESCRIPTION OF THE DRAWINGS

Embodiments will now be described with reference to the drawings summarized below. Throughout the drawings, reference numbers may be re-used to indicate correspondence between referenced elements. The drawings are provided to illustrate example embodiments described herein and are not intended to limit the scope of the disclosure.

FIGS. 1-36B illustrate various example modular components and example structures assembled using such modular components.

FIG. 37A is a block diagram illustrating an example embodiment of an operating environment including a computer aided design system.

FIG. 37B is a block diagram illustrating an embodiment of example components of a computing system capable of providing computer aided design services.

FIGS. 38A-38L-t illustrate example user interfaces.

FIGS. 39A-39I are example flow diagrams illustrating embodiments of routines implemented using the computer aided design system.

FIGS. 40A-40B are example wall designs that may be evaluated by an example optimization process.

### DESCRIPTION

Systems and methods are described that provide computer aided design of structures, such as walls and structures that incorporate walls. An aspect of the disclosure relates to computer aided design systems and methods that facilitate the design of structures using predefined building modules. The building modules may be configured to removably interconnect one with another. Optionally, the modules may be of predefined dimensions and/or may be customized.

Non-limiting examples of such building modules, related components and assembly techniques are disclosed in U.S. Pat. No. 8,756,867 (issued Jun. 24, 2014), U.S. Pat. No. 9,220,995 (issued Dec. 29, 2015), and U.S. patent application Ser. No. 15/357,107 (filed Nov. 21, 2016) and Ser. No. 14/962,959 (filed Dec. 8, 2015), the contents of which are incorporated by reference herein in their entirety.

Further, the disclosed computer aided design systems and methods may be configured to automatically determine which and how many modules are needed to build a structure defined by a user in an efficient manner to reduce the amount of modules needed, thereby reducing waste product, pollution, and material costs. Still further, the disclosed computer aided design systems and methods may further be configured to automatically determine how to efficiently pack building modules and related components for shipment. Yet further, the disclosed computer aided design systems and methods may further be configured to generate human and/or machine readable manufacturing instructions, parts lists, sale documents, and to facilitate inventory control. Still further, the computer aided design systems and methods may be configured to facilitate the design and construction of stable and safe structures, such as walls with window and/or door units.

For example, the disclosed computer aided design systems and methods may optionally be utilized to design structures using some or all of the following example building modules and components, and variations thereof, as wells as other types of modules and components.

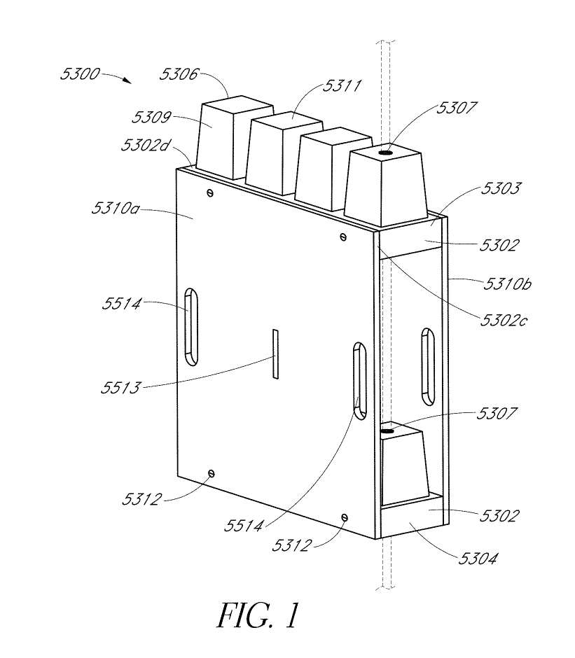

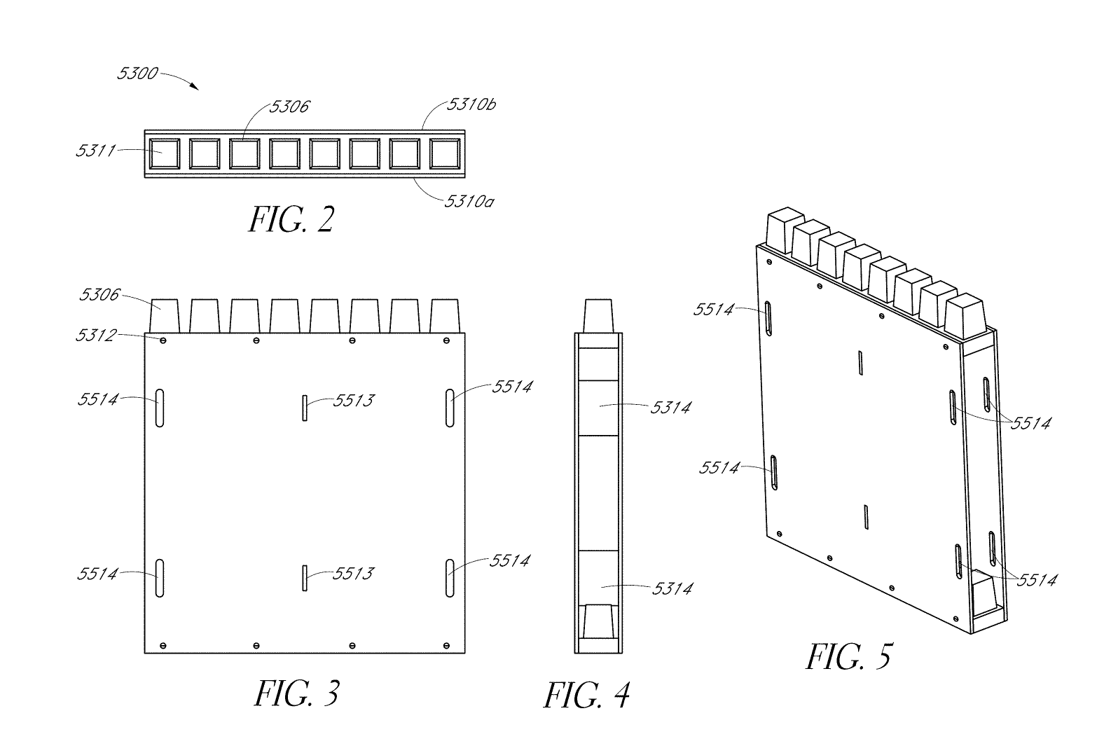

FIG. 1 illustrates aspects of an example wall module 5300, which may be of varying sizes and configurations. FIGS. 2, 3, 4, 5, are a top view, front view, side view, and isometric view, respectively, of the embodiment of the wall module 5300 illustrated in FIG. 1. FIG. 6 is an exploded assembly view of the embodiment of the wall module 5300 illustrated in FIG. 1. In any embodiments, the wall module 5300 in FIG. 1 can have the same features and components, but can have a varying size and a varying number of connector members. For example, the wall module embodiment 5300 illustrated in FIG. 1 can be approximately 1.5 feet by approximately 1.5 feet, approximately 3 feet tall by 1.5 feet wide, approximately 3 feet tall by 3 feet wide, approximately 8 feet tall by 10 feet wide, or approximately 10 feet tall by 10 feet wide. Additionally, any wall module embodiments disclosed herein can have any of the combination of the foregoing sizes, or any other desired size either greater than or less than the aforementioned ranges. By way of further example, a given wall module or support element may have 1, 2, 3, 4, 5, 6, 7, 8, 9, or other number of connector members. The components, including the panels, disclosed herein can optionally be comprises of water-resistant or waterproofed materials for use in wet, exterior environments. The components (e.g., support members, clips, plates, brackets, caps, and/or other components disclosed herein) described herein may be formed from metal, such a steel or aluminum, (e.g., using a stamping process), plastic, such as acrylonitrile butadiene styrene (ABS) plastic (e.g., using an injection molding process), carbon fiber (e.g., using prepreg technology (autoclave curing), 3D printing resin infusion, vacuum bag and/or manual laminating), wood (e.g., medium-density fibreboard (MDF)), plastic or other composite material (e.g., plastic laminated MDF), fiberglass, and any combination thereof.

The wall module 5300 can have a support member 5302, one or more connector members 5306, and one or more cover members 5310 (also referred to herein as panels or panel members) supported by the support member 5302. The support member 5302 and the connector members may be integrally formed as a single component. The support member 5302 can have an upper or first support element 5303 positioned at an upper or first end of the module 5300 and a lower or second support element 5304 positioned at a lower or second end of the module 5300. A given support member 5302 (including its connector members) may optionally be hollow or may be solid. A given connector member may have an orifice and passageway 5307 via which cables, conduit, piping, and/or poles may be routed. For example, the cables may be electrical cables, the piping may be for liquids, and the poles may be configured to support a roof member, such as a tarp, over one or more wall modules (e.g., over wall modules assembled to form a two, three, or four walled room or stall). Any number of connector members 5306 can be used, depending on the size of the wall module, and the size and/or number of connector members 5306 can be used. For example, the wall module embodiment 5300 illustrated in FIG. 55 can have one connector member 5306, or from two to ten (or other number) connector members 5306. In some embodiments, the connector member 5306 can be positioned at both of the two end portions of the support member 5302. Additionally, a connector member 5306 can be positioned near the middle of the support member 5302.

The connector members 5306 can be configured to be supported by the support member 5302 on an upper surface or portion 5302a of the support member 5302. A given support member 5302 (including its connector members) may optionally be hollow or may be solid. As used in this disclosure, the term “hollow” has its ordinary meaning, which includes having a hole or empty space inside. As one example, a hollow connection member can have a recess that is substantially bounded on all sides but one. A given connector member may have an orifice and passageway 5307 via which cables, conduit, piping, and/or poles may be routed. For example, the cables may be electrical cables, the piping may be for liquids, and the poles may be configured to support a roof member, such as a tarp, over one or more wall modules (e.g., over wall modules assembled to form a two, three, or four walled room or stall). Any number of connector members 5306 can be used, depending on the size of the wall module, and the size and/or number of connector members 5306 can be used. For example, the wall module embodiment 5300 illustrated in FIG. 1 can have one connector member 5306, or from two to ten (or other number) connector members 5306. In some embodiments, the connector member 5306 can be positioned at both of the two end portions of the support member 5302. Additionally, a connector member 5306 can be positioned near the middle of the support member 5302.

The connector members 5306 may optionally have tapered walls 5309 with a flat or domed square or rectangular top surface 5311 and/or bottom surface or orifice to thereby facilitate the engagement of male and female connector members or support members. For example, the connector members 5306 may be in the form of a square based pyramid with a truncated top. Other shapes, such as a truncated or non-truncated cone or triangular based pyramid or other pyramidal frustum may be used for one or more of the connector members.

The connector members 5306 can be configured to be received within complementary sized openings 5308 formed in or positioned at a lower edge 5302 of the support member 5302 so that a plurality of support members 5302 can be interconnected to form a larger wall structure. In embodiments where the connector members 5306 of a support member are hollow, a support member can be used as either male support member or as a female support member, depending on whether the support member is installed so that its connector member protrusions are extending from the wall module 5300 (to be used as a male) or are extending into the interior of the wall module 5300 (to be used as a female connector member configured to receive a male connector member).

As with any of the embodiments described above, the support members 5302 can be used to support display panels (such as, but not limited to, cover members 5310), facades, or other aesthetic components. Further, any of the support members 5302 can have recesses, cuts, openings, weight relief features, or other similar features formed therein to reduce the weight of the support members without unacceptably compromising the stiffness of the support members.

Additionally, in any embodiments, any number of connector members 5306 can be positioned on or supported by one or more of the side surfaces 5302c of the support member 5302 so that the support members 5302 can be interconnected in a lateral direction as well to provide removable connections between a plurality of laterally arranged wall modules 5300. For example, openings can be formed in the side portions 5302c of any of the support members 5302, wherein the connector members 5306 can be slidably or otherwise removably supported within the openings. When it is desired to interconnect one or more wall modules 5300, one or more connector members 5306 can be inserted within the openings formed in an upper surface, lower surface, and/or either of the side surfaces of the support member 5302, to interconnect two or more wall modules. As noted above, the openings may be formed and defined by hollow connector members 5306 positioned to face the interior of the wall 5300. Advantageously, an assembled wall unit 5300 may be disassembled, and where the connector members 5306 are hollow, the support members 5302 may be stacked one on top of the other in nested fashion, where a given connector member of a support member is inserted into the bottom opening of a corresponding connector member of second support member and at least a portion of the support member nests within the second support member. The two or more of the support members, including the connector members 5306, may have the same configuration and dimensions and may be manufactured using the same mold or other fabrication machining.

Optionally, one or more floor support members can be used to support the wall structures in a vertical position or orientation, or at any suitable angular orientation. Optionally, the floor support members can engage or attach to the support members of any of the wall modules to provide a stable connection to the wall module. The floor support members can have a base portion that can be wider than a width of the wall modules, and can have a vertical portion that can overlap and/or engage with the support members. The vertical portions may form a slot in which the wall structures may rest. In addition or instead, the floor support members may be affixed to the wall structures using bolts, screws, rivets, and/or otherwise.

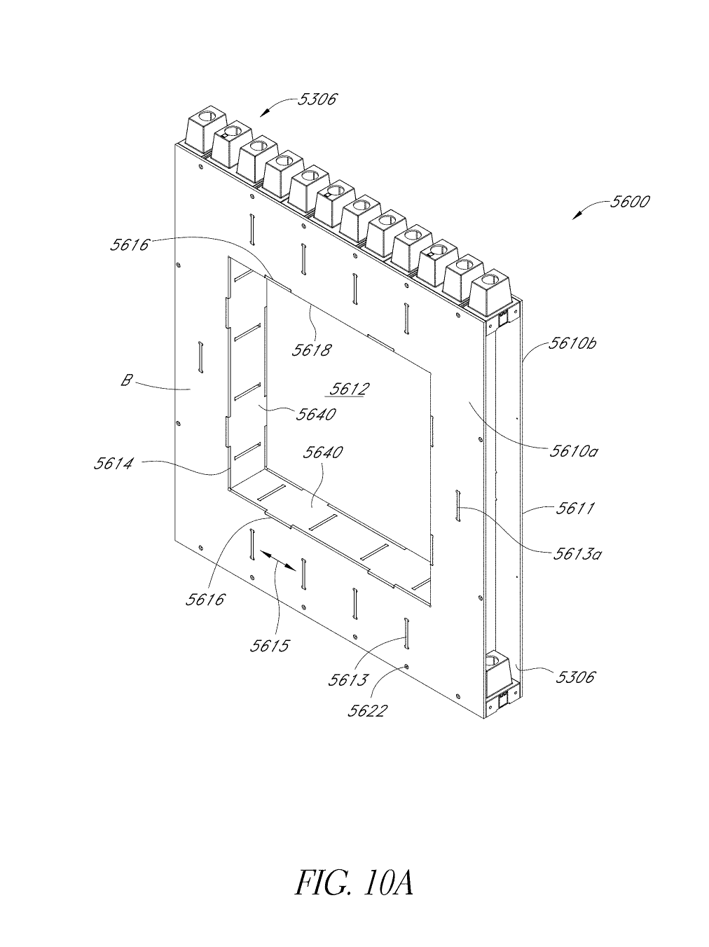

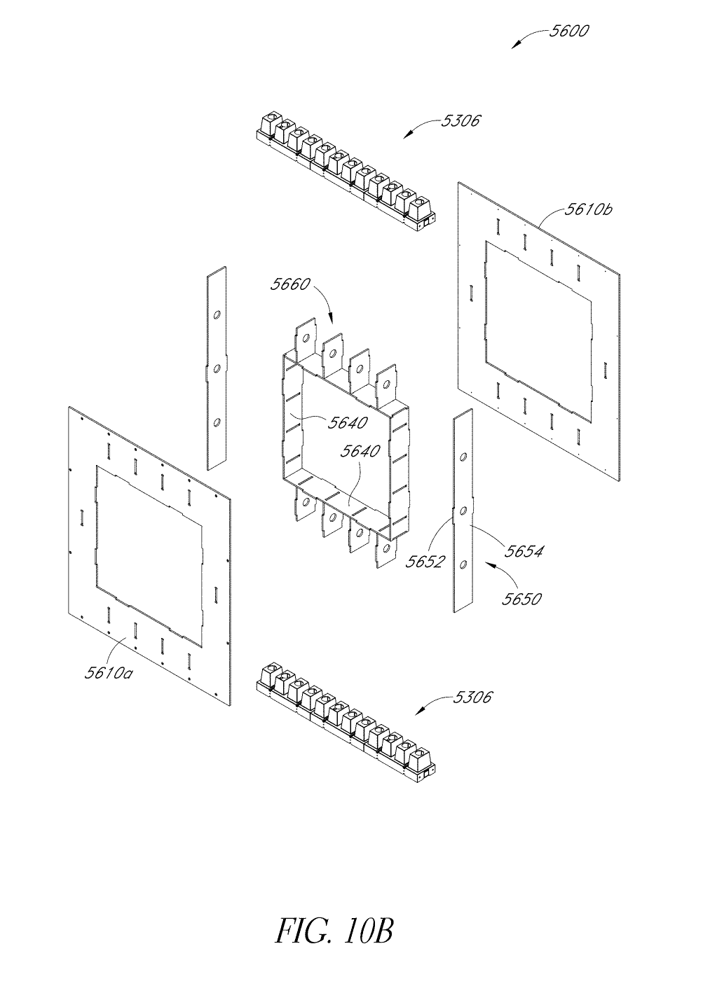

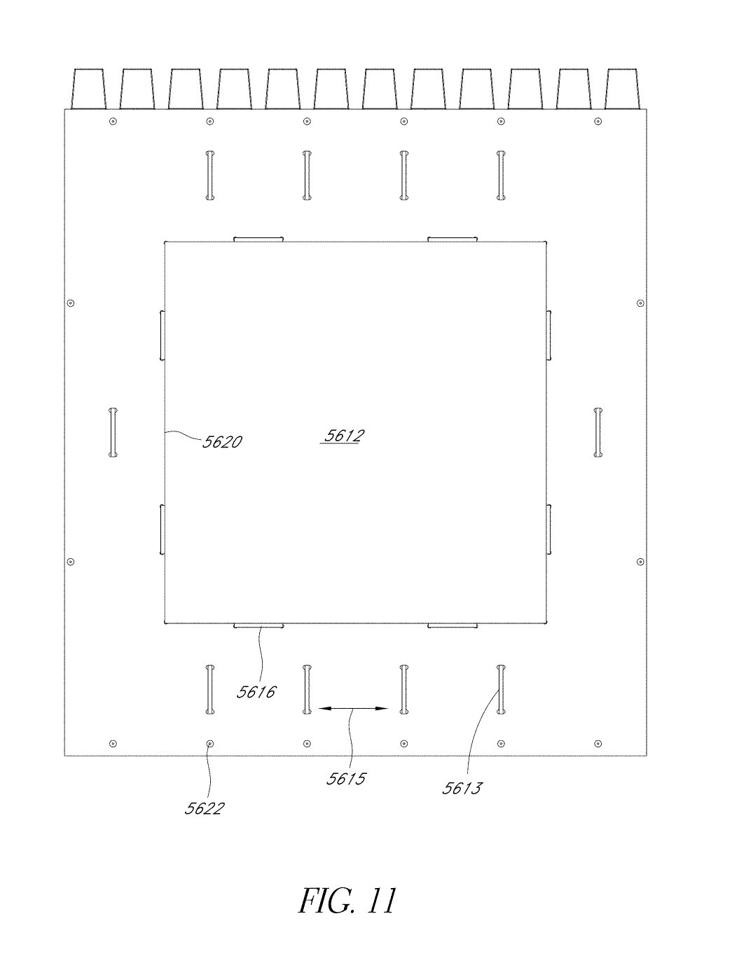

FIGS. 10A-12 illustrates an embodiment of a window module 5600, which can optionally be incorporated into a modular wall (not shown) constructed with one or more wall modules disclosed herein, such as wall modules 5300. As discussed further below, the window module 5600 includes a pair of panels 5610a, 5610b that can be interconnected by one or more internal support elements (e.g., rib members) 5660, one or more side panels 5650, and one or more frame members 5640 to form the assembled window module 5600. In one embodiment, the pair of panels 5610a, 5610b are substantially equal in size and shape (e.g., identical to each other). In the illustrated embodiment, each of the pair of panels 5610a, 5610b is monolithic (e.g., seamless).

In the illustrated embodiment, each of the panels 5610a, 5610b has an outer perimeter 5611 and an opening 5612 (e.g., central opening) defined by an inner perimeter 5614 of the panel 5610, 5610b. In the illustrated embodiment, the inner perimeter 5614 is defined by a pair of generally horizontal edges 5618 and a pair of generally vertical edges 5620. Optionally, the outer perimeter 5611 has a generally square shape. In other embodiments the outer perimeter 5611 can be generally rectangular. Optionally, the inner perimeter 5614 defines a square shaped opening 5612. In other embodiments the inner perimeter 5614 can be generally rectangular. The panels 5610a, 5610b can have a border (e.g., continuous border) B defined between the outer perimeter 5611 and the inner perimeter 5614. The generally horizontal edges 5618 and generally vertical edges 5620 can optionally have one or more recessed edge portions 5616 defined therein. In one embodiment, the outer perimeter 5611 can have a size of approximately 3 feet by approximately 3½ feet. However, the outer perimeter 5611 can have other suitable sizes such as approximately 3½ feet by approximately 4 feet. In one embodiment, the inner perimeter 5614 can have a size of approximately 2 feet by approximately 2 feet. However, the inner perimeter 5614 can have other suitable sizes.

Each panel 5610a, 5610b can have one or more openings 5613 (e.g., slot openings, slits). In one embodiment, the openings 5613 extend completely through the thickness t of the panels 5610a, 5610b. In another embodiment, the openings 5613 extend partially through the thickness t of the panels 5610a, 5610b. In the illustrated embodiment, the panels 5610a, 5610b have a plurality of openings 5613, with four openings on the bottom side, four openings on the top side, and one opening on each of the left and right sides of the panel 5610a, 5610b. However, the panels 5610a, 5610b can have other suitable number of openings 5613. In one embodiment, the openings 5613 can be spaced apart by a distance 5615. Optionally, the distance 5615 can be constant for openings 5613 on the bottom and/or top sides of the panel 5610a, 5610b, so that such openings 5613 are equidistant. In one embodiment, the distance 5615 can be approximately 6 inches, but can be shorter or longer than this in other embodiments. In another embodiment, the distance 5615 between openings 5613 can vary. Each panel 5610a, 5610b can optionally have one or more openings or apertures 5622 sized to receive a fastener (e.g., screw, nail) therethrough, for example to couple the two panels 5610a, 5610b together, as described further below.

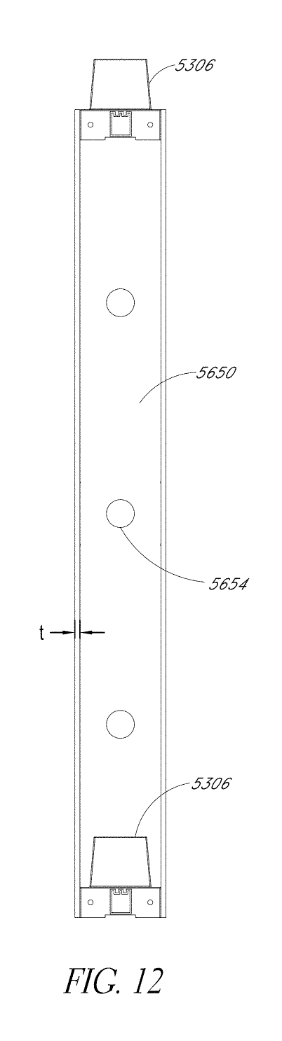

FIGS. 10B and 12 illustrate embodiments of an elongate side panel 5650 that can be coupled to the pair of panels 5610a, 5610b. in the illustrated embodiment, the window module 5600 has two elongate side panels 5650, each having a pair of tabs 5652 that can at least partially extend through slots 5613a in the panels 5610a, 5610b. The elongate side panel 5650 can also have one or more openings or apertures 5654 sized to receive conduits therethrough (e.g., for electrical wiring, etc.). In some embodiments, the apertures 5654 can align with apertures 5667 in the internal support elements 5660, as further discussed below.

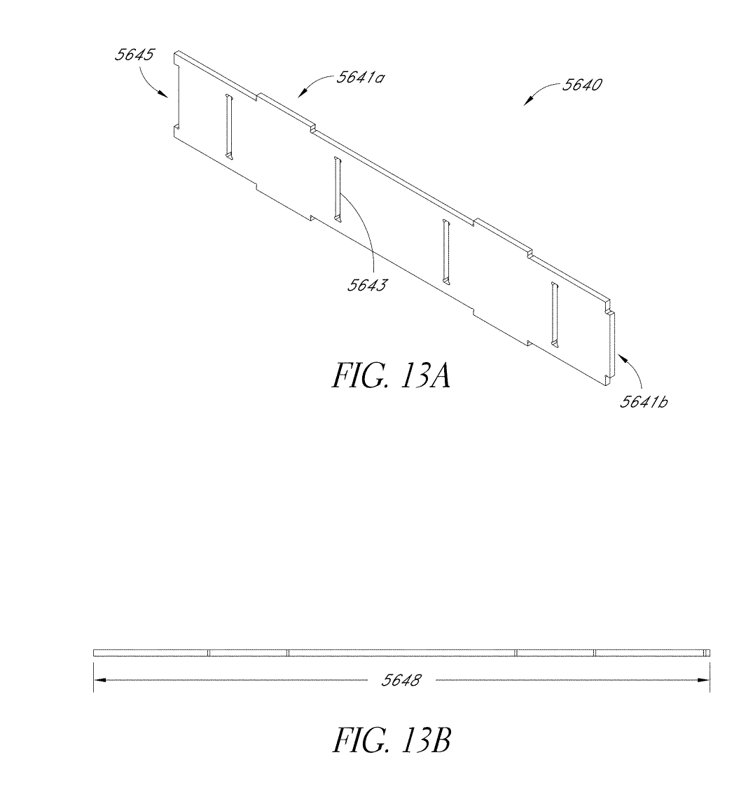

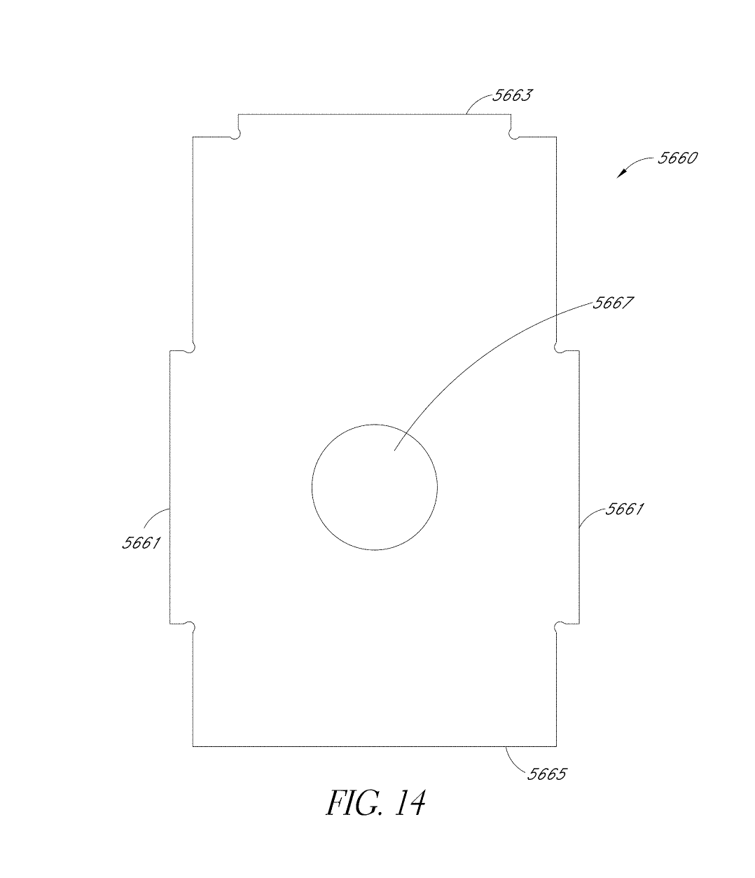

FIGS. 13a, 13b and 14 illustrate embodiments of a frame member 5640 and an internal support element 5660 that can be coupled to the pair of panels 5610a, 5610b to assemble the window module 5600. In some embodiments, a plurality of frame members 5640 and/or a plurality of internal support elements 5660 can couple the panels 5610a, 5610b.

The frame member 5640 can have a length 5648 that generally coincides with a length of the generally horizontal and vertical edges 5618, 5620. In one embodiment, the frame member 5640 can have a length of approximately 2 feet, a width of approximately 5 inches and a thickness of approximately ¼ inch. However, in other embodiments, the frame member 5640 can have other dimensions. The frame member 5640 can have one or more openings 5643 (e.g., slot openings, slits). In one embodiment, the openings 5643 are spaced apart by approximately the same amount as the distance 5615 between the openings 5613 in the panels 5610a, 5610b. The frame member 5640 can also have one or more protrusions or tabs 5641a on side edges thereof. A tab 5641b can be defined on one end and a recessed edge portion 5645 can be defined on an opposite end of the frame member 5640.

The internal support element 5660 can have one or more protrusions or tabs 5661 on side edges thereof, a protrusion or tab 5663 on an end thereof, and a straight edge 5665 on an opposite end of the internal support element 5660. An opening 5667 can extend through the body of the internal support element 5660. In one embodiment, the internal support member 5660 can have a height of approximately 7 inches, a width of approximately 5 inches and a thickness of approximately ¼ inch. However, the internal support member 5660 can have other dimensions. In one embodiment, the opening 5667 can be a circular opening with a diameter of approximately 1⅜ inches. However, the opening 5667 can have other suitable shapes and sizes.

In use, the panels 5610a can be positioned on a support surface (e.g., floor, table, etc.). One or more internal support elements 5660 can be coupled to the panel 5610a, by inserting one of the side tabs 5661 in a corresponding opening 5613 in the panel 5610a and such that the straight edge 5665 of the internal support element 5660 is aligned with an outer perimeter edge of the panel 5610a, and so that the tab 5663 of the internal support element 5660 is aligned with an inner perimeter edge of the panel 5610a. Similarly, internal support elements 5660 can be coupled to the panel 5610a by inserting side tabs 5661 in the openings 5613 along the bottom and top edges of the panel 5610a. The second panel 5610b can be placed over the panel 5610a, so that the internal support elements 5660 are interposed between the panels 5610a, 5610b and so that the side tabs 5661 on an opposite side of the internal support elements 5660 couple with the openings 5613 in the second panel 5610b. The openings 5667 of the internal support elements 5660 (e.g., once installed on the bottom and/or top sides of the panels 5610a, 5610b) are advantageously aligned and receive and support a conduit that is inserted through the openings 5667 (e.g., conduit carrying electrical cables, water line, etc.).

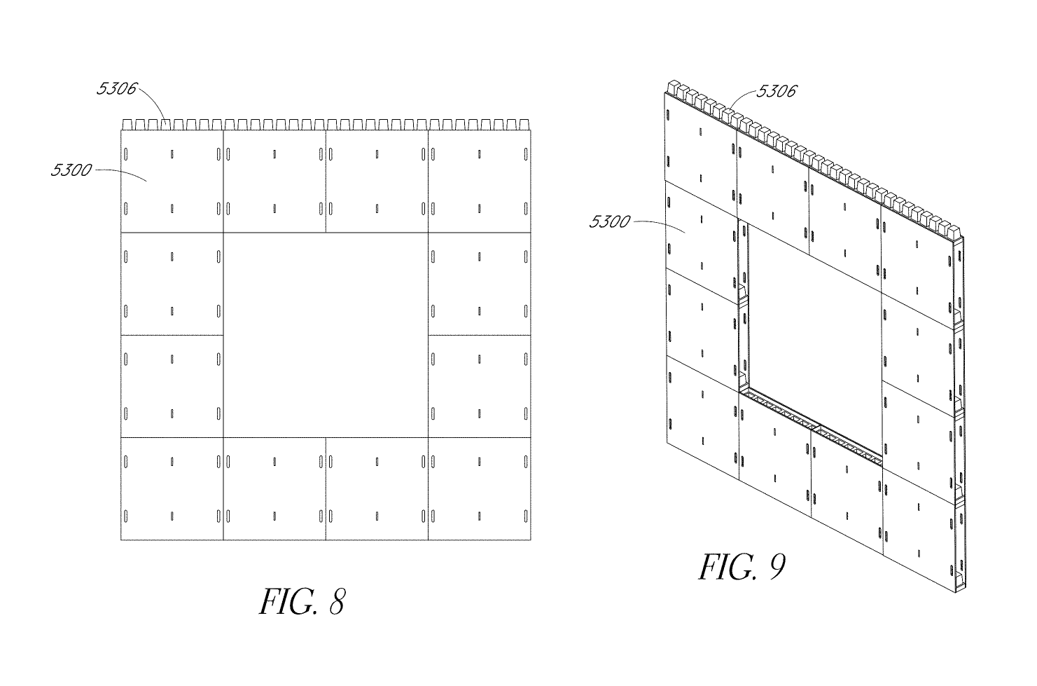

One or more connector members 5306 (see FIGS. 8-9) can be disposed between the panels 5610a, 5610b and coupled thereto (e.g., by inserting fasteners, such as screws, through the openings 5622 to couple the connector members 5306 to the panels 5610a, 5610b). As disclosed in other embodiments of this disclosure, the one or more connector members 5306 can be coupled to the top portion of the panels 5610a, 5610b such that at least a portion of the one or more connector members 5306 (e.g., the frustum portion of each connector member 5306) protrudes past the outer perimeter edge of the top of the window module 5600. Additionally, the one or more connector members 5306 can be coupled to the bottom portion of the panels 5610a, 5610b such that a bottom end of the connector members 5306 generally aligns with the outer perimeter edge of the bottom of the window module 5600. The connector members 5306 on the top and bottom of the assembled window module 5600 can advantageously allow the window module 5600 to be coupled to other wall modules, such as wall module 5300, in the manner described above.

The one or more frame members 5640 can be positioned between the panels 5610a, 5610b along the inner perimeter of the window module 5600. The openings 5643 of the frame member 5640 can couple to end tabs 5663 of the internal connector elements 5660. The side tabs 5641a of the frame member 5640 can couple to the recessed edge portions 5616 on the generally horizontal and vertical edges 5618, 5620 of the panels 5610a, 5610b. The frame members 5640 are also advantageously arranged in the inner perimeter of the panels 5610a, 5610b so that they interconnect with each other. In one embodiment, the end tab 5641b of one frame member 5640 (e.g., on a bottom edge of the window module 5600) can extend into the recessed edge portion 5645 of an adjacent frame member 5640 (e.g., on a vertical side edge of the window module 5600). Accordingly, the frame members 5640 once installed in the assembled window module 5600 define an inner window frame that can advantageously receive and support a preassembled window, thereby facilitating the process of assembling a window for use in a modular wall made of a plurality of wall modules, such as the wall modules 5300. Advantageously, the inner perimeter 5614 edges and frame members 5640 define substantially perpendicular angles to provide a substantially true shape that allows for easy installation and removal of the preassembled window from the window module 5600.

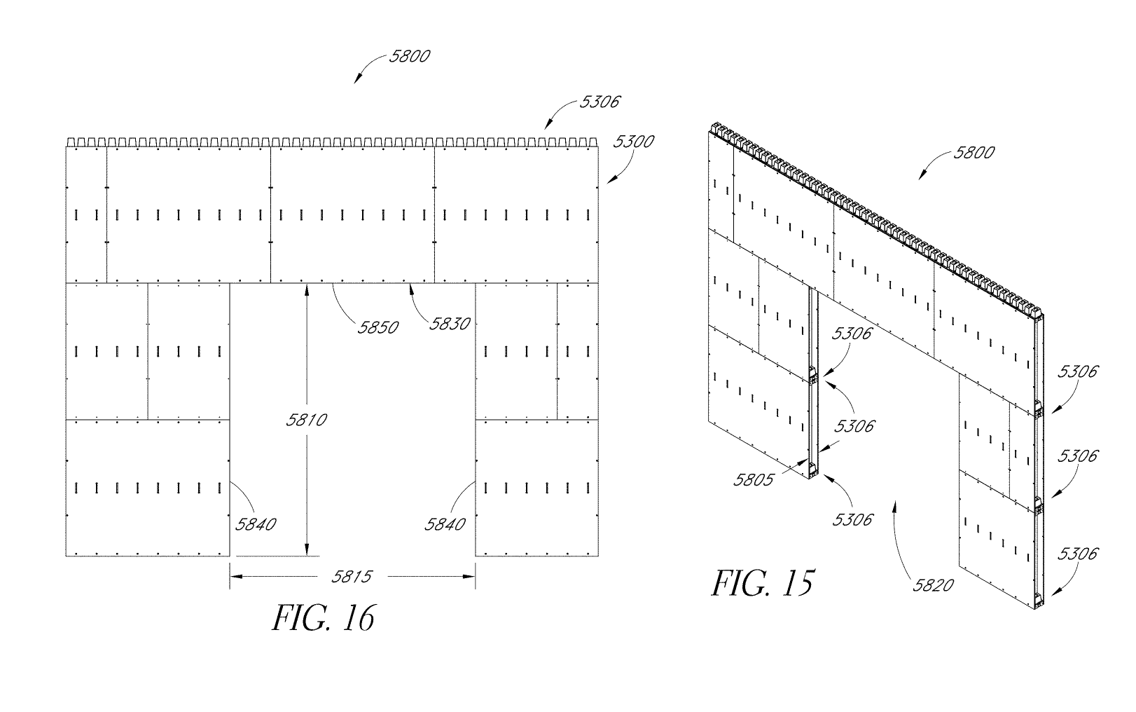

FIGS. 15-16 show one embodiment of a modular wall 5800 constructed of a plurality of wall modules as described herein, such as wall modules 5300 described above. The wall modules 5300 can be coupled at least in part via the connector members 5306, as discussed above. In the illustrated embodiment, the wall modules 5300 are coupled to define an opening 5820 having a depth 5805, a height 5810 and width 5815. In one embodiment, the height 5810 can optionally be about 80 inches. In one embodiment, the width 5815 can optionally be about 6 feet. In one embodiment, the depth 5805 can optionally be about 5 inches. However, the depth 5805, height 5810 and/or width 5815 of the opening 5820 can have other suitable values. The opening 5820 can advantageously receive and support a preassembled door frame and/or door, thereby facilitating the process of assembling a door for use in the modular wall 5800 made of a plurality of wall modules, such as the wall modules 5300. Advantageously, an inner perimeter 5830 of the opening 5820 and edges 5840, 5850 define substantially perpendicular angles to provide a substantially true shape for the opening 5820 that allows for easy installation and removal of the preassembled door from the opening 5820.

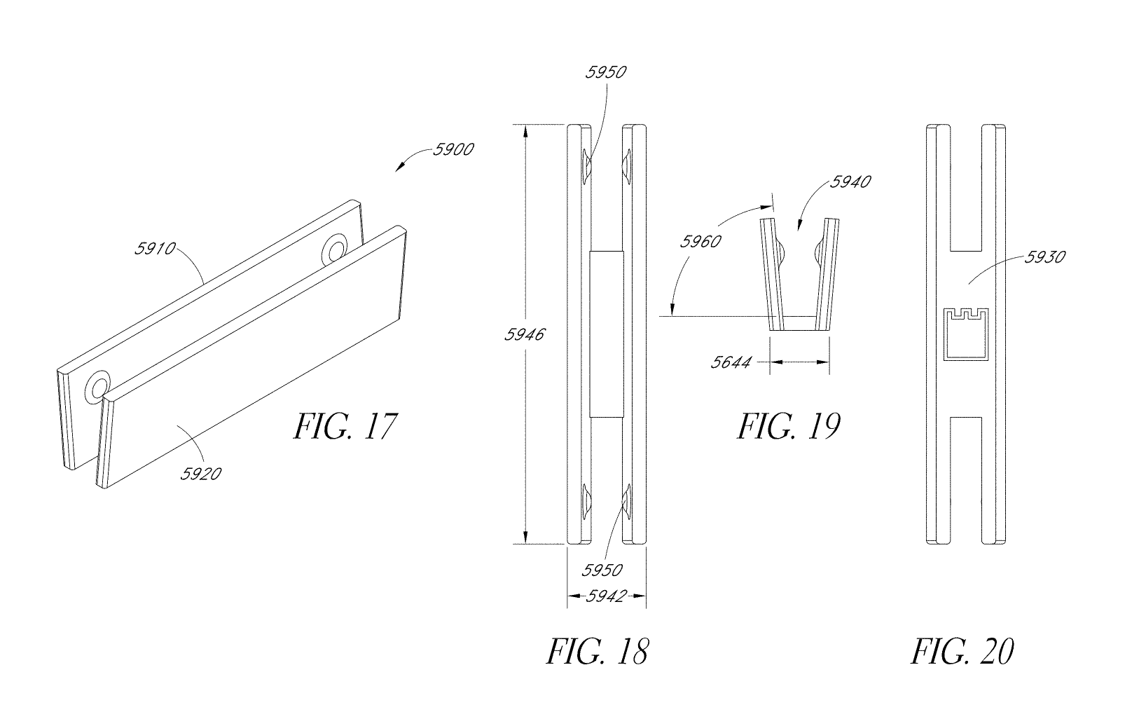

FIGS. 17-20 show one embodiment of a connector 5900 that can optionally be used to interconnect wall modules described herein, such as the wall modules 5300 described above. In the illustrated embodiment, the connector 5900 can be shaped like a clip (e.g., a butterfly clip).

The connector 5900 can have a first plate member (or wing) 5910 and a second plat member (or wing) 5920 that are interconnected by a base 5930. The plate members 5910, 5920 can be spaced apart from each other to define a channel 5940 therebetween. Optionally, one or both of the plate members 5910, 5920 can have one or more bumps or protrusions 5950 that extend into the channel 5940 from a surface of the plate members 5910, 5920. The plate members 5910, 5920 can optionally extend at an angle 5960 relative to each other. In one embodiment, the angle 5960 can be approximately 85 degrees. However, in other embodiments the plate members 5910, 5920 can extend at other suitable angles relative to each other that are larger or smaller than the value provided above. In still another embodiment, the plate members 5910, 5920 can be substantially parallel to each other.

In one embodiment, the connector 5900 can be made out of a resilient material that allows at least a portion of the connector 5900 to flex (e.g., when connecting wall modules, as described below). In some embodiments, the connector 5900 can be made of a plastic material. However, the connector 5900 can be made of other suitable materials. In some embodiments, the connector 5900 can have a length 5946 of about 3¾ inches, a width 5944 at its base of about 2 inches and a width 5942 at its open end of about 7/10 inches. However, the connector 5900 can have other suitable dimensions. In some embodiments, where the plate members 5910, 5920 are substantially parallel to each other, the width 5944 at the base and the width 5942 at the open end of the connector 5900 can be substantially the same.

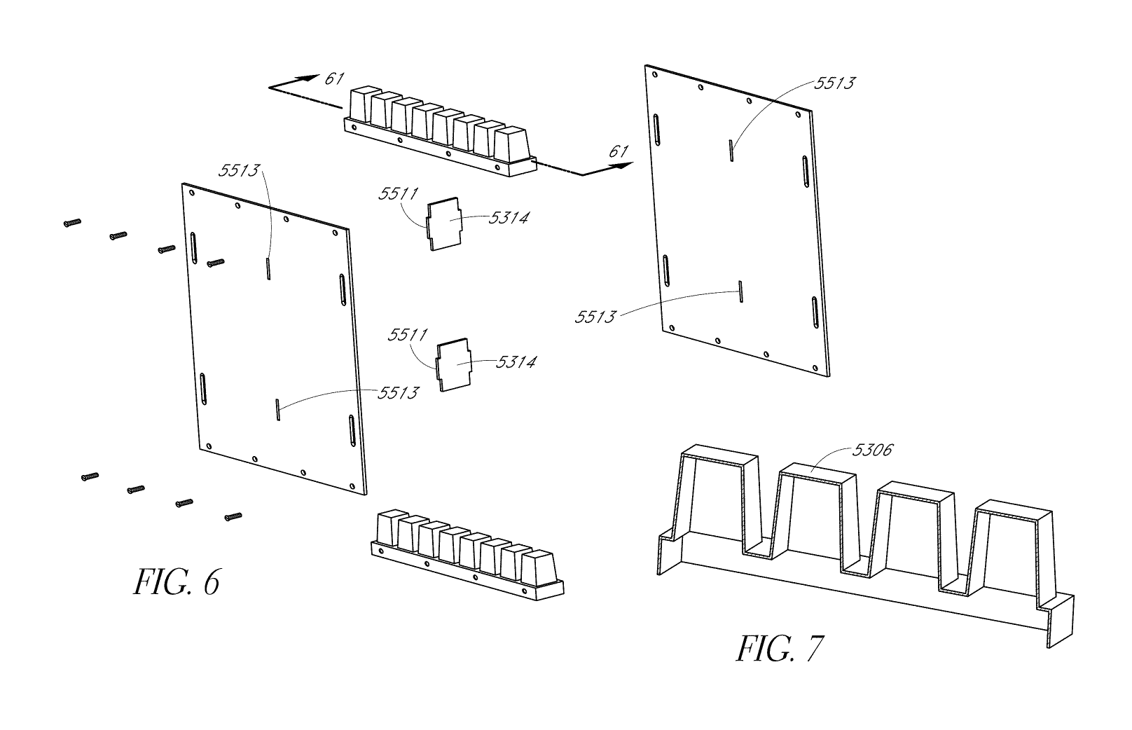

In use, wall modules described herein, such as the wall modules 5300 described above, can be coupled to define a larger structure, such as a wall. The connector 5900 allows for the coupling of adjacent side-by-side wall modules. In one embodiment, when two wall modules 5300 (see FIGS. 1-7) are side-by-side, the side edge 5305 of the support member (or base) 5302 of the connector members 5306 can be adjacent each other. The connector 5900 can be inserted over the adjacent side edges 5305 so that the side edges 5305 extend into the channel 5940. Optionally, the side edges 5305 can contact the one or more bumpers 5950, which can inhibit the disengagement of the connector 5900 from the side edges 5305. Optionally, the connector 5900 can be sized so that it resiliently flexes when the channel 5940 receives the adjacent side edges 5305 to securely couple the connector 5900 to the adjacent side edges 5305 and inhibit the disengagement of the connector 5900. Advantageously, the connector 5900 is low profile and extends into the connector members 5306 when coupled to the adjacent edges 5305 to inhibit protruding from the bottom of the wall modules 5300 in a way that would interfere with the stacking engagement of wall modules.

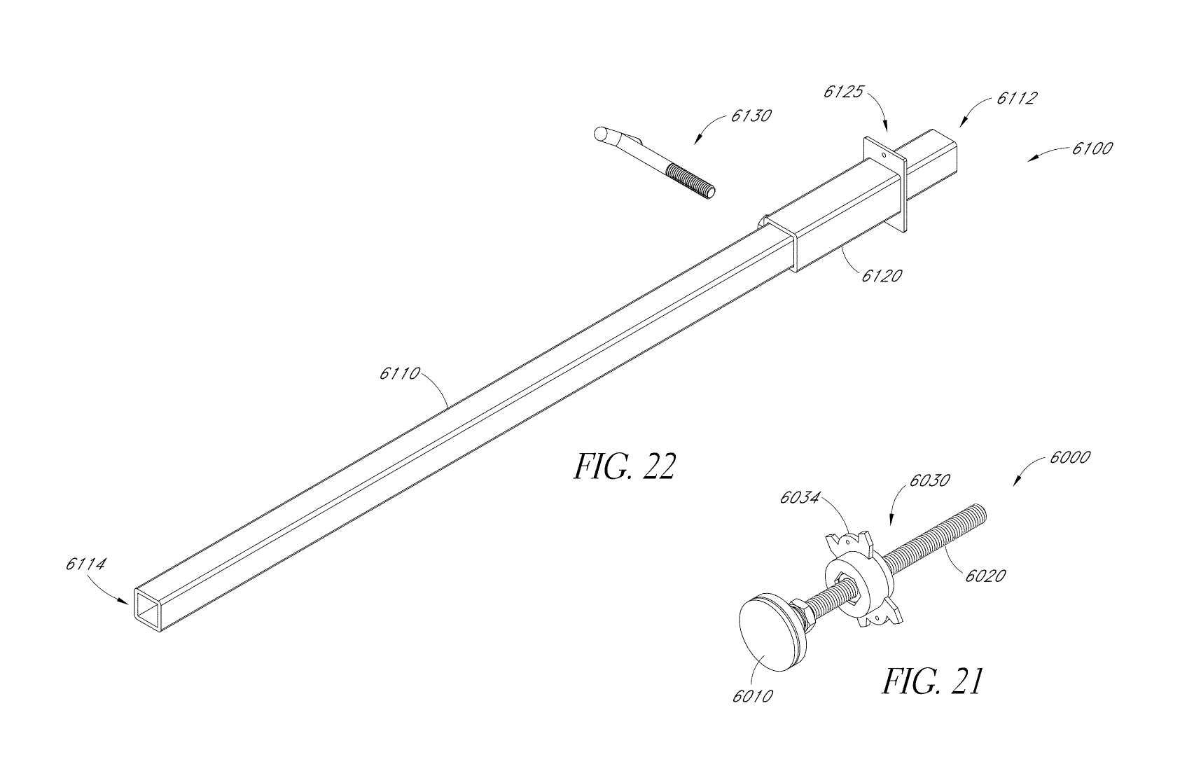

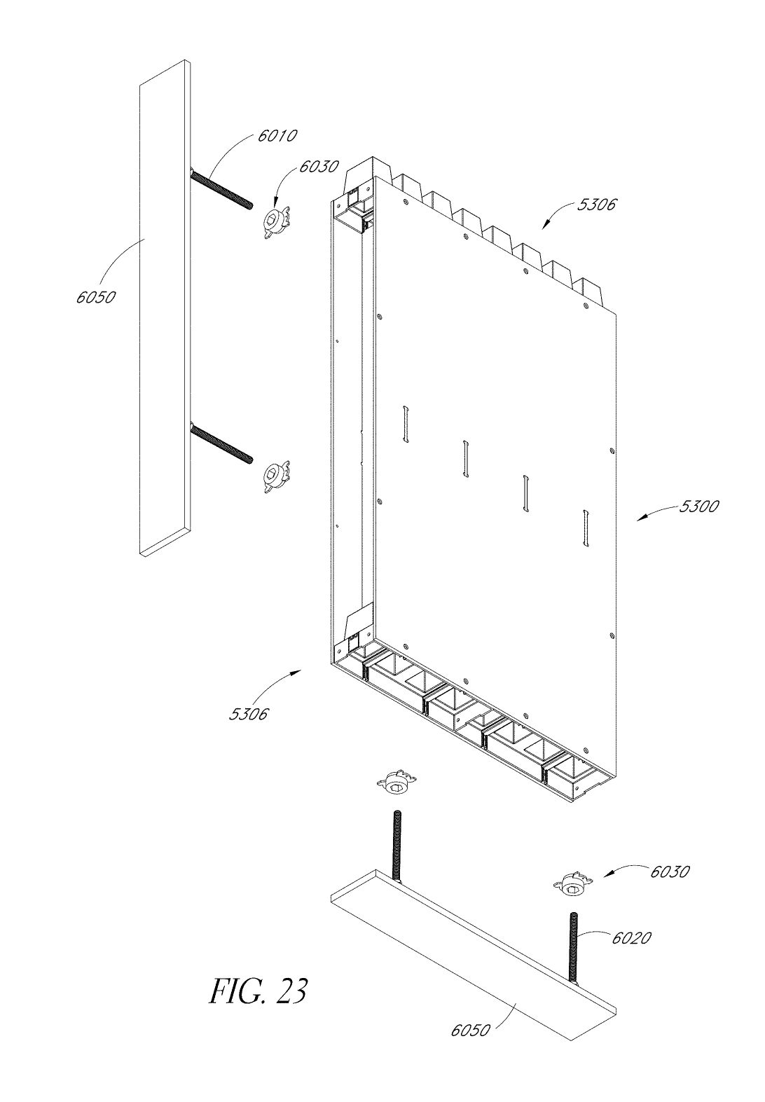

FIGS. 21, 23 show one embodiment of an extension member 6000 that can be coupled to a wall module as described herein, such as the wall module 5300 described above, to allow the wall module to span a vertical or lateral distance greater than provided by the panels 5310a, 5310b of the wall module 5300.

The extension member 6000 can have a head 6010 attached to a screw 6020, which can be threadably coupled to an insert 6030. The insert 6030 can have a pair of tabs or feet 6034 that extend laterally from a body of the insert 6030 in a direction generally perpendicular to an axis of the screw 6020. The distance between the head 6010 and the insert 6030 can be adjusted by screwing or unscrewing the insert 6030 along the screw 6020.

FIG. 23 shows a plurality of extension members 6000 attached to extension panels 6050. One extension panel 6050 can be coupled to a bottom of the wall module 5300 to optionally adjust a height of the wall module 5300 and another extension panel 6050 can be coupled to a side of the wall module 5300 to optionally adjust a width of the wall module 5300. The head 6010 of the extension members 6000 can couple to the extension panels 6050 in any suitable manner (e.g., adhesive, screws, etc.). The distance between the insert 6030 and the extension panels 6050 can be adjusted to provide the desired extension amount and then the inserts 6030 can be coupled to the wall module 5300. For example, in the extension panel 6050 that couples to the bottom of the wall module 5300, the screws 6020 can extend through the passageway or opening 5307 in connector members 5306 (see FIG. 1), and the tabs or feet 6034 of the inserts 6030 can be attached to a surface of the connector member 5306 (e.g., with fasteners, such as screws or nails). In the extension panel 6050 that couples to the side of the wall module 5300, the screws 6020 can extend through openings in interconnecting frame or rib members disposed between the panels 5310a, 5310b of the wall module 5300, and the tabs or feet 6034 of the inserts 6030 can be attached to a surface of the interconnecting frame or rib members (e.g., with fasteners, such as screws or nails).

The extension members 6000 advantageously allow for the height and/or width of a wall module, such as the wall module 5300, to be adjusted so that a modular wall constructed out of multiple wall modules 5300 can fit a room with a ceiling height or room width that is greater than the wall height or width that can be achieved with just coupling the wall modules 5300 together.

FIG. 22 shows another embodiment of an extension member 6100. The extension member 6100 can have an elongate tube 6110, a sleeve member 6120 that extends over the elongate tube 6110 so that the elongate tube 6110 can telescopingly engage the sleeve member 6120. A pin 6130 can be inserted through a hole or aperture (not shown) in the sleeve 6120 that is aligned with a hole or aperture not shown) in the elongate tube 6110 to couple the sleeve member 6120 to the elongate tube 6110 in a fixed position. The elongate tube 6110 can have a plurality of such holes or apertures along its length (e.g., equidistantly spaced apart holes), so that the elongate tube 6110 can fixedly couple to the sleeve 6120 as a plurality of locations that allow the distance that the elongate tube 6110 extends out of the sleeve 6120 to be varied.

The sleeve can have a flange 6125 that can facilitate the coupling of the extension member 6100 to a wall module, such as the wall module 6300. For example, the flange 6125 can be coupled (e.g., with one or more fasteners, such as screws, nails, etc.) to interconnecting frame or rib members disposed between the panels 5310a, 5310b of the wall module 5300, and one end 6112 of the elongate tube 6110 extending through an opening in the frame or rib members. The opposite end 6114 of the elongate tube 6110 can bear against a wall or extend through another wall module 5300. Optionally, the opposite end 6114 of the elongate tube 6110 can attach to an extension panel, similar to the extension panel 6050, that can bear against a wall or wall module 5300. In one embodiment, the extension member 6100 can be coupled to a wall module 5300 to increase a height and/or width of the wall module 5300, similar to the manner shown in FIG. 23.

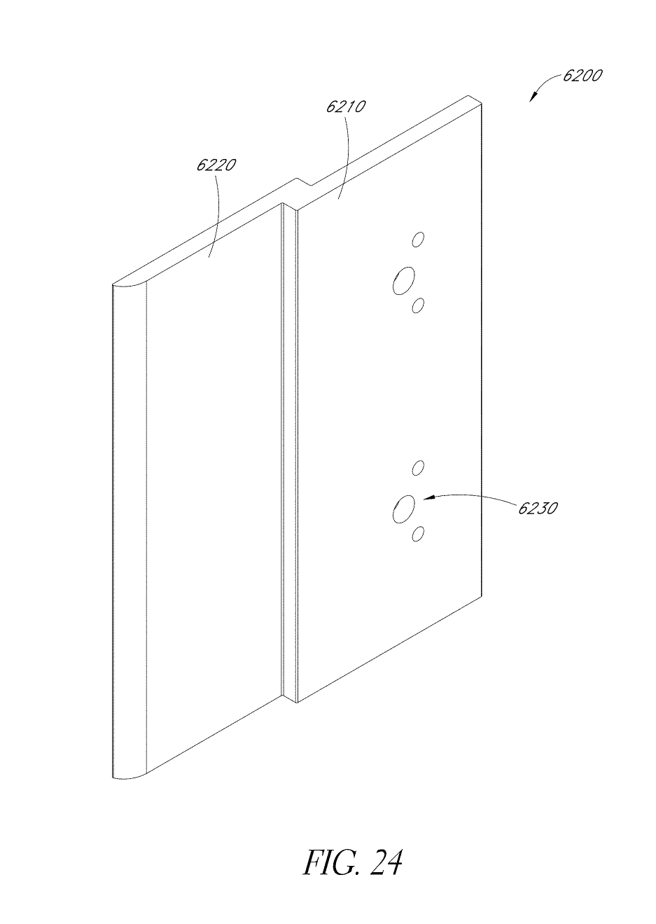

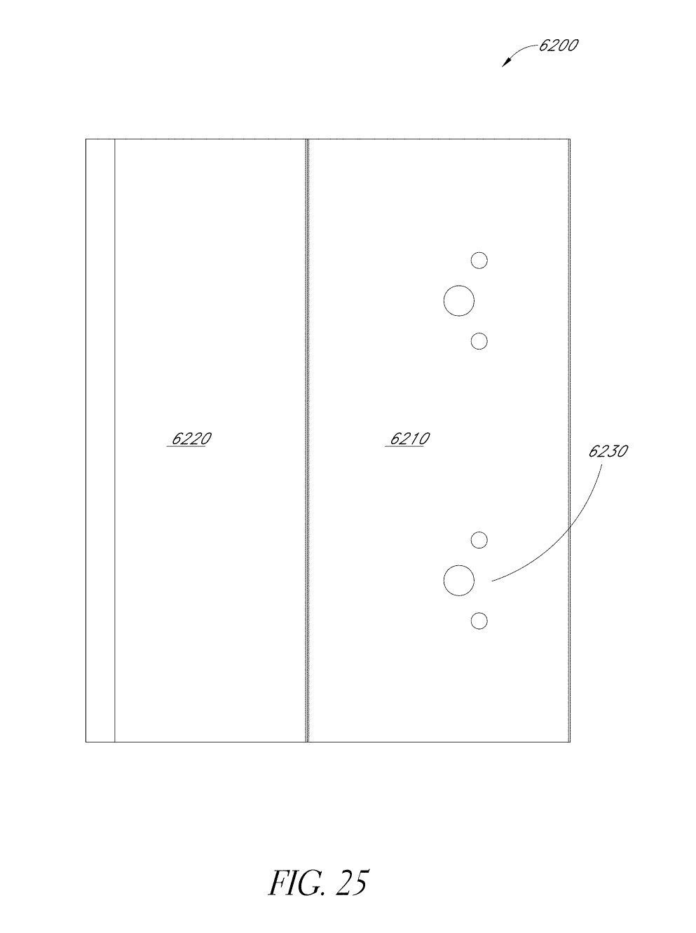

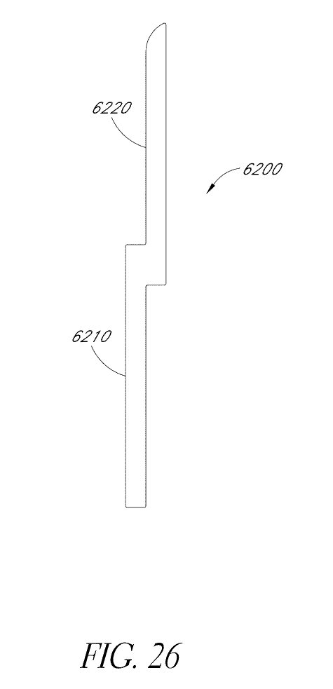

FIGS. 24-26 show a perspective view, top planar view and side view, respectively, of a connector 6200 that can be used to interconnect two wall modules, such as wall modules 5300 described above. The connector 6200 can be a cleat 6200 that can interconnect wall modules, such as the wall modules 5300. The cleat 6200 can have a stepped shape with a first planar portion 6210 and a second planar portion 6220 vertically offset relative to the first planar portion 6210. The cleat 6200 can also have one more apertures or openings 6230 that can receive one or more fasteners therethrough. The cleat 6200 can be made of metal or other suitable material (e.g., plastic).

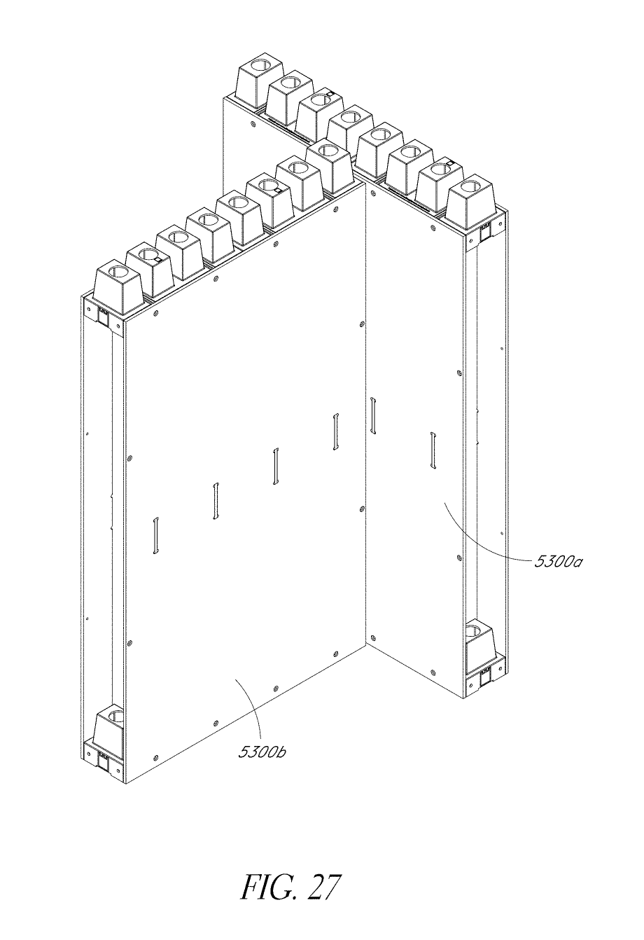

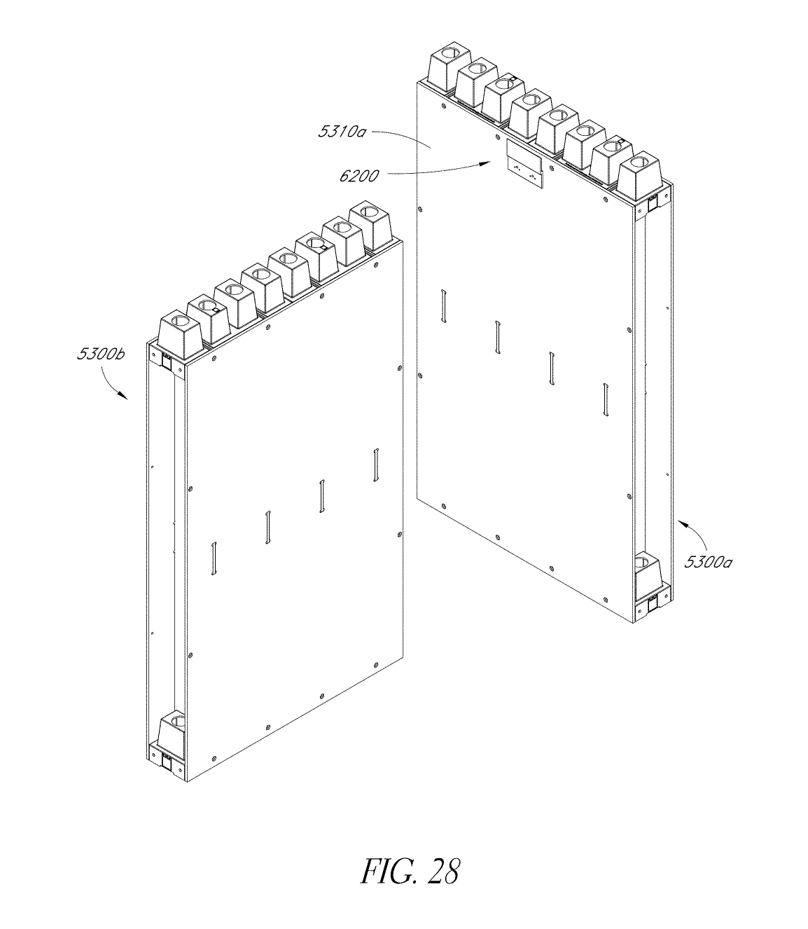

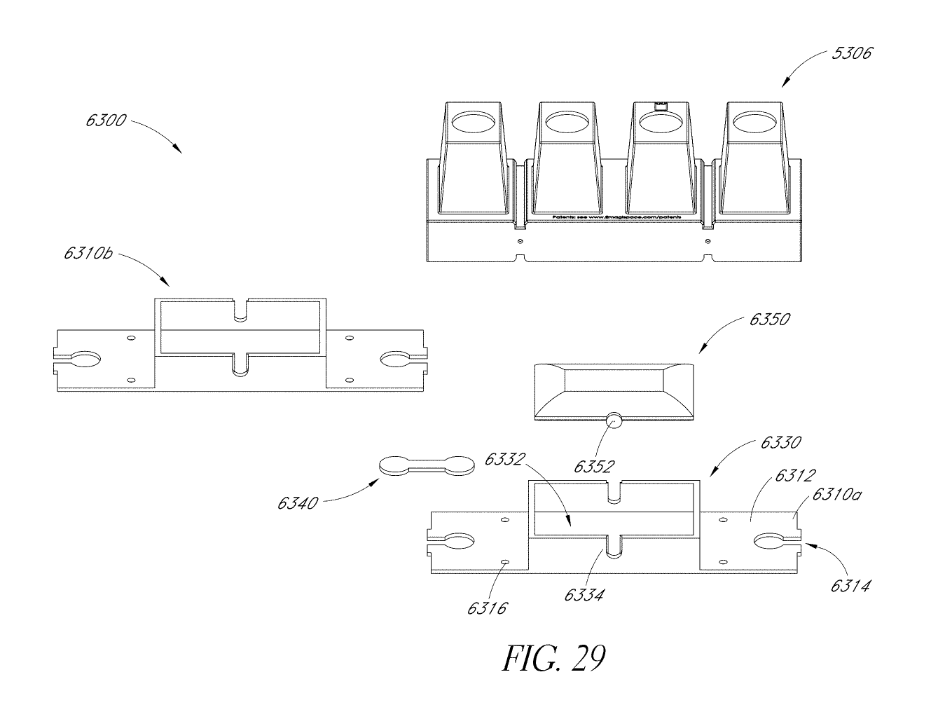

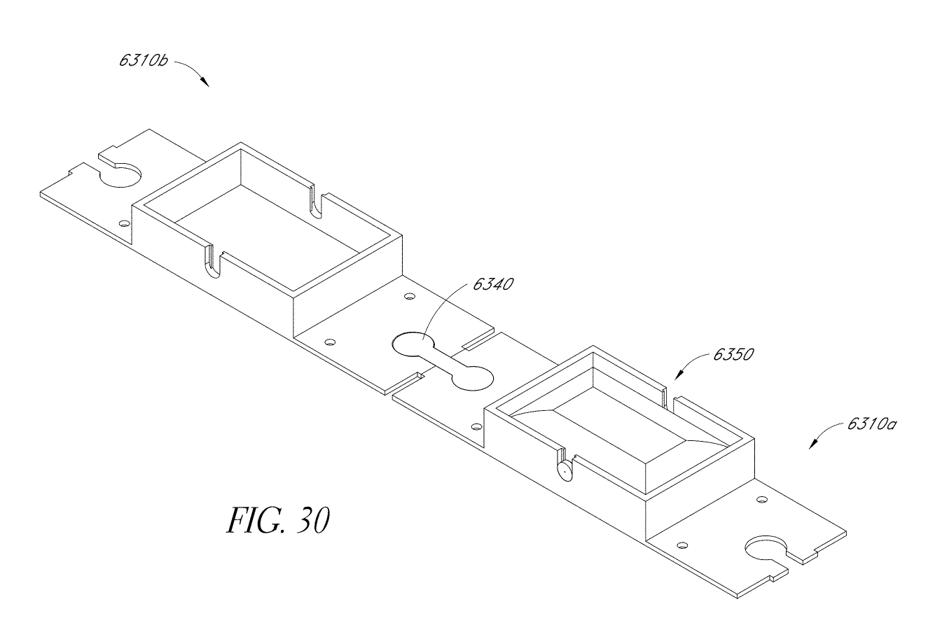

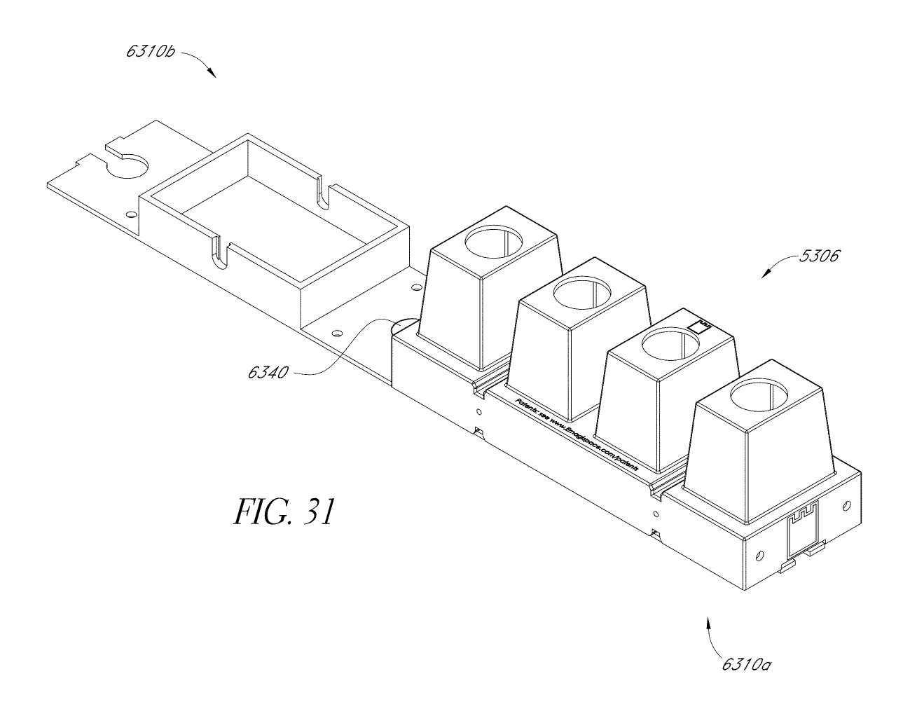

FIGS. 27-28 show two wall modules 5300A, 5300B interconnected at 90 degrees. As shown in FIG. 28, the cleat 6200 can be fastened to a panel 5310a of the wall module 5300A so that the second planar portion 6220 is offset from the panel 5310a so as to define a gap between the second planar portion 6220 and the panel 5310a. The wall module 5300B can be coupled to the wall module 5300A by inserting the second planar portion 6220 of the cleat 6200 under the end edge of the connector members 5306, such that the edge of the connector 5306 is in the gap between the second planar portion 6220 and the panel 5310a in order to fix the wall modules 5300A, 5300B together.

FIGS. 29-32 show one embodiment of a leveling assembly 6300 for wall modules, such as the wall modules 5300, to allow the wall modules to sit level on an uneven surface (e.g., on an uneven floor). The leveling assembly 6300 can include one or more leveling plates 6310. In the illustrated embodiment, two leveling plates 6310a, 6310b are shown. The leveling plate 6310 can have a planar base 6312 with openings 6314 at opposite ends of the planar base 6312. One or more apertures 6316 can be formed on the planar base 6312 to allow the leveling plates 6310a, 6310b to be coupled to a support surface (e.g., ground, floor).

The leveling plate 6310a, 6310b can have a raised wall 6330 that defines a cavity 6332 therein and one or more openings 6334 on the raised wall 6330. The cavity 6332 is sized to receive an expandable member 6350. In one embodiment, the expandable member 6350 can be a pneumatic bladder. In another embodiment, the expandable member 6350 can be a hydraulic bladder. The expandable member or bladder 6350 has a connector 6352 that can be received in the opening 6334 of the raised wall 6330. The connector 6352 can allow the expandable member or bladder 6350 to be expanded. In one embodiment, a pump (e.g., manually operated pump, motor operated pump) can be connected to the connector 6352 to inflate the expandable member or bladder 6350. In the illustrated embodiment, there are two leveling plates 6310a, 6310b side by side and one expandable member 6350 in one of the cavities 6332 of the two leveling plates 6310a, 6310b. However, in other embodiments, there can be an expandable member 6350 in each of the cavities 6332 of the leveling plates 6310a, 6310b, and each of the expandable members 6350 can be independently expanded (e.g., inflated) as needed to account for an uneven support surface (e.g., floor) on which the wall module(s) sits.

The leveling plates 6310a, 6310b can be interconnected by a locking member 6340 that can extend into the openings 6314 of adjacent leveling plates 6310a, 6310b. The leveling plates 6310a, 6310b are sized to fit under the connector block 5306, as best shown in FIG. 35. The leveling assembly 6300 advantageously allows the leveling plates 6310a, 6310b to move relative to the connector block 5306 via the expandable member or bladder 6350 that contacts the base of the leveling plate 6310a, 6310b and the bottom of the connector block 5306, thereby allowing the leveling mechanism 6300 to account for an uneven floor structure on which the wall module sits so that the wall module sits level on the floor.

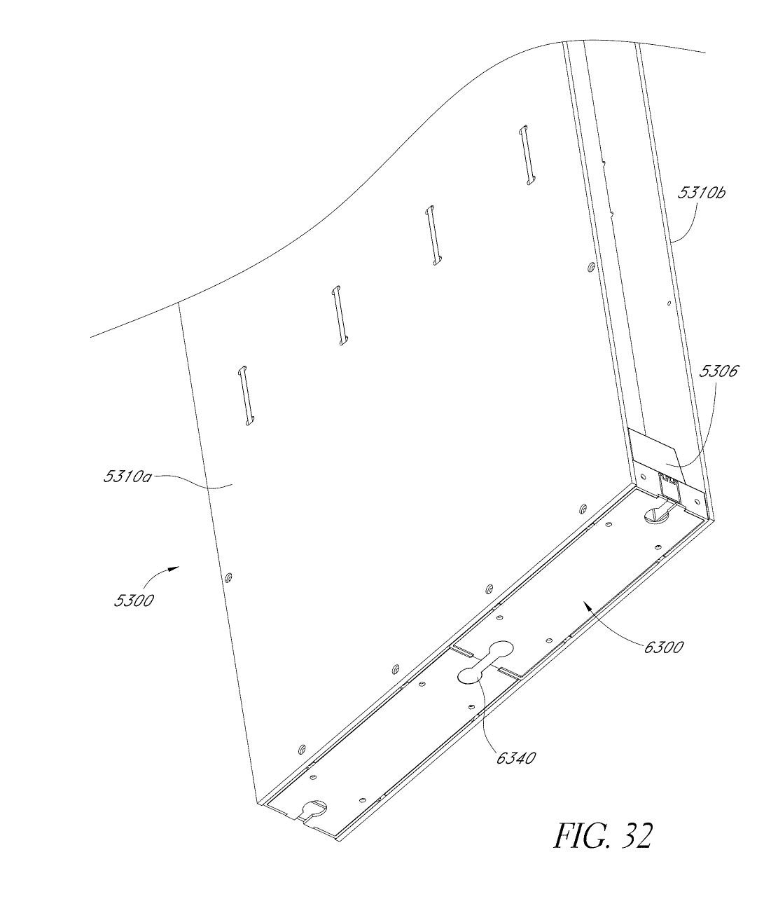

FIG. 32 shows a bottom of a wall module 5300 on which the leveling mechanism 6300 has been installed under the connector block 5306 and between the panels 5310a, 5310b of the wall module 5300. In the illustrated embodiment, the leveling mechanism 6300 includes two leveling plate 6310a, 6310b interconnected by the locking member 6340. In use, the one or more expandable members 6350 can be expanded (e.g., inflated), so that the wall module 5300 that sits upon the leveling assembly 6300 can be lifted (e.g., jacked up) off the support surface (e.g., uneven floor). Advantageously, the wall module 5300 can be lifted (via actuation of the leveling assembly 6300) so that the top of the wall module 5300 is substantially flush with another wall module 5300 above it (e.g., that together define at least a portion of a modular wall), thereby providing a generally continuous face for the wall (e.g. without any gaps between connected wall modules 5300).

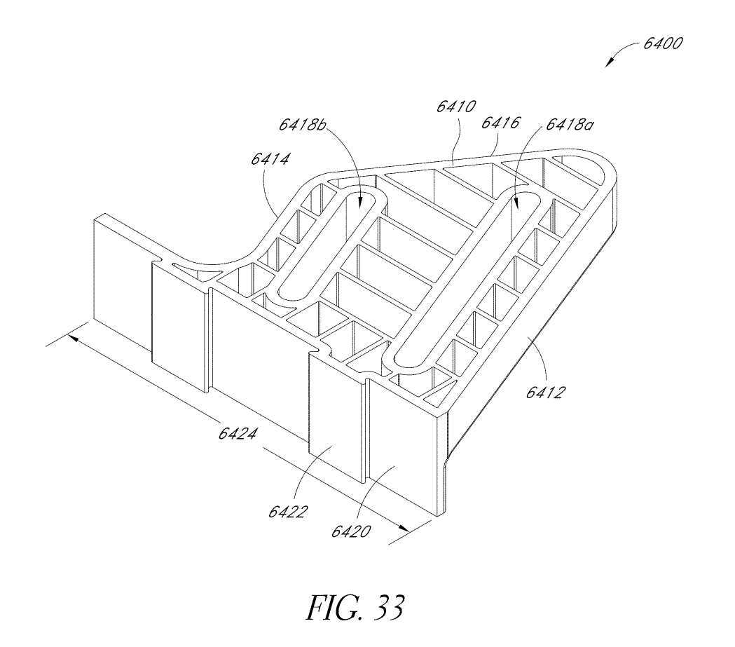

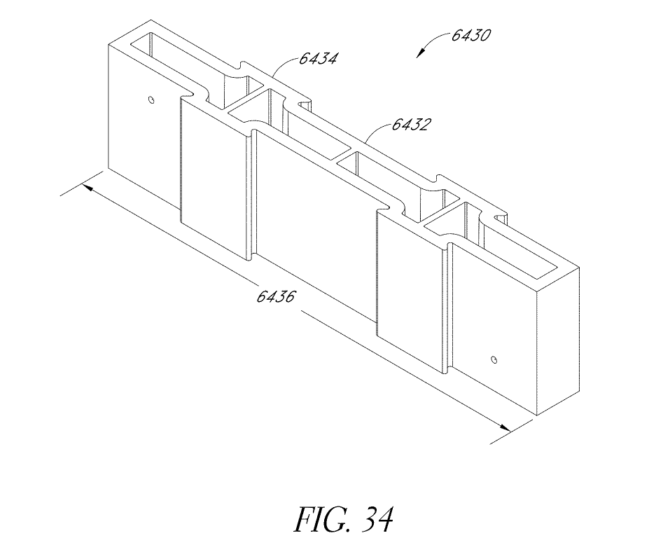

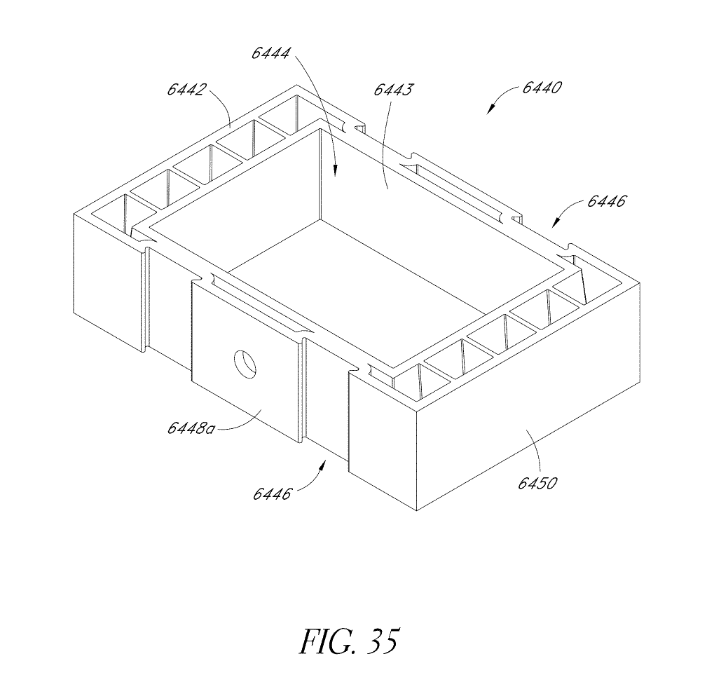

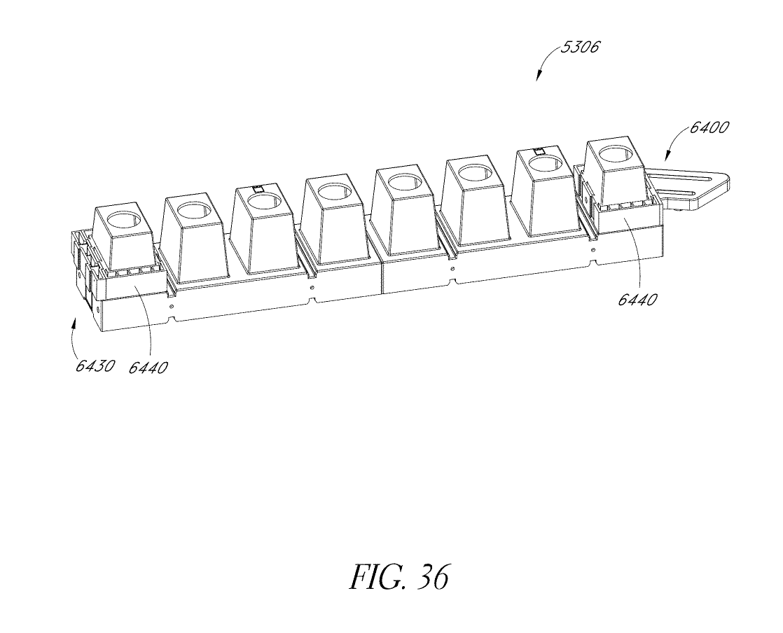

FIG. 33 shows one embodiment of a hinge member 6400 for use with a wall module, such as the wall modules 5300 described above. The hinge member 6400 has a body 6410 with a long side edge 6412, a short side edge 6414 on an opposite side of the long side edge 6412 and an angled side edge 6416 that connects the long and short side edges 6412, 6414. A first slot 6418a and a second slot 6418b can extend through a thickness of the body 6410, the slots 6418a, 6418b sized to receive one or more fasteners (e.g., bolts) therethrough. The hinge member 6400 can have one or more coupling protrusions 6422 that extend or protrude from a base surface 6420 of the hinge member 6400, where the base surface 6420 is on an opposite side of the hinge member 6400 from the angled side edge 6416. The base surface 6420 can have a length 6424.

FIG. 34 shows one embodiment of a shim member 6430. The shim member 6430 can have one or more coupling protrusions 6434 that extend or protruded from a base surface 6432 on both sides of the shim member 6430. The shim member 6430 can have a length 6436.

FIG. 35 shows one embodiment of a collar member 6440. The collar member 6440 can have a body 6442 with an inner peripheral wall 6443 that defines an opening 6444 that extends through the collar member 6440. The collar member 6440 can have a pair of opposite side surfaces 6448a into which one or more recesses 6446 extend and a pair of opposite end surfaces 6450.

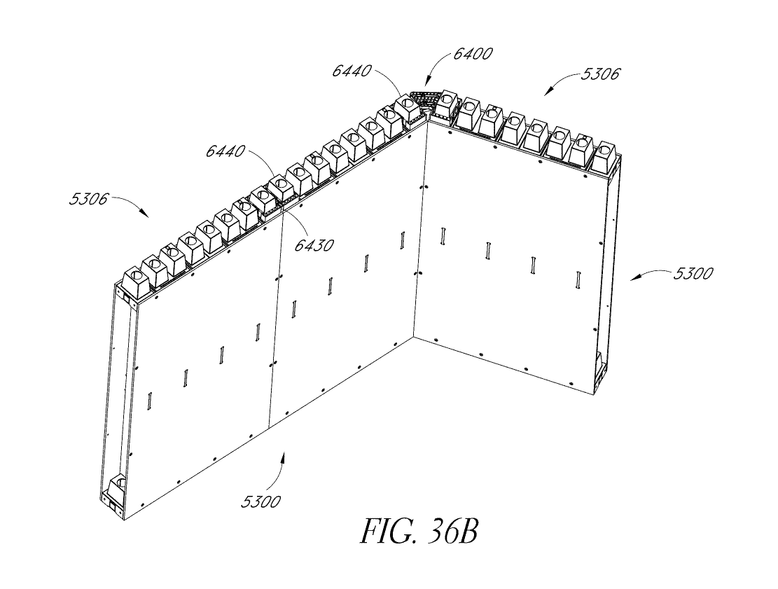

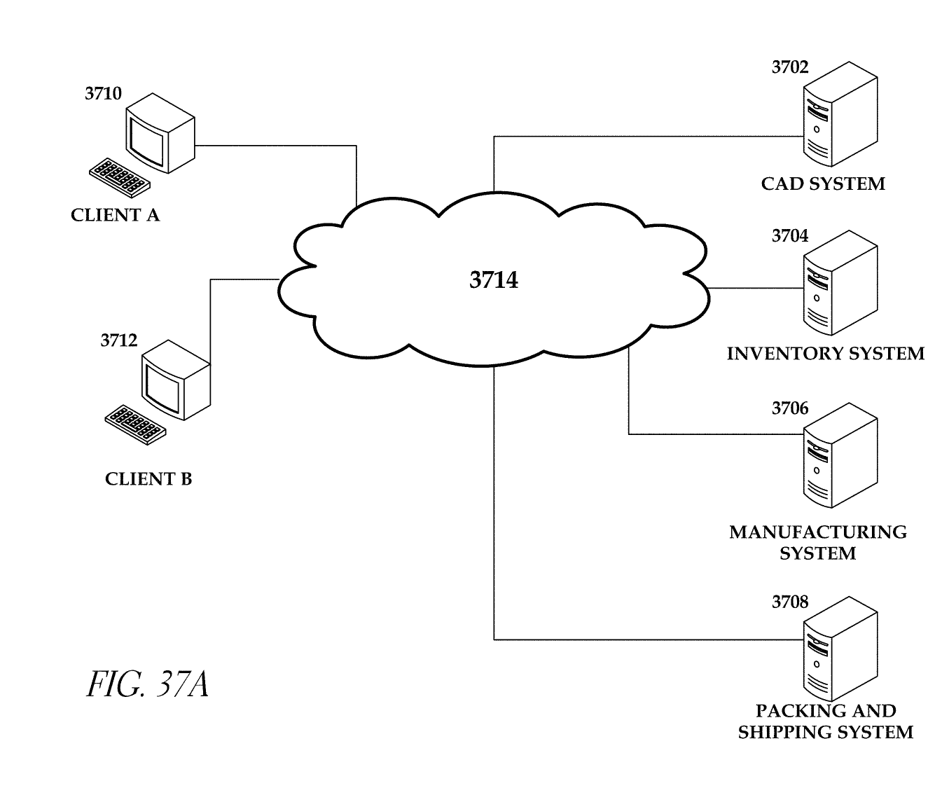

FIG. 36 shows on embodiment of a connector block 5306, as described above, to which a pair of collars 6440 has been coupled. The hinge member 6400 is coupled to one of the collars 6440 (e.g., the coupling protrusions 6422 of the hinge member 6400 extend into the recesses 6446 of the collar member 6440) and a shim member 6430 is coupled to the other collar 6440 (e.g., the coupling protrusions 6434 of the shim member 6430 extend into the recesses 6446 of the other collar member 6440). The shim member 6430 advantageously allows the connector block 5306 (e.g., when incorporated as part of a wall module 5300, as described above) to be coupled to an adjacent connector block 5306 (e.g., incorporated as part of an adjacent wall module 5300), thereby allowing the coupling of adjacent wall modules. The hinge member 6400 advantageously allows the connector block 5306 (e.g., when incorporated as part of a wall module 5300, as described above) to be coupled to an adjacent connector block 5306 with a similar hinge member 6400 (e.g., incorporated as part of an adjacent wall module 5300) to allow the adjacent wall modules to pivot or extend at an angle via the hinge members 6400. As discussed above, fasteners (e.g., bolts and nuts) can extend through the slots 6418a, 6418b of the hinge members 6400 to couple them together.

FIG. 36B shows three wall modules 5300, where two wall modules 5300 (see middle and right wall module 5300 in FIG. 91) are coupled at an angle via their hinge members 6400, as described above. The third wall module 5300 is shown coupled to another wall module 5300 (see left wall module and middle wall module in FIG. 91) along are coupled together via a shim member 6430 and a pair of collars 6440 on both wall modules 5300, as described above, so that they extend along the same plane.

Additionally, in any embodiments disclosed herein, the wall modules can be configured to support and include water and gas conduit(s), piping and/or fixtures to enable the passage of fluids and/or gases through the wall modules. Such conduit or fixtures can be configured, for example, to supply gas or fluids to sinks, showers, bathtubs, faucets, fountains, any water features, fireplaces or other flame sources, or any combination of the foregoing, that can also be positioned on, in, or otherwise supported by the wall modules. For example, the conduit can be configured to removably pass through openings or channels in the wall modules, or can be integrated directly into the wall modules and have sealable connections (e.g., quick release connections) between the wall modules so that the conduit can be quickly interconnected when the wall modules are interconnected.

Additionally, any embodiments disclosed herein can also support electrical conduit, lighting, or other electrical fixtures. As with the plumbing or gas conduit, the wall modules can have electrical connections at the interfaces of the wall modules for quick connection. Or, in addition or instead, the wall modules can be configured such that the electrical conduit can be passed through openings, passages, or through or over other features positioned about the wall modules to permit the electrical conduit to be quickly and easily advanced through the wall modules. Lights and other electrical features can be positioned about the wall modules in any desired positions. Spuds or other metal fasteners can be positioned about the wall modules for supporting lights, electrical conduit or other similar components. Optionally, the wall modules can have one or more stubs on an upper surface (or other surface) therefor to support lights. For example, the lights may be equipped with clamps or the like which may be clamped on to or otherwise removably attached to the stubs. The lights may include a cylindrical mount or other mount that mates with a stub having a receiving/mating configuration (e.g., a cylindrical opening configured to receive the cylindrical mount). The lights can be used for decoration purposes or can be used to illuminate the wall modules and/or a space defined by the wall modules. For example, the lights may be used to illuminate actors and/or props positioned in a set defined in whole or in part by one or more wall modules.

Although the various building-related modules and components were disclosed herein as being full size or scale, any embodiments disclosed herein can be made or formed at any desired height or size. For example and without limitation, scaled models or toy versions of any of the modules and components disclosed herein can be made having any combination of the features disclosed herein. Such scaled models can be useful for mockups, demonstrations, or simply as toys. The scaled models can be from approximately 1/10th size, or approximately 1/12th sized scaled models (or other scale), and can be made from any suitable materials such as plastic, wood, metal, or any combination of the foregoing. Optionally, the models may be manufactured using 3D printing or other manufacturing techniques disclosed herein. The utilization of the various building-related modules and components is not limited to a particular application, and may be used for stages or sets, as temporary structures, emergency structures, tradeshow structures, store interiors, etc.

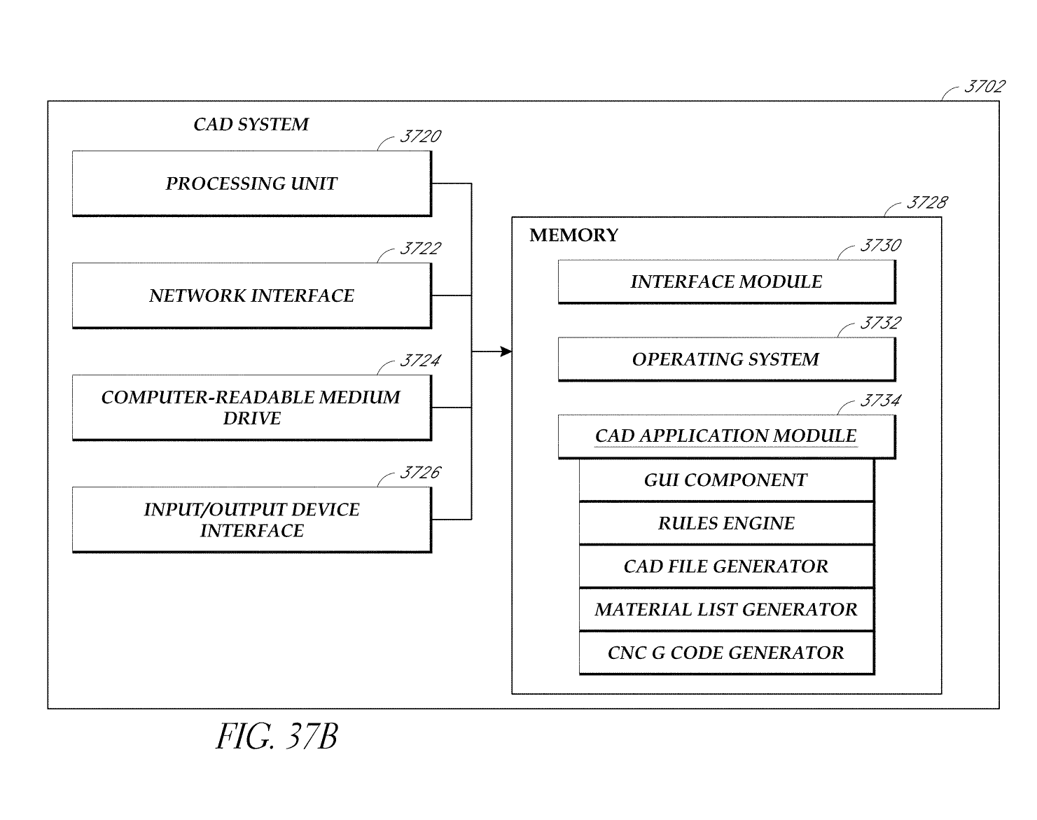

An example system architecture that may be utilized to provide computer aided design and manufacturing services will now be discussed with reference to FIG. 37A. In the illustrated embodiment a computer aided design (CAD) system 3702 may be hosted on one or more servers. The CAD system 3702 may be cloud-based and may be accessed by one or more client terminals 3710, 3712 over a network 3714 (e.g., the Internet, Ethernet, or other wide area or local area network). Client terminals may be able to share software applications, computing resources, and data storage provided by the CAD system 3702.

The client terminals may be in the form of a desktop computer, laptop computer, tablet computer, mobile phone, smart television, dedicated CAD terminal, or other computing device. A client terminal may include user input and output devices, such a displays (touch or non-touch displays), speakers, microphones, trackpads, mice, pen input, printers, haptic feedback devices, cameras, and the like. A client terminal may include wireless and/or wired network interfaces via which the client terminal may communicate with the CAD system 3702 over one or more networks. A user terminal may optionally include a local data store that may store CAD designs which may also be stored on, and synchronized with, a cloud data store.

As will be described in greater detail herein, the CAD system 3702 may provide tools to graphically construct computer models of structures that may be assembled using pre-defined building modules and related components such as those discussed elsewhere herein and illustrated in the figures. The CAD system 3702 tools may include wall drawing and placement tools, window drawing and placement tools, door drawing and placement tools, and wall surface treatment specification tools. The CAD system 3702 tools may also enable the addition and placement of other components, such as wall hinges (that enable the angle of connected walls to be changed), shelves and/or shelf mounting hardware, leveling assemblies, conduits (e.g., electrical or water conduits), floor support members, lights, electrical controls (e.g., wired or wireless light switches or switches), and the like.

The CAD system 3702 may generate and provide a graphical user interface enabling the user to utilize the tools to draw (e.g., using a pointing tool) one or more walls, connect walls, place windows on walls, place doors on walls, and/or place components on walls or otherwise mechanically coupled to walls, via one or more design areas. The graphical user interface may optionally illustrate surface treatments selected or applied by the user. The CAD system 3702 may a provide drag and drop and/or point and drop interface to enable the user to position building elements, reposition building elements, and/or change the dimensions of building elements. The CAD system 3702 may provide top plan, front plan, and/or perspective plan views of structures designed by the user.

The CAD system 3702 may optionally generate, based on a user design, order forms (including a bill of materials listing of parts, part quantities, and cost per part, per part type, and total cost) and/or manufacturing instructions based on a user design. Some or all of the information generated by the CAD system 3702 may be provided to an inventory system 3704, a manufacturing system 3706, and/or a packing/shipping system 3708. Some are all of the foregoing systems may optionally be cloud based. Optionally, the CAD system 3702, inventory system 3704, manufacturing system 3706, and/or packing/shipping system 3708 may be the same system and may be operated by the same entity. Optionally, the CAD system 3702 may generate, based on a user design, quote forms (including a bill of materials listing of parts, part quantities, and cost per part, per part type, and total cost) for a user design, or for multiple alternative designs. The quote form may include one or more accept controls (e.g., one for each design) and/or one or more delete controls (e.g., one for each design). The user can delete a design from the quote by activating a corresponding delete control, or place an order for a design by activating the accept control (e.g., a place order control).

For example, the CAD system 3702 may optionally generate directives in the form of manufacturing machine instructions (e.g., using computer-aided manufacturing (CAM) software for the manufacture of components (e.g., modules that are not already in inventory) for a user design. By way of illustration, the CAM software may generate specific commands (e.g., using G code) for a particular machine or set of machines to produce a module or component, which may then be loaded into or otherwise communicated to a computer numerical control (CNC) manufacturing machine (e.g., a CNC machine that uses molds to manufacture components, a CNC milling machine, a CNC router machine, a CNC cutter machine, a CNC grinder machine, a CNC automated nail delivery system, etc.). For example, the commands may specify, as appropriate, a 2D or 3D tool path, work piece feed rate, spindle speed, step down distance, step over distance, depth of cut, width of cut, torque, tapping speed, and/or the like. The commands may also specify that identifiers be molded into, printed on, and/or applied via an adhesive label on some or all of the components. The identifiers may be used when generating assembly instructions (e.g., printed instructions and/or animated instructions). Optionally, each component is given a unique identifier. Optionally, each component type is given a unique identifier. For example, each 3 foot block having 4 connection members may be labeled with the identifier 3F4C, while each 3 foot block having 2 connection members may be labeled with the identifier 3F3C.

The CAD system 3702 may enable multiple users to collaborate on a design via their respective terminals, optionally in real time, and generate and provide tracking information, indicating who made a given revision, when the revision was made, and what the revision was. The CAD system 3702 may further store a record of changes an enable a user to undo or redo changes to a design.

The CAD system 3702 may include or have access to a data store that stores of component library. The component library may include information on building modules (e.g., the wall modules described herein), including their dimensions (e.g., length, width, and/or height), the number of connector member protrusions, module-type identifier, and the like. The component library may include information (e.g., dimensional information (e.g., length, width, and/or height information), application information, load bearing information, electrical connection information, color information, cost information, lead time ordering information, as relevant) on other components such as window modules, door units, wall hinges, shelves and/or shelf mounting hardware, leveling assemblies, conduits (e.g., electrical or water conduits), floor support members, lights, electrical controls, and the like. For example, information regarding a conduit may include an indication as to whether it is useable in pluming application, in electrical application, or the like. Information regarding shelves and/or shelf mounting hardware may include load bearing information. The system may include or have access to a data store that stores user account information, including user designs, parts lists, ordering documents, shipping information, order history, and the like.

The inventory system 3704 may receive a bill of materials from the CAD system 3702, may access its inventory records of parts, determine which parts are in stock, determine which parts are out of stock but are on order, determine which parts are out of stock and not on order, and which parts are in stock but below a specified threshold. The inventory system 3704 may also provide some or all of the foregoing inventory information to the CAD system 3702, and optionally the CAD system 3702 will not design or inhibit the design (e.g., via an out of stock warning) of a structure using a certain component if the component (e.g., a wall module) is not available in inventory. The inventory system 3704 may instruct the manufacturing system 3706 to manufacture certain parts using the manufacturing instructions generated by the CAD system 3702, and may order other components that are out of stock or below a specified threshold from third party vendors.

The packing/shipping system 3708 may generate packing instructions to efficiently package the materials being shipped to the user. For example, the instructions may specify package sizes, which parts are to be shipped in which package, and the orientation of the parts in the package. The packing/shipping system 3708 may further generate shipping labels and/or other shipping documents.

FIG. 37B is a block diagram illustrating an embodiment of example components of a CAD system 3702. The example CAD system 3702 includes an arrangement of computer hardware and software components that may be used to implement aspects of the present disclosure. Those skilled in the art will appreciate that the example components may include more (or fewer) components than those depicted in FIG. 37B.

The CAD system 3702 may include one or more processing units 3720 (e.g., a general purpose process and/or a high speed graphics processor with integrated transform, lighting, triangle setup/clipping, and/or rendering engines), one or more network interfaces 3722, a non-transitory computer-readable medium drive 3724, and an input/output device interface 3726, all of which may communicate with one another by way of one or more communication buses. The network interface 3724 may provide the CAD services with connectivity to one or more networks or computing systems. The processing unit 3720 may thus receive information and instructions from other computing devices, systems, or services via a network. The processing unit 3720 may also communicate to and from memory 3724 and further provide output information via the input/output device interface 3726. The input/output device interface 3726 may also accept input from various input devices, such as a keyboard, mouse, digital pen, touch screen, microphone, camera, etc.

The memory 3728 may contain computer program instructions that the processing unit 3720 may execute in order to implement one or more embodiments of the present disclosure. The memory 3720 generally includes RAM, ROM and/or other persistent or non-transitory computer-readable storage media. The memory 3720 may store an operating system 3732 that provides computer program instructions for use by the processing unit 3720 in the general administration and operation of the CAD application module 3734, including it components. The CAD application module components may include a GUI component that generates graphical user interfaces and processes user inputs, a rules engine to ensure that user designs do not violate design rules, a CAD file generator that generates data files for an inputted user design, a material list generator that generates a material list for a user design, and/or a CNC code generator that generates instructions for CNC manufacturing machines. The memory 3728 may further include other information for implementing aspects of the present disclosure.

In an example embodiment, the memory 3728 includes an interface module 3730. The interface module 3730 can be configured to facilitate generating one or more interfaces through which a compatible computing device, may send to, or receive from, the CAD application module 3734 data and designs.

The modules or components described above may also include additional modules or may be implemented by computing devices that may not be depicted in FIGS. 37A and 37B. For example, although the interface module 3730 and the CAD application module 3734 are identified in FIG. 37B as single modules, the modules may be implemented by two or more modules and in a distributed manner. By way of further example, the processing unit 3720 may include a general purpose processor and a graphics processing unit (GPU). The CAD system 3702 may offload compute-intensive portions of the CAD application module 3734 to the GPU, while other code may run on the general purpose processor. The GPU may include hundreds or thousands of core processors configured to process tasks in parallel. The GPU may include high speed memory dedicated for graphics processing tasks. As another example, the CAD system 3702 and its components can be implemented by network servers, application servers, database servers, combinations of the same, or the like, configured to facilitate data transmission to and from data stores, user terminals, and third party systems via one or more networks. Accordingly, the depictions of the modules are illustrative in nature.

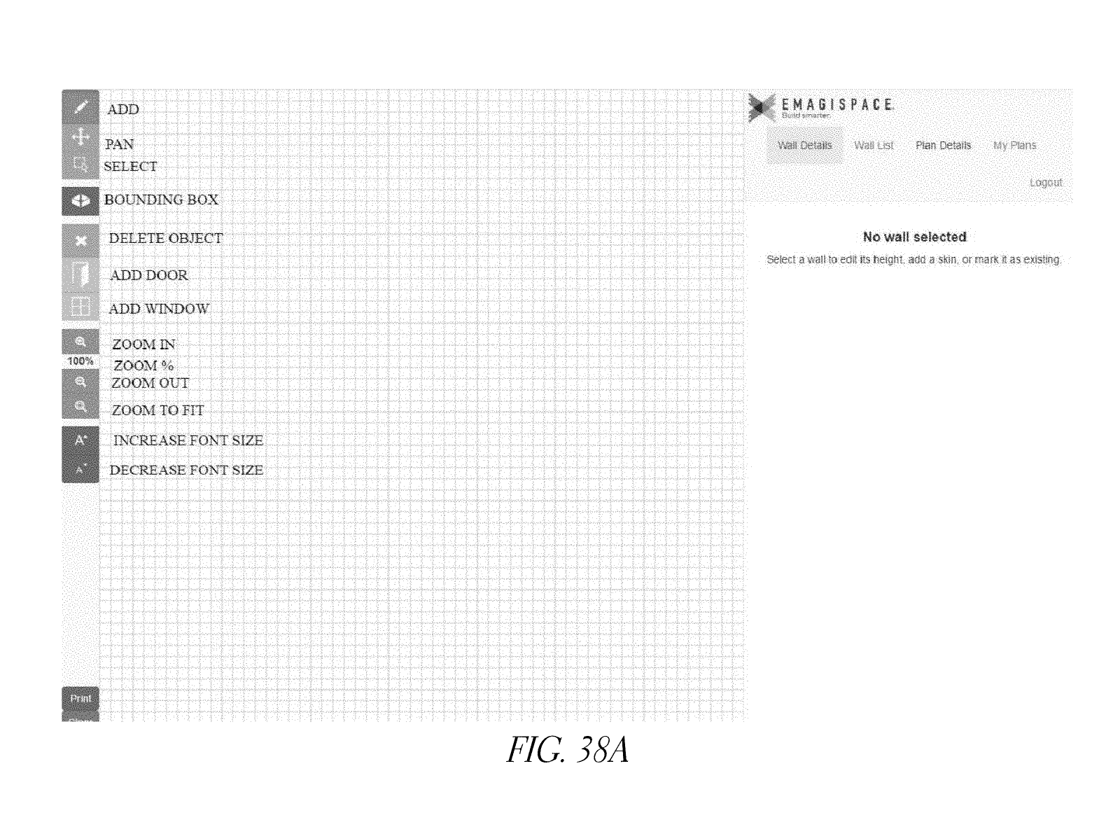

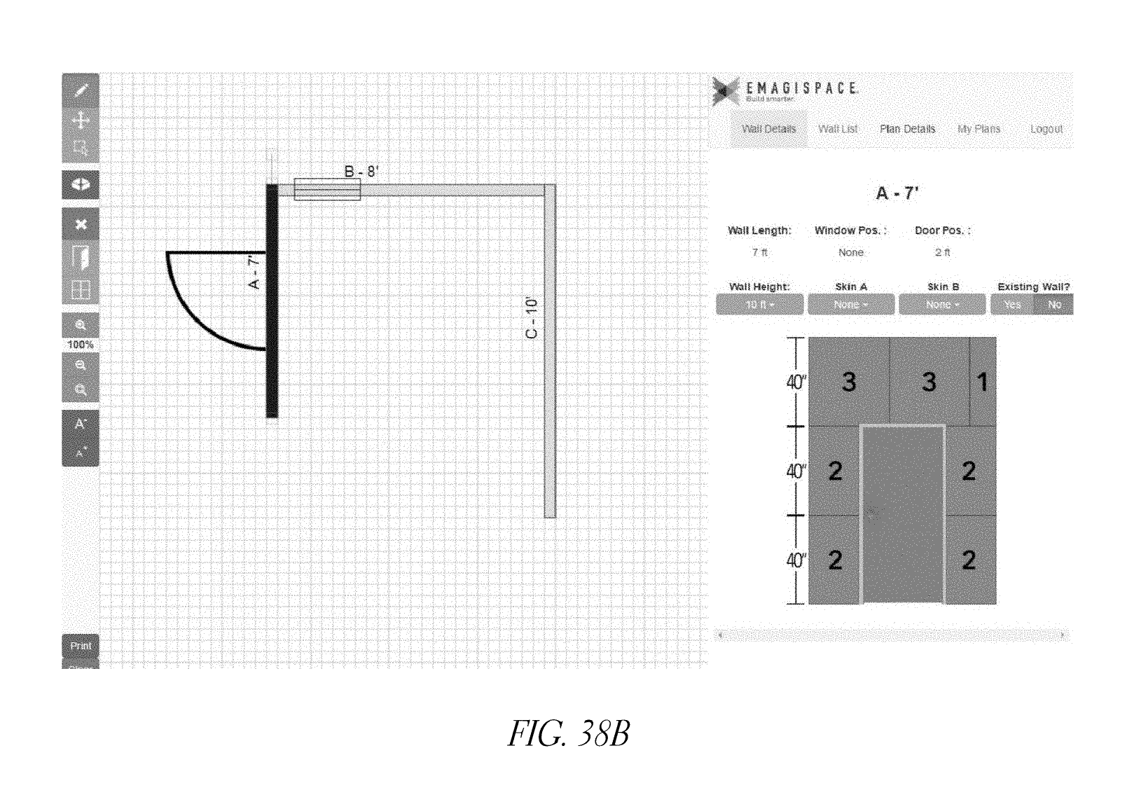

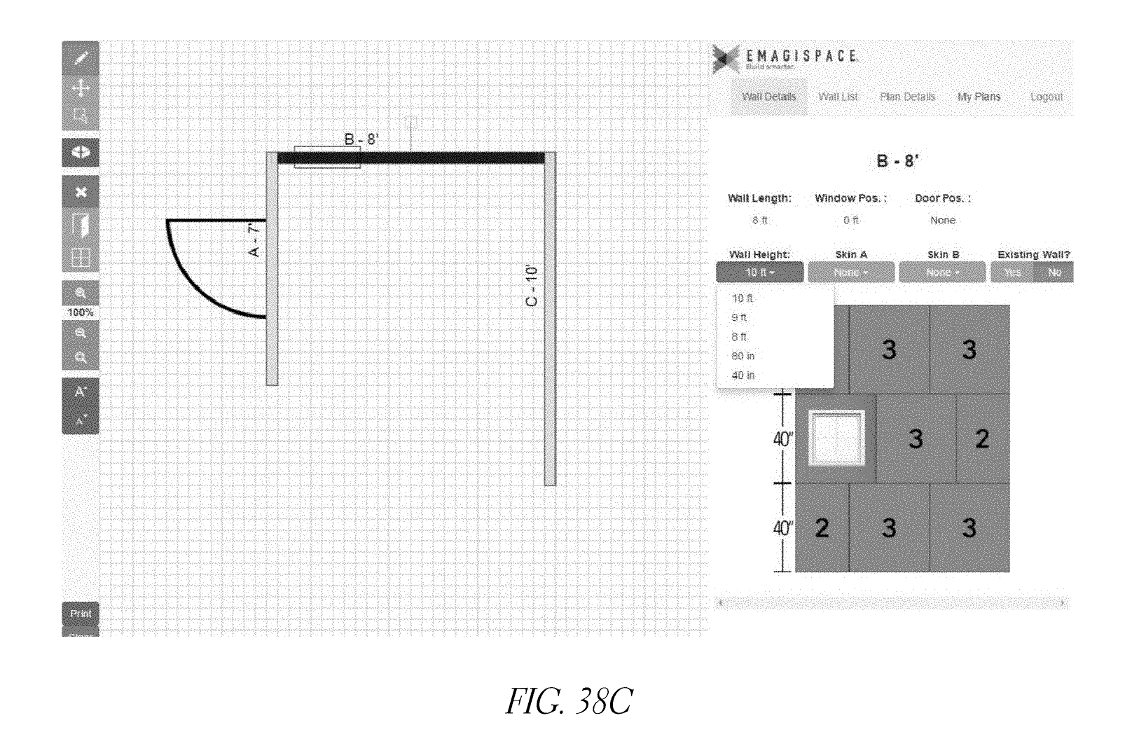

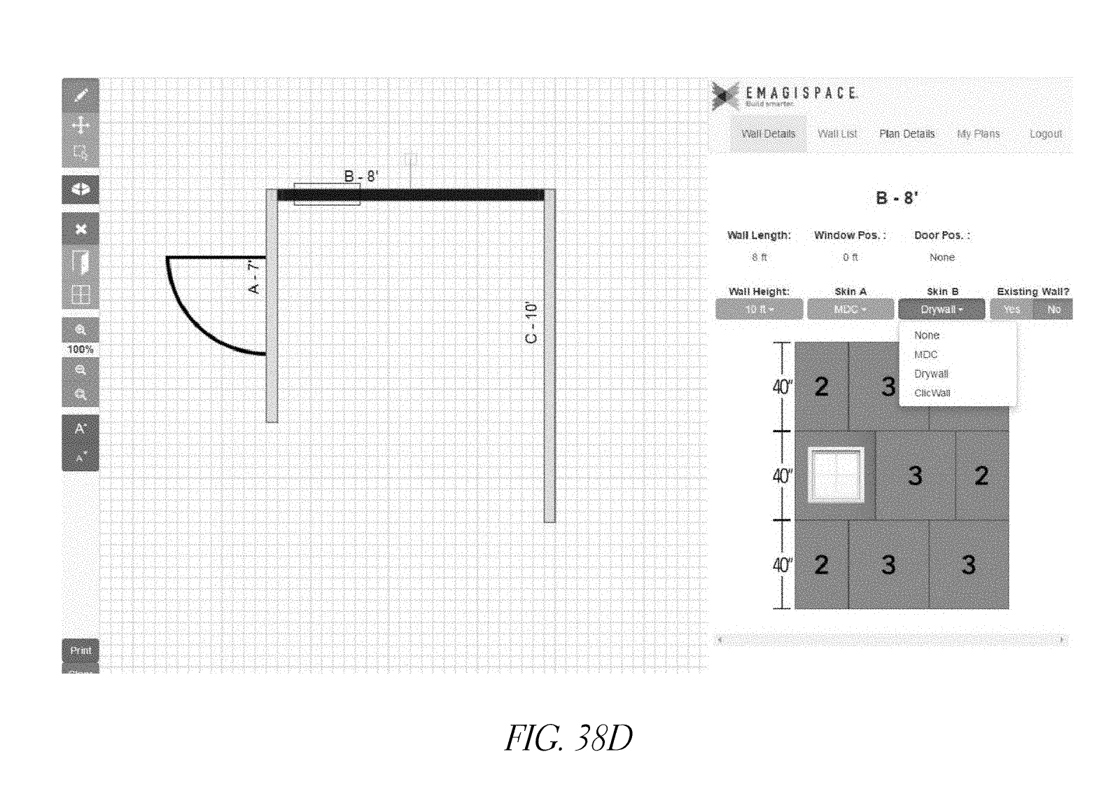

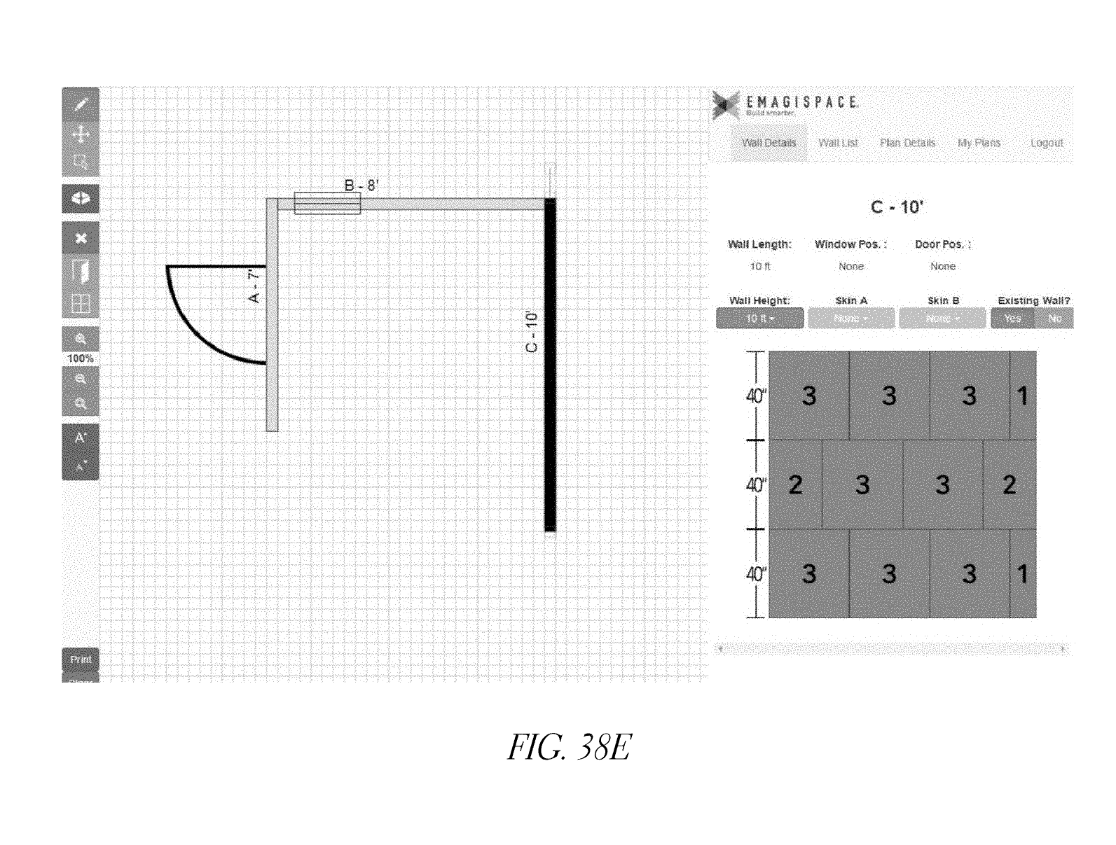

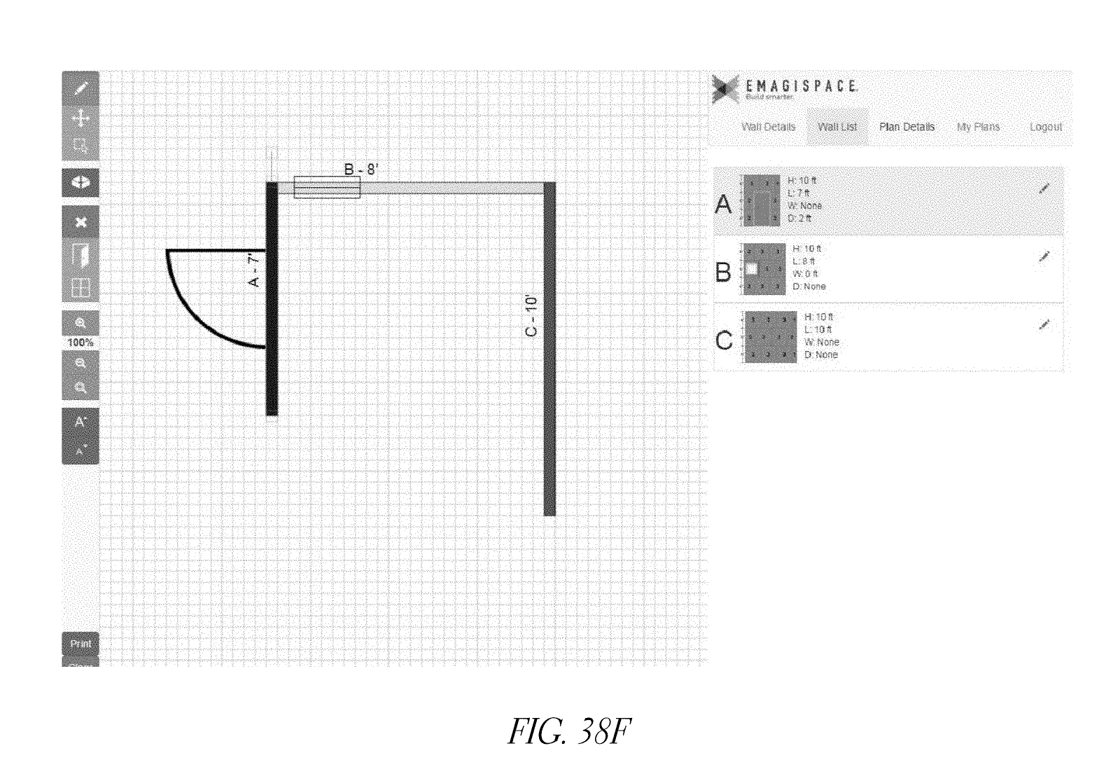

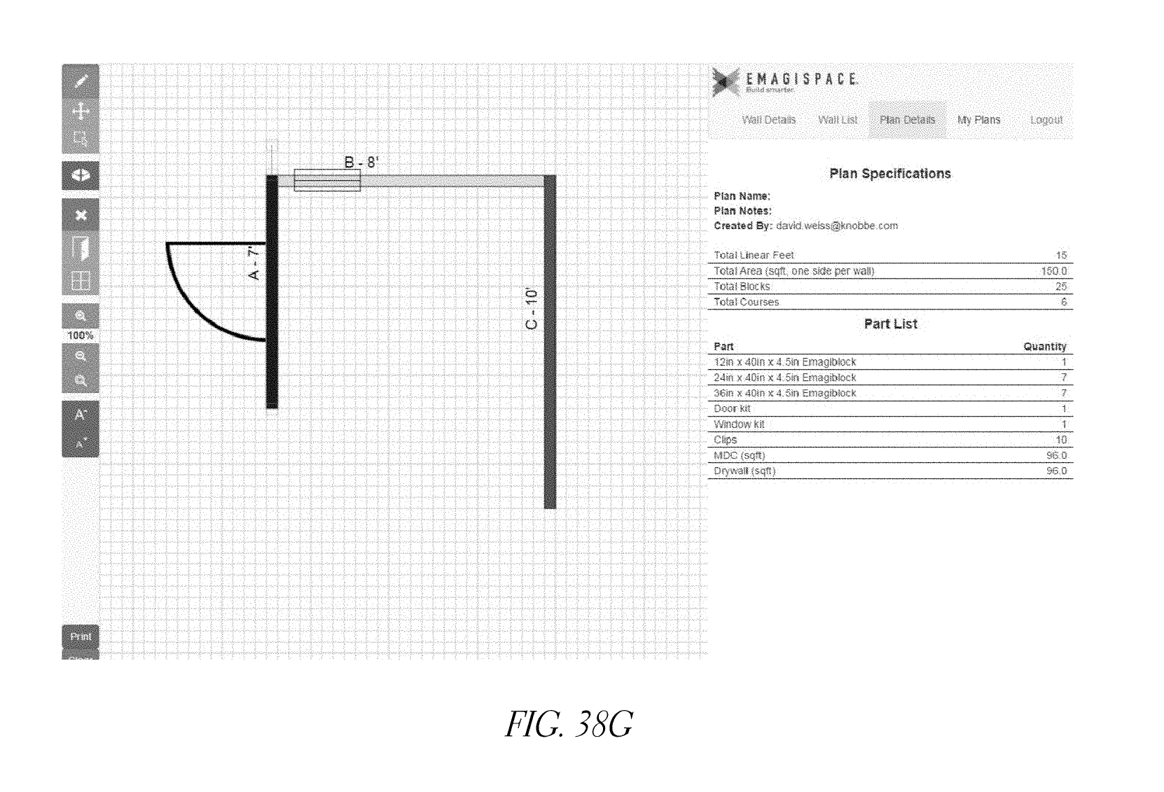

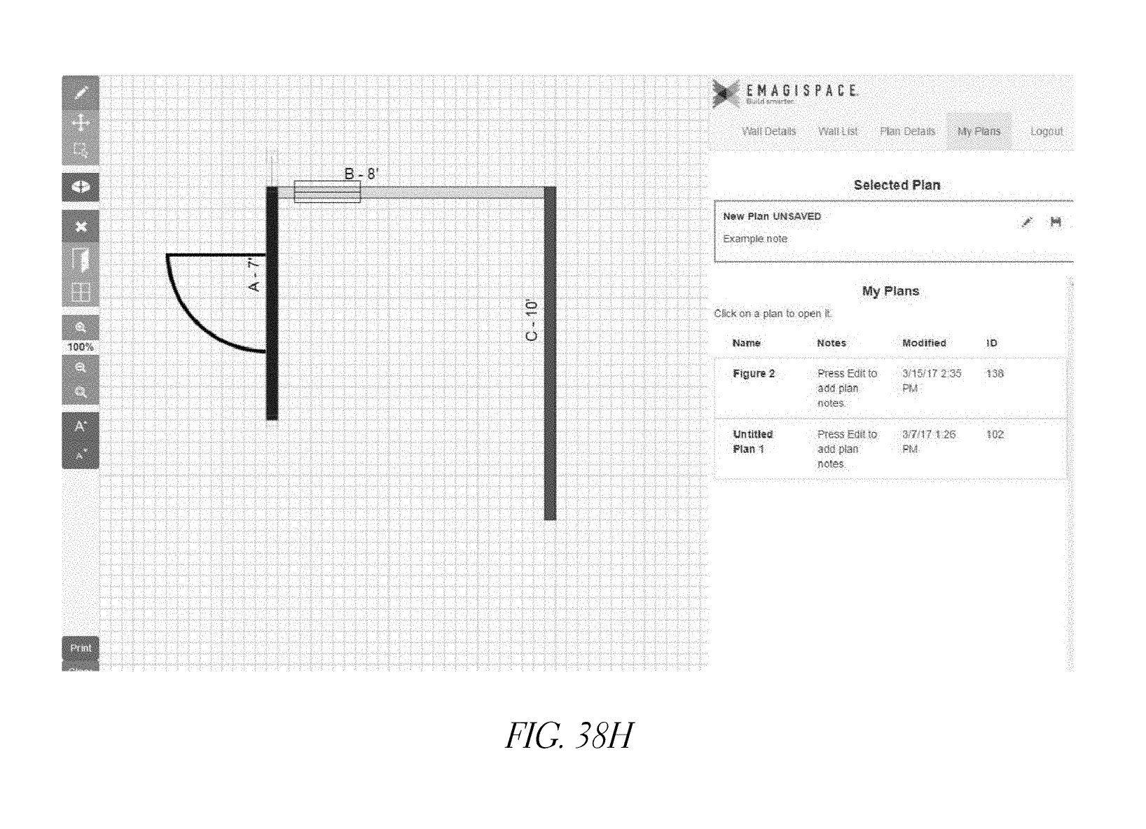

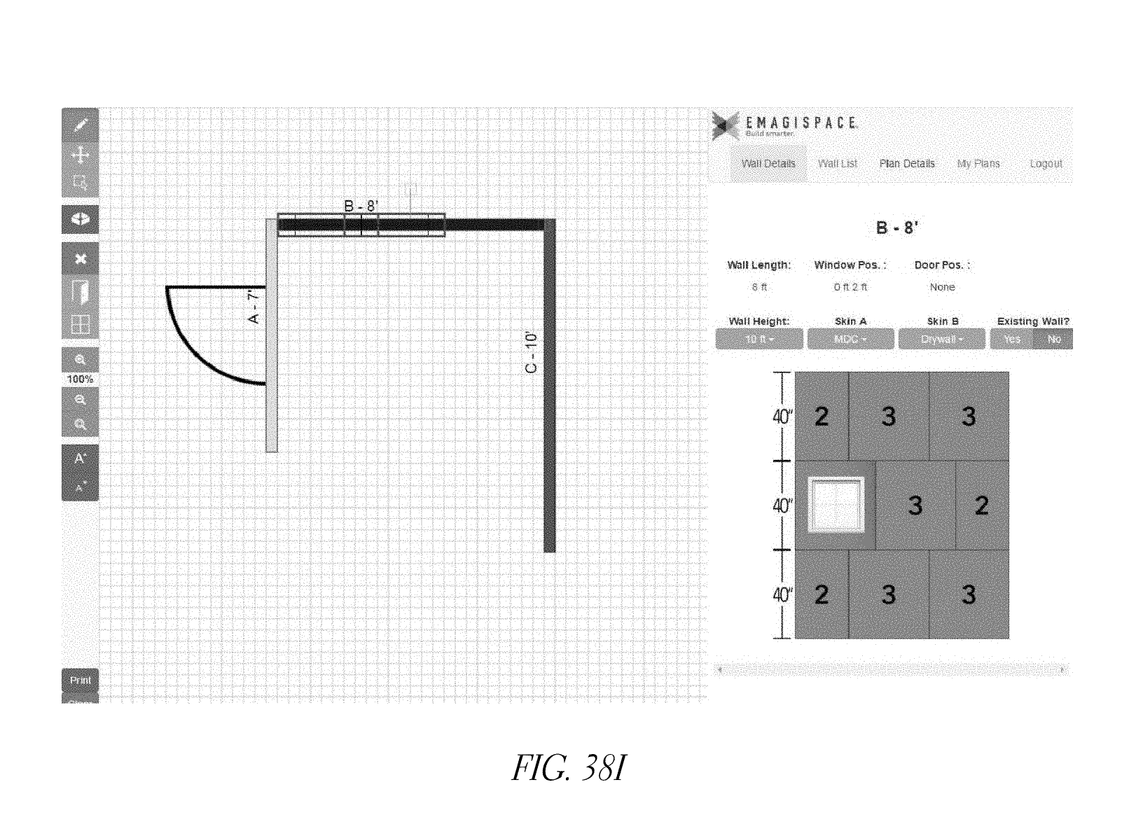

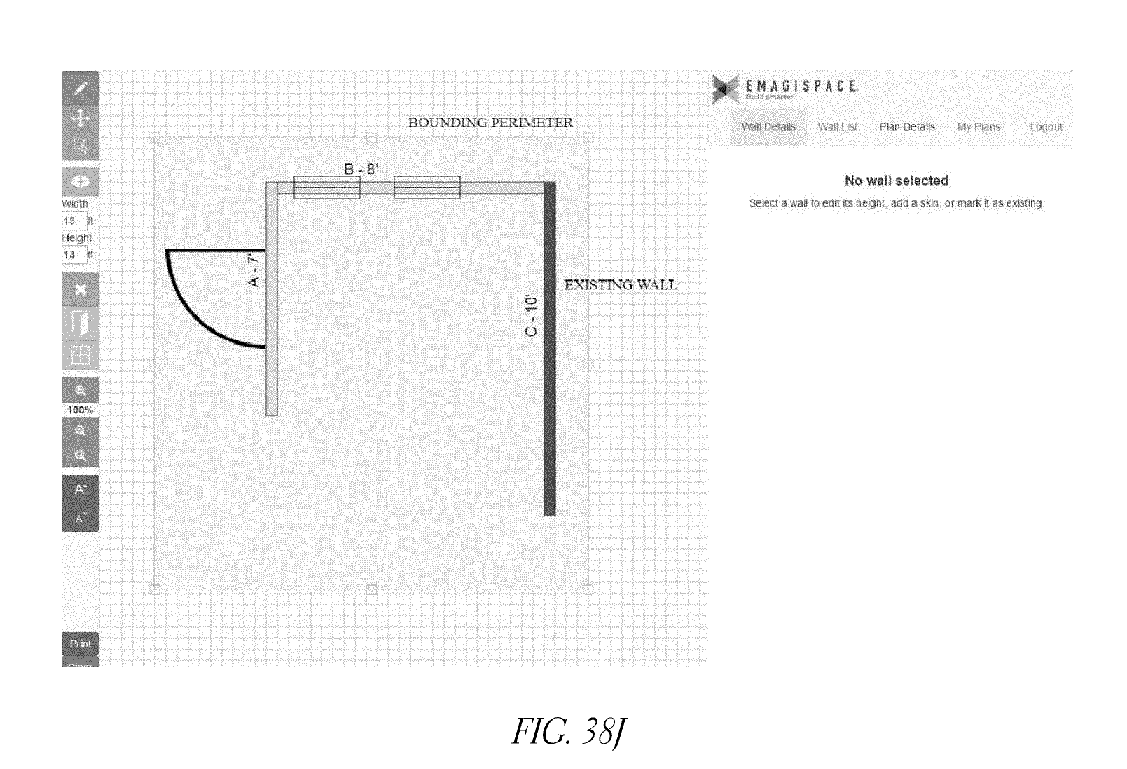

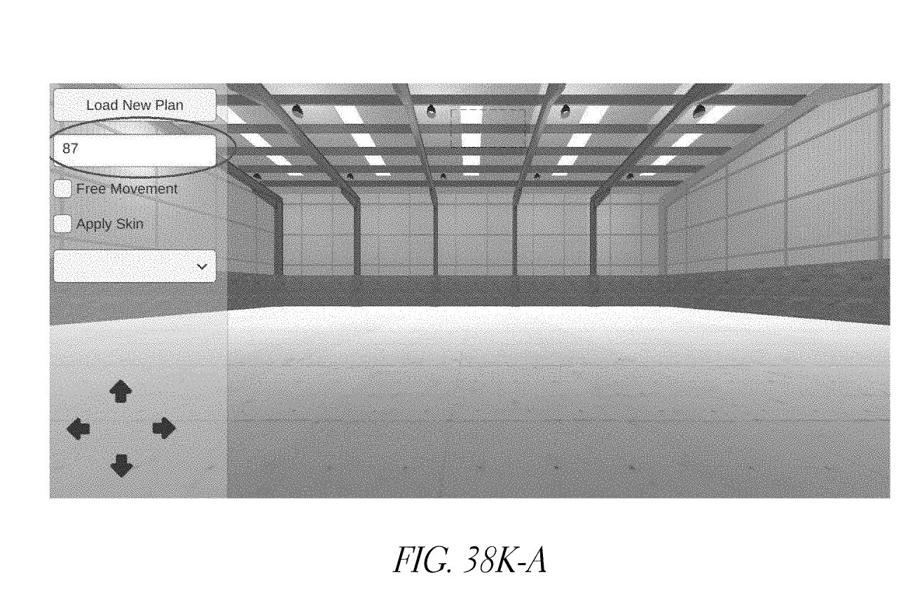

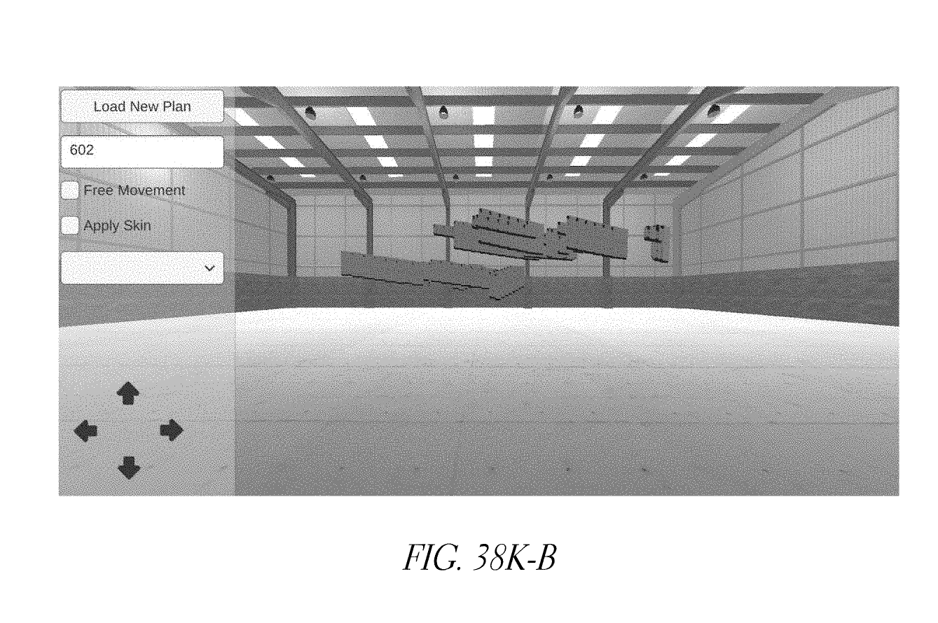

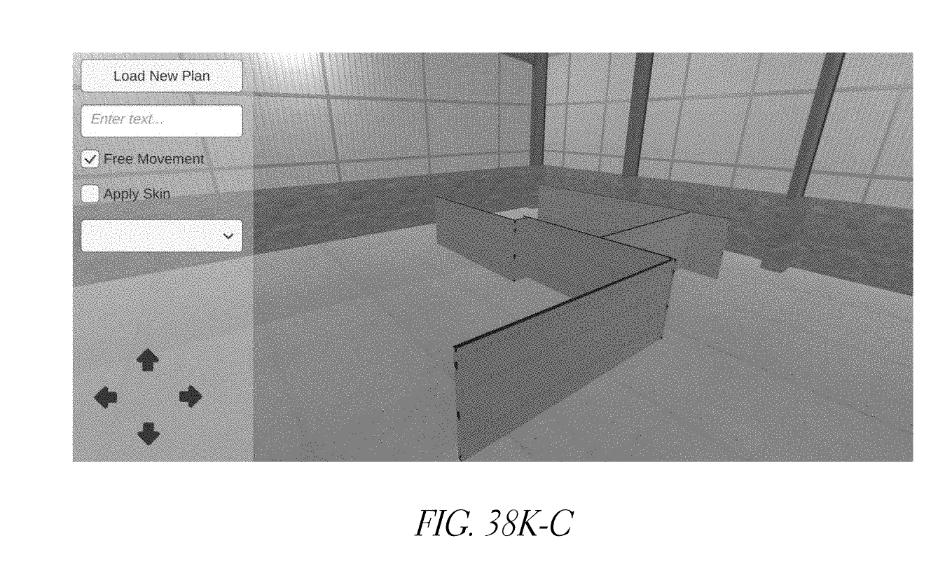

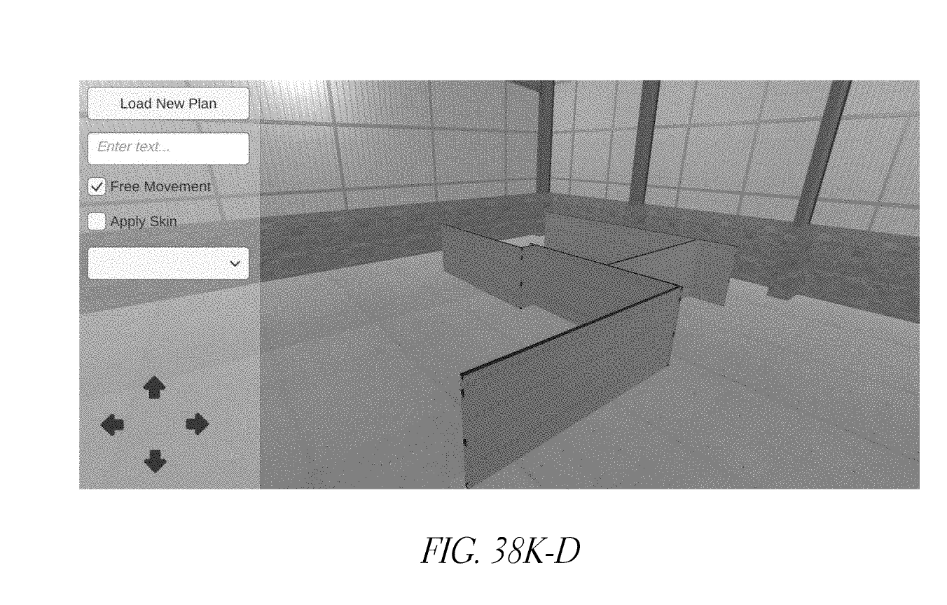

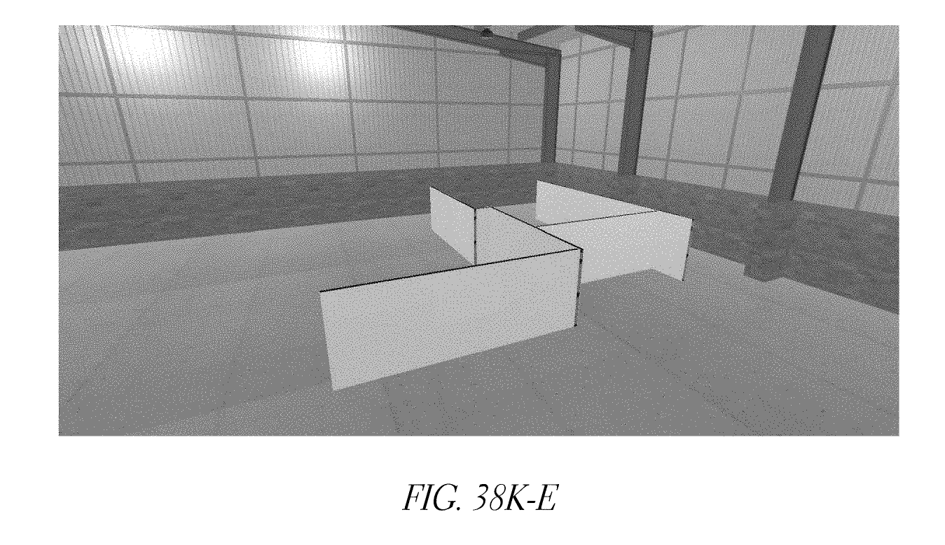

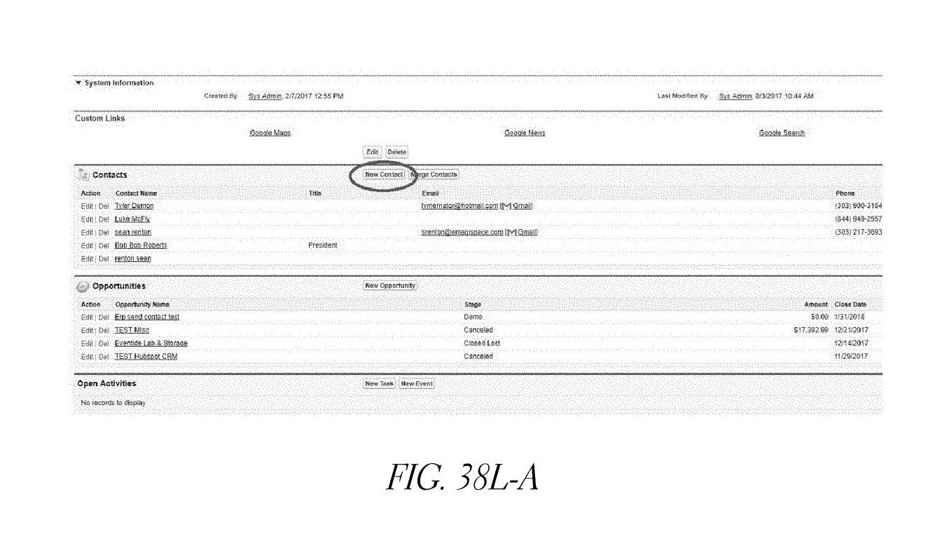

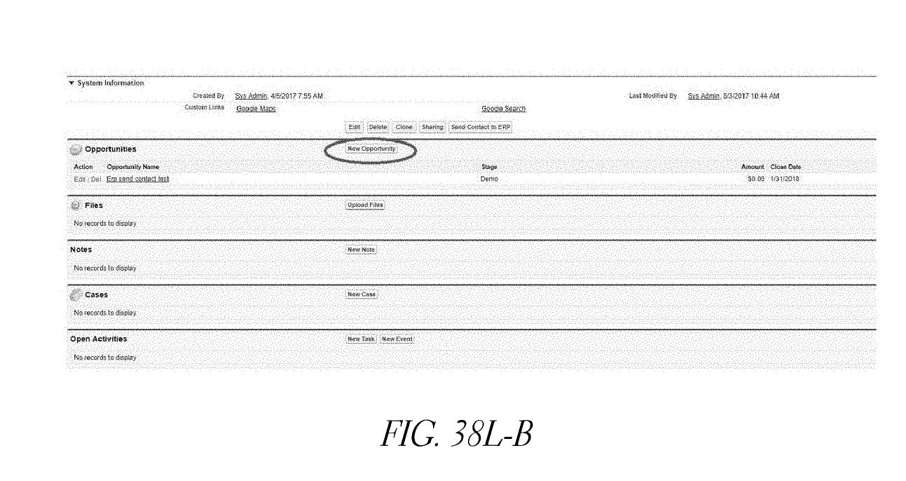

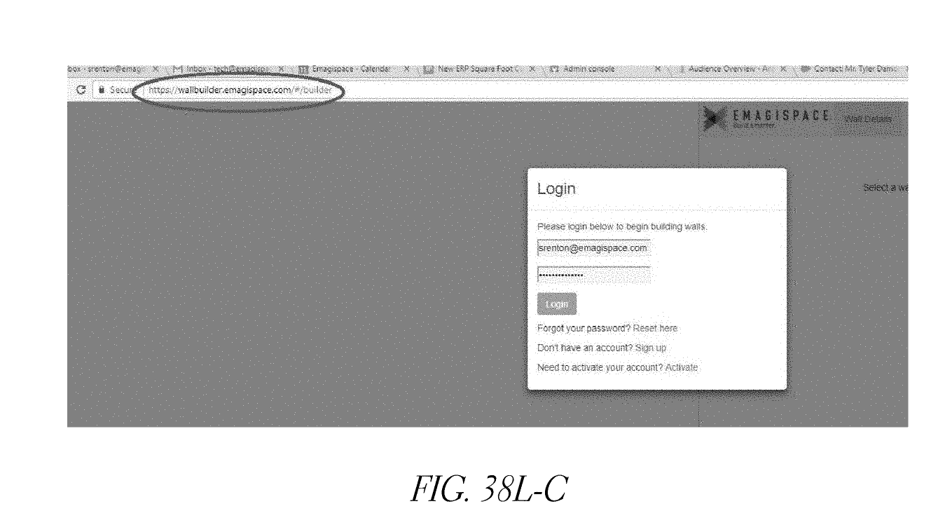

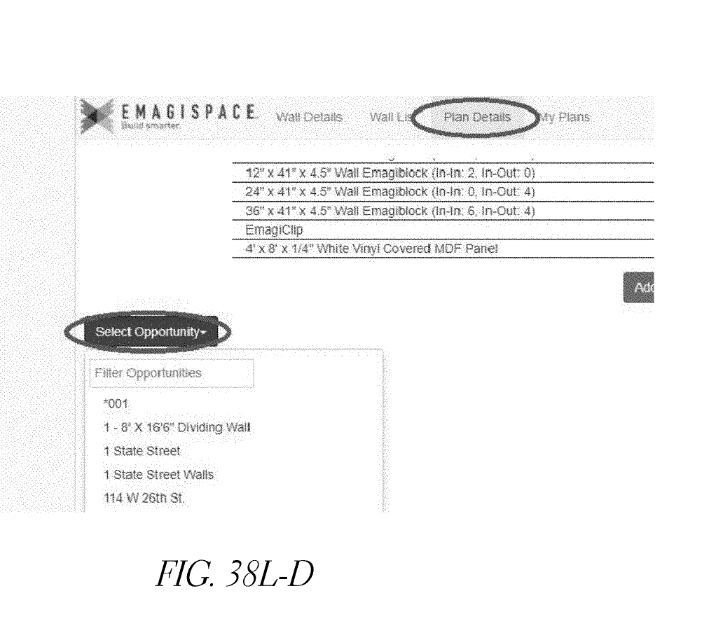

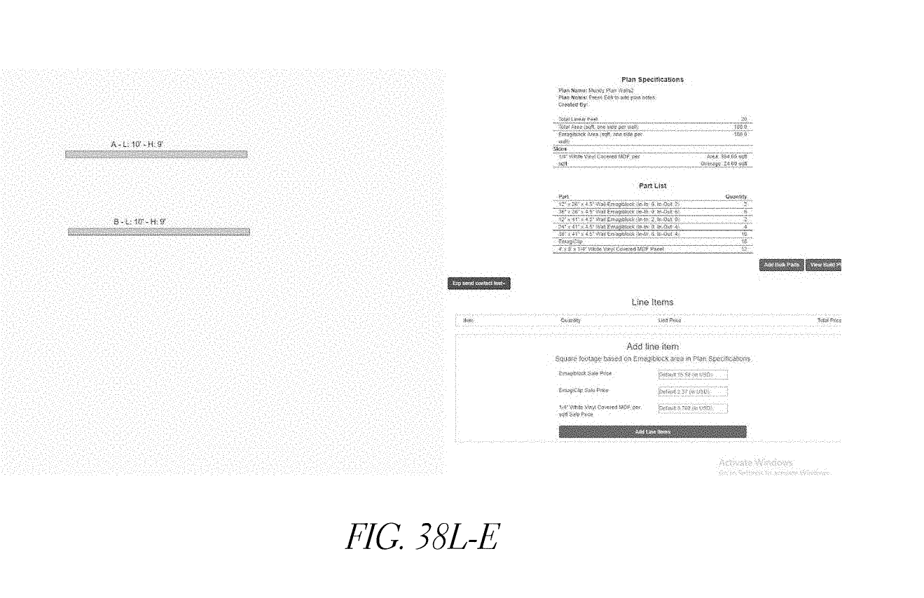

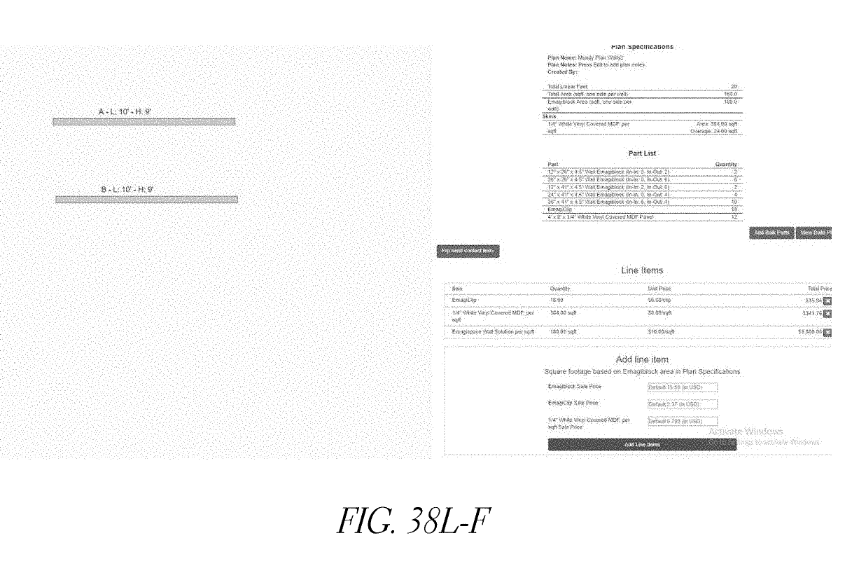

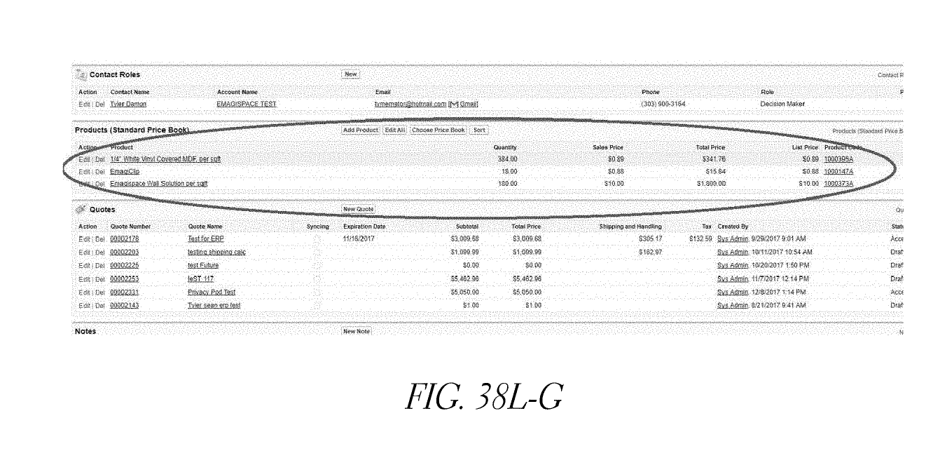

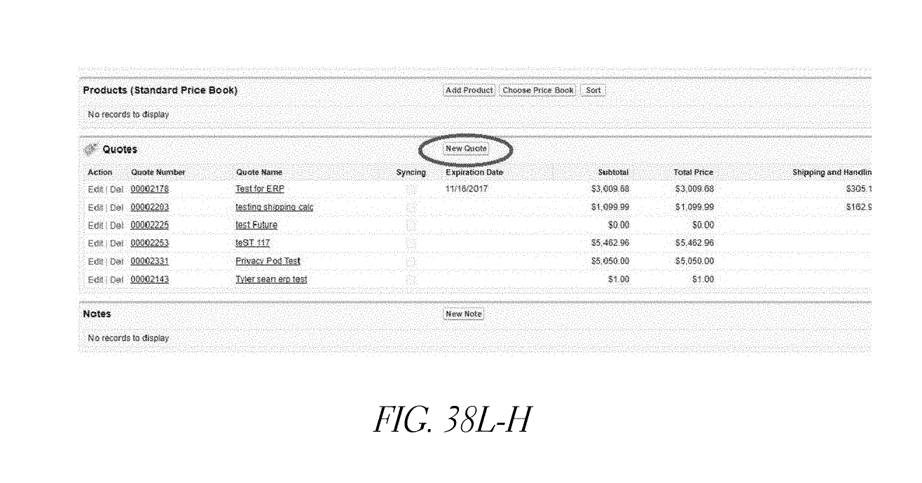

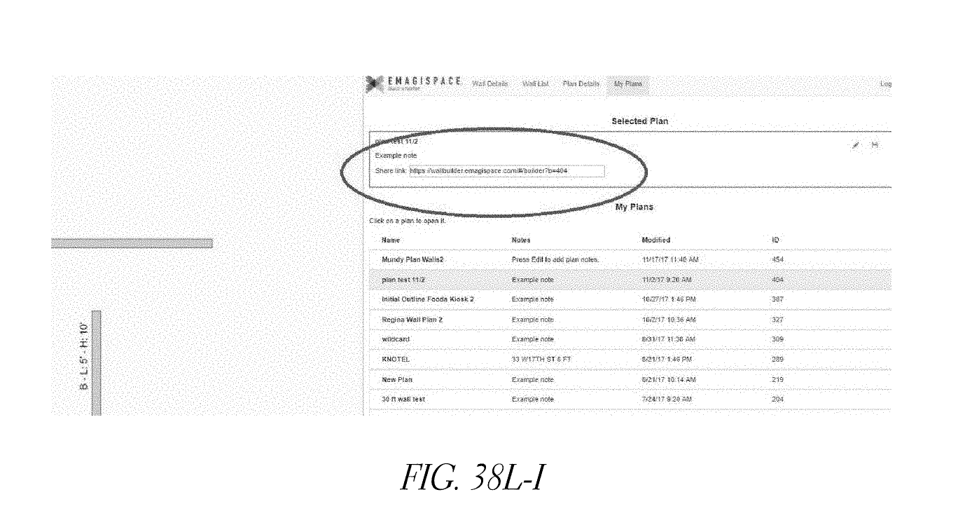

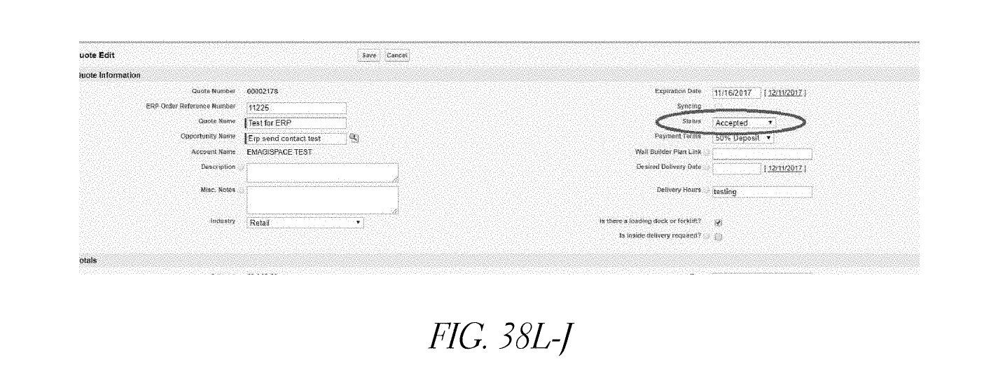

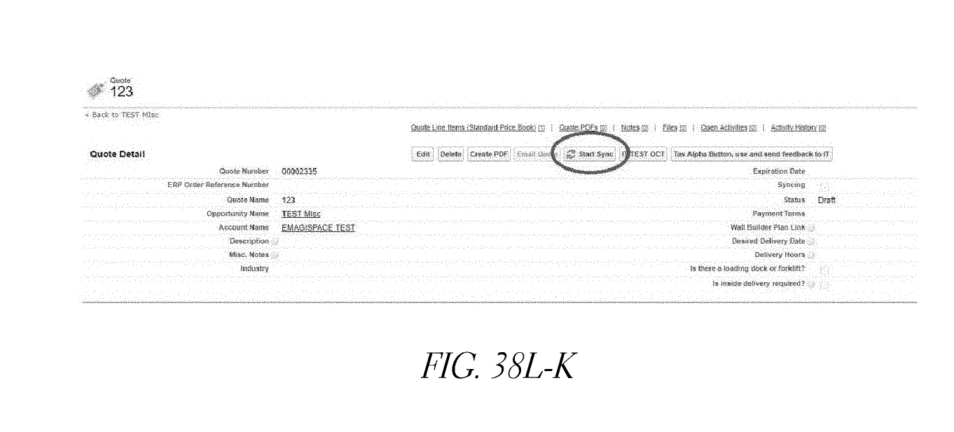

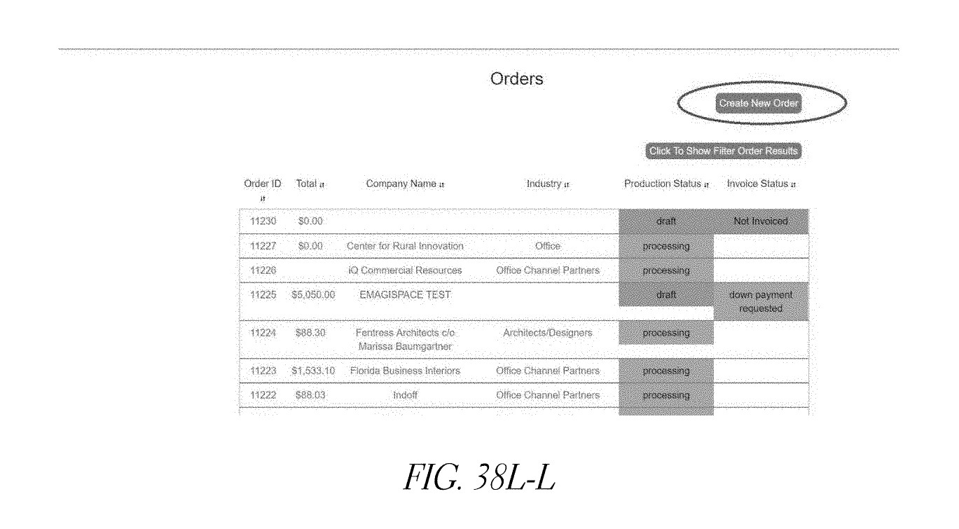

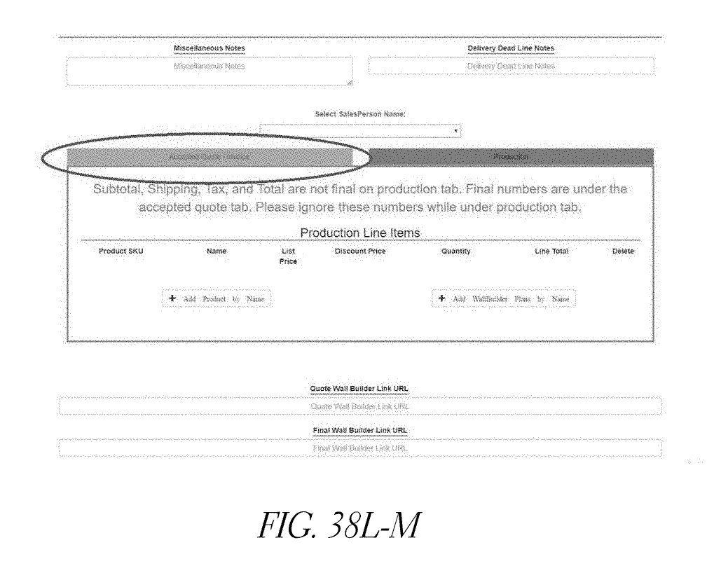

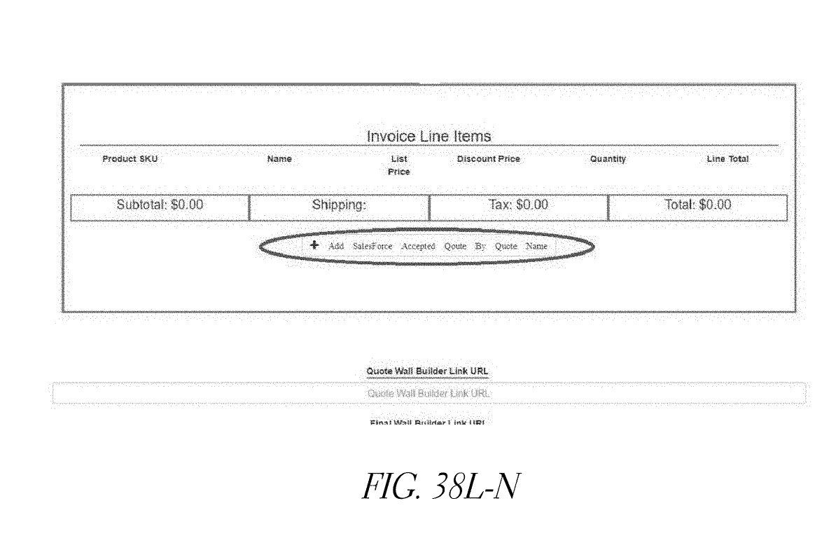

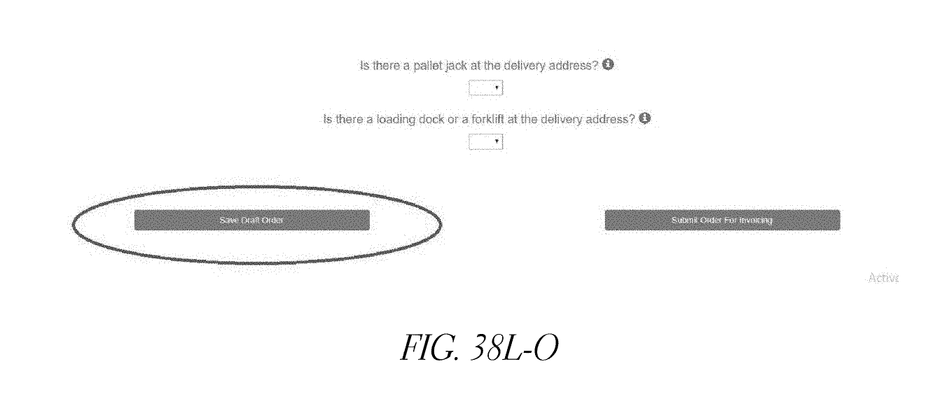

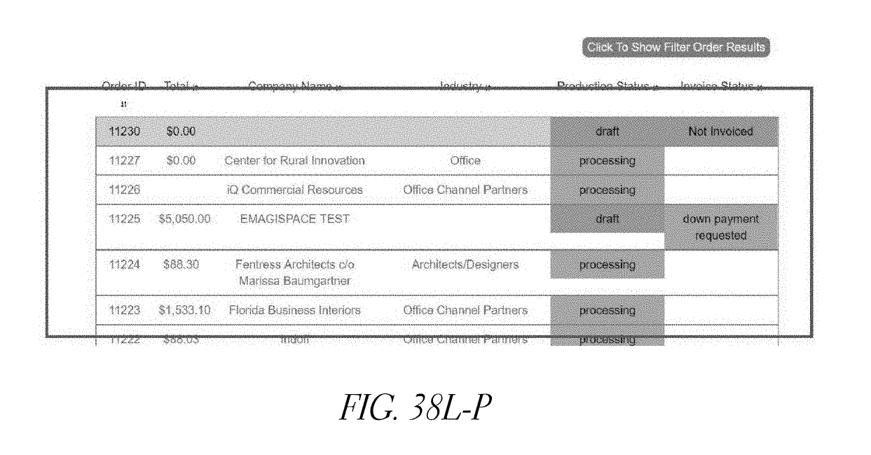

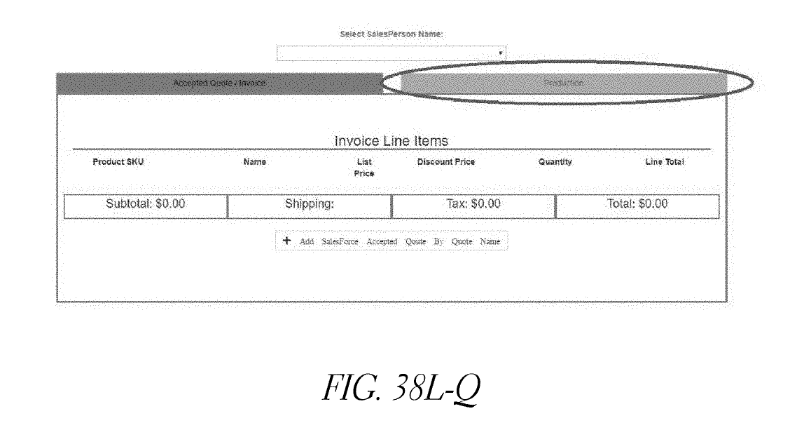

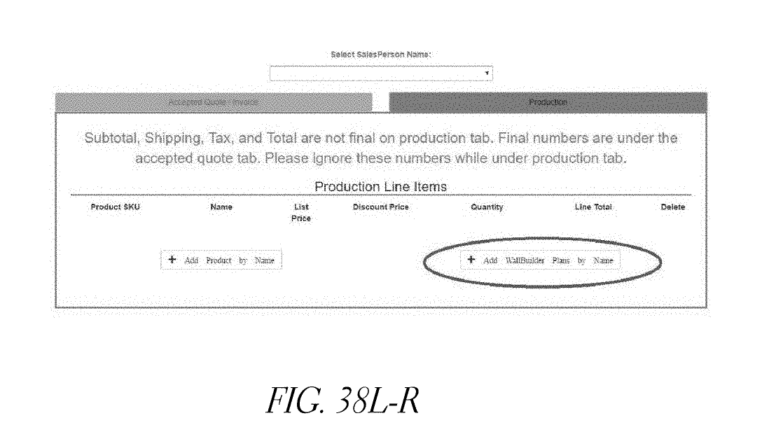

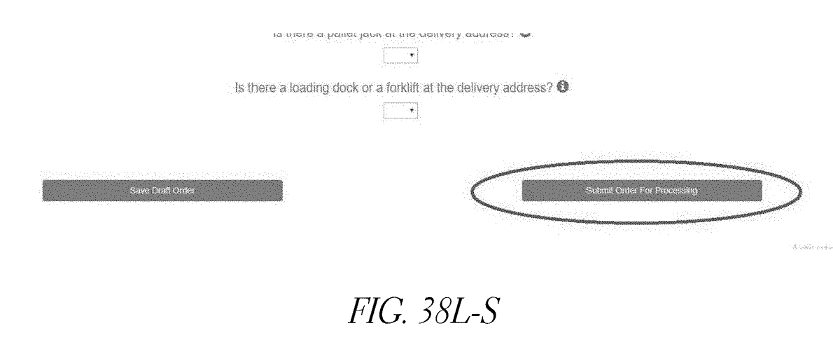

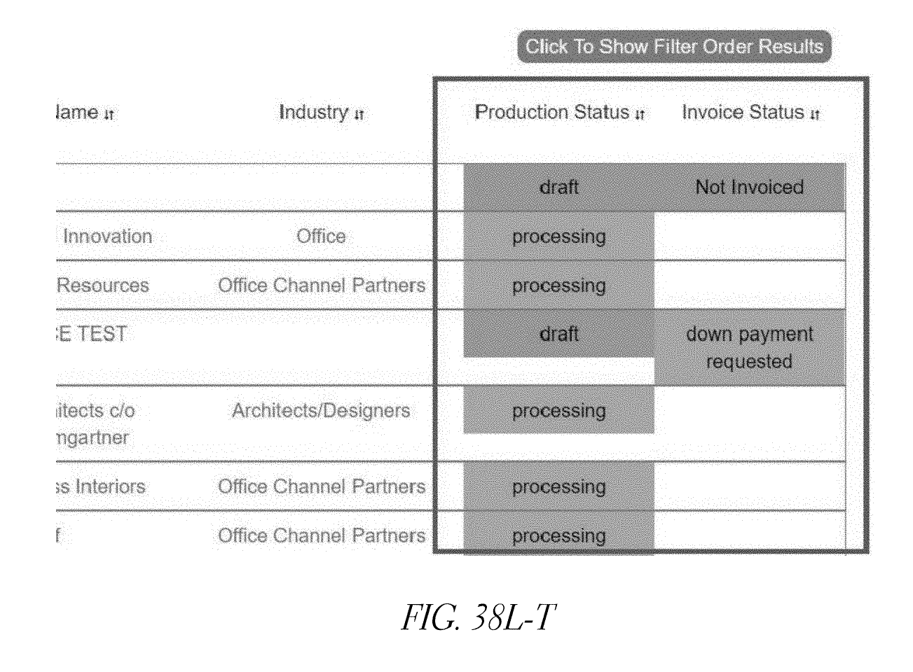

FIG. 38A illustrates an example CAD user interface. The user interface includes a tool section, a work area section, and a details section. In the illustrated example, tools include a wall drawing tool, a pan tool, a select mode tool, a bounding box tool, a delete object tool, a door add tool, a window add tool, a zoom in tool, a zoom out tool, a zoom to fit tool, an increase font size tool, a decrease font size tool, a print tool, and a clear tool. Tools may be provided for the placement of other components, such as other components described herein (e.g., wall hinges, shelves, shelf mounting hardware, leveling assemblies, conduits, floor support members, lights, electrical controls, and the like). The work area is an area where the user may specify a design, such as, by way of example, via drag and drop, or point and drop, of components, such as walls, doors and windows via respective tools. Other techniques may be used for placing components.

For example, to draw a wall, the CAD system may enable the user to select the wall drawing tool, indicate (e.g., via a tap of a pointing device on a touch screen or via a click of a mouse, pen, or other pointing device) a start position in the work area for the wall, then move (e.g., drag) the pointing device (e.g., a mouse, finger, or electronic pen) to an end position, and provide an end indication (e.g., by clicking the pointing device, lifting the pointing device from the touch screen, or otherwise provide an end indication), and the wall will be drawn between the start and end positions. Optionally, the system will continuously draw the wall from the start position to the current location of the pointing device cursor/indicator, until the user provides the end indication. Optionally, the CAD system enables the user to change the length of the wall by selecting one end of the wall and dragging it to a new desired position in the work area and/or by entering a numerical length in length field.

Optionally, the system quantizes the wall length as it is drawn so the wall is only drawn in increments corresponding to the lengths that can be assembled using available building modules (e.g., using a standard predefined wall module having the shortest length). For example, if the smallest standard available building block has a length of 2 feet, the system may only permit the user to draw a wall that is a multiple of 2 feet. Optionally, the user interface enables the user to define a wall angle relative to a vertical axis, relative to a side of a bounded space (e.g., defined using the bounding box tool described elsewhere herein), and/or relative to another wall in the work area. For example, the user interface may enable the user to drag one end of a wall at an angle. Optionally, a user interface is provided via which the user can specify (e.g., via an angle field) or select a numerically defined angle (e.g., 90 degrees, 45 degrees, or the like).

By way of further example, the CAD system may enable the user to select a wall that has been drawn, and then select a door or window, and the door or window are automatically placed at a location on the wall that satisfies one or more placement rules and optionally at a location that the system infers the user may want to place the door or window. For example, the rules may require that a window/door cannot be located closer than a specified distance or number of building components (e.g., building blocks) from the end of a wall or within a specified distance or number of building components (e.g., building blocks) from another window/door. Optionally, once a door or window is placed on a wall, the user can point at and select the door or window and drag it to a new location on the wall or delete it from the wall. By way of further example, a rule may indicate that a wall must be anchored to pre-existing studded wall, a solid support beam, or a support wall (e.g., where a support wall be a wall configured to form the top of a “T” shape ├ when connected to the wall being supported, where the wall being supported is connect to about the middle of the support wall). Another example rule may specify that a support wall must be at least a specified length (e.g., 3 feet long), be designed using 3 foot wall modules, and as tall as the wall that it is supporting. Other rules may indicate that a wall needs to be anchored at one end or at both ends. Still another example rule may indicate that a wall may not span more than a threshold number of feet (e.g., 15 feet), between anchor points.

Optionally, the system will indicate if the location violates a placement rule (e.g., via a pop up textual warning, highlighting the window, changing the color of the window, prevent the user from dropping the window at the location). Optionally, the user interface enables the user to specify a height and/or width of a window or door. Optionally, tools are provided via which the user can add and position other components, such as wall hinges (that enable the angle of connected, hinged walls to be changed), shelves and/or shelf mounting hardware, leveling assemblies, conduits (e.g., electrical or water conduits), floor support members, lights, electrical controls (e.g., wired or wireless light switches or switches), and the like.

The pan tool may be used to drag the design in the work area section so as to display a desired part of the design. The zoom in, zoom out, and zoom fit controls may be utilized to correspondingly control the zoom view of the design in the work area section. The select mode tool may be used to activate a select mode, wherein when the user clicks on a component in the work area, that component will be selected, and optionally the display of the component will be modified (e.g., via color, bolding, emphasized component outline, cross hatching, blinking, or otherwise) to indicate that the component has been selected. The bounding box tool is used to place a visible perimeter around an area of the work area. The perimeter may be used to indicate an area allotted for a structure being designed. Optionally, the system will generate a notification if the user places a portion of the structure outside of the perimeter. The font tools may be utilized to increase or decrease font size of selected text.

An example details area includes various detail controls, including a wall detail control, a wall list control, a plan details control, and a plan list control, which are described in greater detail elsewhere herein.

Optionally, a user interface is provided via which the user may specify whether building blocks used to design a structure are to be sized according to the metric system (e.g., building blocks having a length that is an integer number of meters or centimeters) or sized according to the U.S./Imperial system (e.g., building blocks having a length that is an integer number of feet or inches).

Optionally, a user interface (e.g., a materials menu) may be provided for display on a user terminal that enables a user to specify what material(s) a given component (e.g., block, panel, clip, skin, etc.) or module is to be manufactured from (e.g., steel, aluminum, ABS plastic, carbon fiber, MDF, plastic laminated MDF, fiberglass, and/or other materials). This enables a user to select the appropriate material based on cost, weight, fire resistance properties, water resistance properties, code requirements, and/or other criteria. Optionally, a user interface may be provided via which the user can provide (e.g., via a menu selection or text field entry) one or more building-related codes that the structure being designed needs to comply with. The system may then access from a rules data store rules associated with the provided codes, determine what materials need to be used for a given component to comply with such codes, and restrict the materials menu for a given component to listing only those that meet the code(s). The material-type may be indicated in the parts list.

Optionally, a skin menu is provided via which the user can select a desired skin from available skins (e.g., to be applied to blocks, panels, caps, and/or other components). For example, the skin menu may enable a user to select from one or more of the following skins: raw MDF, vinyl MDF, corkboard, blackboard, white dry-erase, ECLICK paintable, a particular wood finish (e.g., pine, walnut, oak, etc.), and/or the like. Optionally, a cap menu is provided via which the user can select from available caps (e.g., wood, metal, none, etc.) for a wall side, wall top, wall bottom, or other assembly. Optionally, a plate menu may be provided which enables a user to indicate that there is to be a plate on one side of the wall, both sides of the wall, or neither side of the wall. Optionally, a cleat menu may be provided which enables a user to indicate that there are to be one or more cleats, or no cleats. Optionally, a level menu may be provided which enables a user to indicate that there is to be a levelling assembly (which may be used to level the wall when set on an uneven surface). Any specified skins, caps, plates, and/or cleats may be added to the parts list and order, and may be rendered in the work area and/or details area.

Optionally, a control may be provided that enables the user to specify a custom block size. For example, in response to activating a “wild card” block control, height and width text fields and/or menus may be presented via which the user can specify a custom height and/or width for a custom block.

The user selections of materials, skins, caps, plates, cleats, levelling assemblies, blocks sizes, and/or other components or component characteristics will then be utilized to generate a corresponding order, manufacturing to satisfy the order, and delivery of corresponding components.

FIG. 38B illustrates the user interface of FIG. 38A after three walls were drawn using the wall drawing tool, a door module was added using the door tool, and a window module was added using the window tool. Optionally, the door module and the window module are a default door module and a default window module having respective predetermined dimensions (e.g., a predefined height, width, and depth), mechanisms, and/or styles. Optionally, a menu of two or more window module-types (e.g., having respective different dimensions and/or respective different styles (e.g., with grids, without grids, modern, Mediterranean, other architectural styles etc.) and/or mechanisms (e.g., slider, single hung, double hung, awning, etc.) is provided, wherein the user can select a desired window module-type. Optionally, a menu of two or more door module-types types (e.g., having respective different dimensions and/or respective different styles (e.g., slap, with panels, with built in window, modern, Mediterranean, other architectural styles etc.) and/or mechanisms (e.g., slider, hinged, bi-fold, etc.)) is provided, wherein the user can select a desired door module-type. Optionally, one or more fields are provided via which the user can specify custom dimensions, styles, and/or mechanisms for a window module or a door module. Optionally, one or more fields and tools are provided via which the user can specify dimensions for a space to be left empty and reserved for placement of a user supplied module or to simply be left unfilled.

The system may automatically generate and/or access, and provide for display various items of metadata. For example, the system may automatically generate and display a wall identifier for each wall (“A”, “B”, and “C” in this example). Optionally, a user interface is provided via which the user can change a wall identifier. In this example, the system automatically tracks the length of a wall as it is being drawn and generates a display of the wall length in real-time. Once the user specifies the end location for the wall, the system generates and displays in association with the wall the final wall length, as determined by the system. In this example, wall “A” has a length of 7 feet, wall “B” has a length of 8 feet, and wall “C” has a length of 10 feet. Optionally, a user interface is provided via which the user can specify whether the unit of measure is to be provided via the metric system (e.g., in meters or centimeters) or the US/Imperial system (e.g., in feet or inches), and the units of measurement to use (e.g., meters or centimeters). Optionally, other metadata, accessed from a component library (e.g., dimensional information, application information, load bearing information, electrical connection information, color information, cost information, lead time ordering information, as relevant), may be provided for display as well. In this example, wall “A” has been selected and is emphasized by the system (by being filled in with a solid color) to indicate the selection.

In this example, the walls are of a fixed width corresponding to the width of a predefined standard building block module, where the user is optionally prevented from changing the wall width.

Optionally, the system quantizes the placement of a component (e.g., a door or window) so that the component is placed only at positions that will enable the wall to be assembled using available building modules (e.g., using a standard predefined wall module having the shortest length). For example, if the shortest standard available building module has a length of 2 feet, the system may only permit the user to position a window at the edge of the wall, or in multiples of 2 feet from the wall edge (e.g., 2 feet from the wall edge, 4 feet from the wall edge, and so on).

The details area displays details corresponding to one or more walls in the design area and the selected details control. In this example, the wall details control is selected. The displayed wall details correspond to the currently selected wall (wall “A” in this example). The wall details include the identifier corresponding to the selected wall, the wall length, the wall height, the window position (if any), the door position (if any), a skin identifier for the selected skin (e.g., raw MDF, vinyl MDF, corkboard, blackboard, white dry-erase, ECLICK paintable, a particular wood finish (e.g., pine, walnut, oak, etc.), and/or the like) for a first side of the wall, and a skin identifier for the selected skin for a second side of the wall. In this example, the window position is provided as the number of feet between the left side of the window and the left side of the wall. Similarly, the door position is provided as the number of feet between the left side of the door and the left side of the wall. In this example, the door position is 2 feet and the window position is “none” (because there is no window in the wall). If there were no building blocks between the left side of the door and an end of the wall (where the door is position so that its left side is coterminous with the left side of the wall), the position may be given as “0”. Optionally in addition or instead, a door or window position may be specified as the number of building blocks from an end of the wall.

A control is provided via which the user can indicate that a selected drawn wall is an existing wall (e.g., not a wall that is being designed or for which building modules are being ordered, but to which a wall being design is to be attached). If the user selects the existing wall control, the system prevents the user from adding skins to the selected wall. Further, optionally the system will not generate and/or display a parts list for the existing wall and will not generate manufacturing instruction for the existing wall.

A user interface may be provided via which a user can define an order for bulk walls. For example, fields may be provided that enables a user to specify average wall length, average wall height, and/or total wall area. A calculate control may be provided that causes a parts lists of components to be calculated and presented for the bulk walls.

The wall details user interface also includes a drawing (e.g., a schematic) generated by the system of the designed wall, including the building block types the system has determined as an efficient way to construct the wall and their position, as well as any door units or window modules included in the design. A given block may include a block-type identifier, which may be a block length (e.g., a 3 foot block, a 2 foot block, a 1 foot block, and the like). In this example, the building blocks include four 2 foot blocks, two 3 foot blocks, and one 1 foot block. The wall drawing may also indicate the height of respective building blocks, or a portion thereof. The height, width, and/or length dimensions of a given assembly or component, and/or the placement coordinates, may be accessed from memory and displayed over or adjacent to the corresponding assembly or component (e.g., a panel assembly, block, other component or assembly disclosed herein, and/or the like).

A delete control may be displayed over or adjacent to the depicted assembly or component, wherein activation of the delete control may cause the corresponding assembly or component to be deleted from the wall details user interface, and corresponding parts list.

FIG. 38C corresponds to the interface of FIG. 38B, except wall “B” is selected. In this example, the user has selected the wall height menu, and can select a wall height from among those included in menu (e.g., 10 feet, 9 feet, 8, feet, 80 inches, 40 inches, etc.). Optionally, the wall height menu is dynamically modified so that it only includes wall heights for the selected wall that satisfy corresponding rules. For example, a rule may specify that a wall that has a window module must be at least 6 feet high. Another rule may specify that a wall that has a door unit must be at least 8 feet high. Thus, if a wall includes a window module but not a door, 6 feet may be shortest height included in the dynamically adjusted wall height menu. By way of further example, if a wall includes a door unit, 8 feet may be shortest height included in the dynamically adjusted wall height menu. Of course other rules may be utilized. Different rules may be used when using customized door or window modules (e.g., more conservative rules as the customized modules may not have been tested for strength, stability, etc.).

FIG. 38D corresponds to the interface of FIG. 38C, except in this example, the user has selected the skin B menu, and can select a skin to be applied to the B side of wall B from among those included in menu (e.g., none, MDC, Drywall, CLICWALL, a specified wood finish (e.g., pine, oak, walnut, Zebra, etc.), whiteboard, blackboard, white dry erase, etc.).

FIG. 38E corresponds to the interface of FIG. 38B, except in this example, the user has selected wall “C”, and has selected the “existing wall” control, indicating that wall “C” is an existing wall (e.g., a preexisting, conventional, non-modular wall), not a wall that the user is designing or needs to order modules to build. One or more controls or menu items may be deactivated and visually modified (e.g., greyed out) to indicate that the user cannot currently access such controls or menu items. For example, the skin A and skin B menus may be deactivated or otherwise rendered unusable. Optionally, the wall height control is still enabled so that the user can specify the height of the existing wall. Optionally, the system prevents the user from adding doors or windows via the CAD system to the designated existing wall. Optionally, the wall details interface does not display a drawing of the existing wall or does not display a drawing that includes the building block types the system has determined as an efficient way to construct the wall. Optionally, the system does generate a drawing (e.g., a schematic) generated by the system of the existing wall, including the building block types the system has determined as an efficient way to construct the wall and their position, but provides a visual indication (e.g., greying out at least a portion of the drawing and/or a textual notification) that the wall is an existing wall.

FIG. 38F corresponds to the interface of FIG. 38B, except in this example, the user has selected the wall list. The system aggregates the wall details for the walls in the work area and presents the information via the wall list at the same time as displaying the design in the work area.

FIG. 38G corresponds to the interface of FIG. 38B, except in this example, the user has selected the parts list control. The system generates a plan specification and a parts list based on the design in the work area and causes the specification and parts list to be displayed. The specification may include the plan name, plan notes, the name/identifier of the person who created the design, the total linear of feet the designed walls (optionally excluding the length of the existing wall), the total area (e.g., square feet one side of each wall, optionally excluding the length of the existing wall), the total number of blocks, and the total number of courses. The parts list may include the quantity of each type of block, the number of door kits, the number of window kits, the number of clips, and the number of square feet of each type of skin.

The number of clips may be determined by the system based at least in part on the number of internal seams on each course of the wall. Optionally, the system may determine that clips are only needed for certain courses (e.g., only top and bottom courses). For example, the system may optionally specify that on the bottom course, clips are to be placed on the bottom of each inner seam. By way of further example, the system may optionally specify that on the top course, clips are placed at the top of each inner seam. FIG. 38G-1 illustrates (via circle icons) clip placement for a 10 ft wall. Thus, by way of example and not limitation, the number of clips for a given wall may equal or be based at least in part on the number of internal seams on the bottom course plus the number of internal seams on the top course plus. Optionally, the number of clips calculated by the foregoing example equation may be a minimum number of clips for a wall, but additional clips may be used (e.g., by positioning clips on internal seams of one or more other courses, by positioning clips on every other internal seam of one or more other courses, or the like).

The system may optionally further calculate and present the number of floor supports, such as floor plates and/or leveling assemblies for a given wall. For example, the number of floor supports and their placement may be determined based at least in part on the length of the “unsupported” length of a wall. By way of illustration, optionally the system may place a floor support (and/or other form of wall support, such as a “dead man” retaining wall) every “x” number of feet (e.g., every 8, 10, or 12 feet) of unsupported wall length. The floor supports may be configured and placed for use as a leveling solution and/or to prevent “kick-out” of walls. Optionally, the placement of floor supports (e.g., leveling assemblies) may be determined based at least in part on received pictures and/or measurements of a proposed build area (which may include displacement measurements of the following from a plane), which may be used by the system to create a topographic map of the floor showing elevations and placement of objects (e.g., existing walls, columns, etc.). For example, measurements used to create the topographic map of the floor may be generated using image processing of photos, 3D scanning cameras, laser measurement devices (e.g., laser range finders, LIDARs, etc.), sonar devices and/or using other measurement techniques. This information (e.g., which indicates upward and/or downward changes in floor level) may then be used to automatically generate placement locations for floor leveling supports to ensure that the bottom course (and the wall has a whole) is maintained at a level position (e.g., parallel to a plane of the floor).

FIG. 38H corresponds to the interface of FIG. 38B, except in this example, the user has selected the “my plans” control. The system accesses from memory the user's account information, accesses plan data for the user's plans, and generates the user interface illustrated in FIG. 38H for display on the user terminal. The user interface may include the name assigned by the user or the system for each plan, user notes, the date last modified, and an identifier generated by the system. The user can click on a given plan name (which acts as a link), which when activated causes the system to access and provide for display the selected plan. Edit controls are provided which when activated by the user causes the corresponding text to be placed in an edit user interface enabling the user to edit the text.

FIG. 38I illustrates an instance in the work area where a user attempted to place two window modules too close together on wall “B”. The outline of the window modules may have their color changed (e.g., to red or another color) and the overlap is depicted. The wall details area shows the wall drawing with the first window the user placed on wall “B”, but the system will not enable the second window to be displayed in the wall drawing until the system detects that the user has moved one or both windows so that they do not overlap and are separated by at least a threshold difference. In response to detecting the at the user has positioned the windows so that they are separated by at least the threshold amount, the system may update the wall drawing in real time to show the positions of both windows. Optionally, the update is performed in response to a user activating a refresh control.

FIG. 38J corresponds to the interface of FIG. 38B where the user placed a bounding box around the existing wall “C” and an area designated for the new walls.

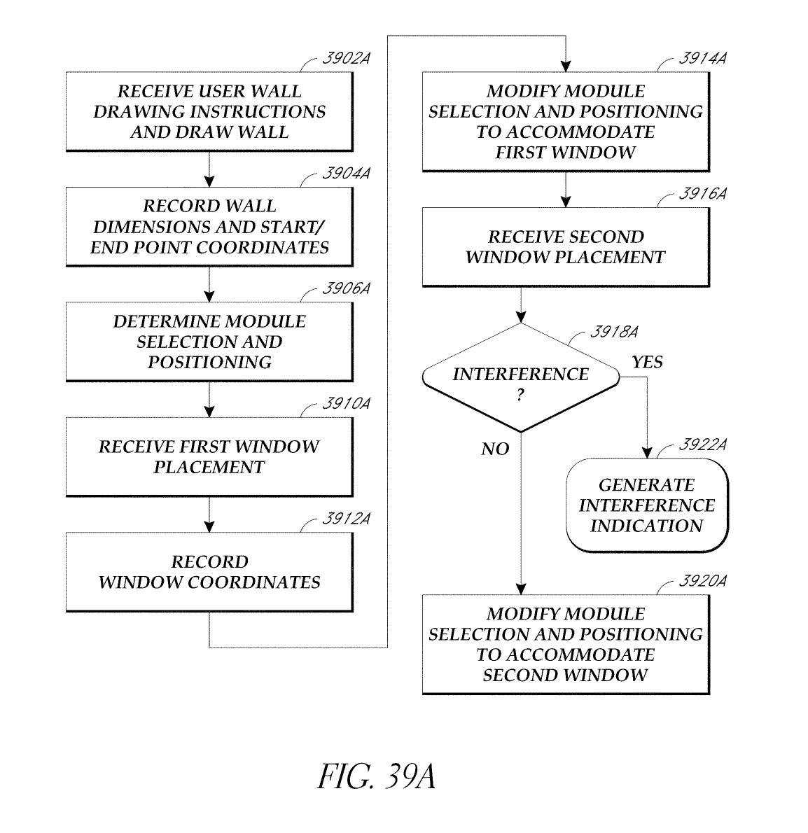

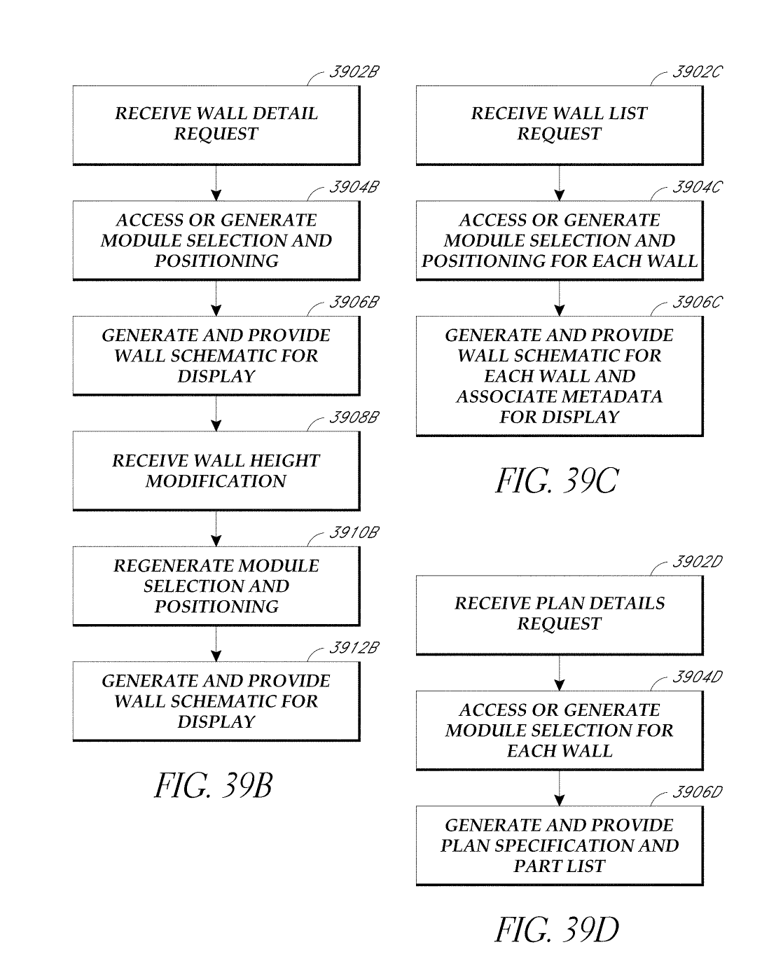

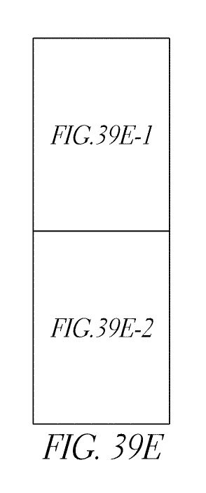

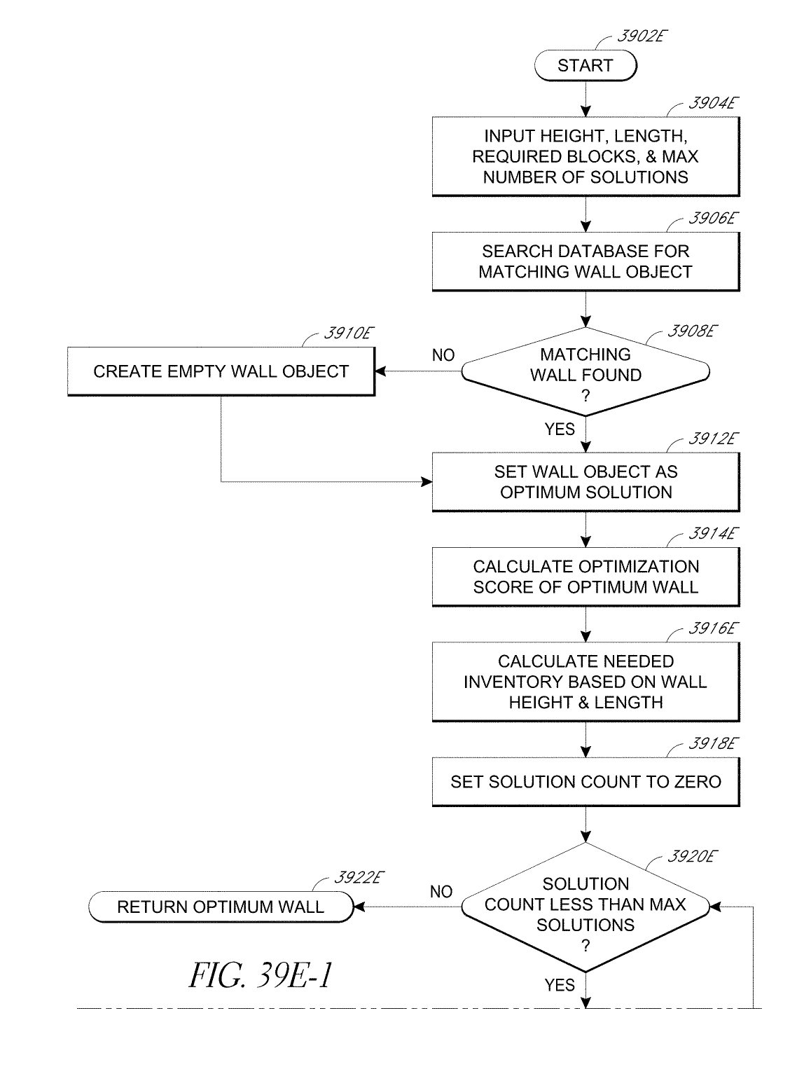

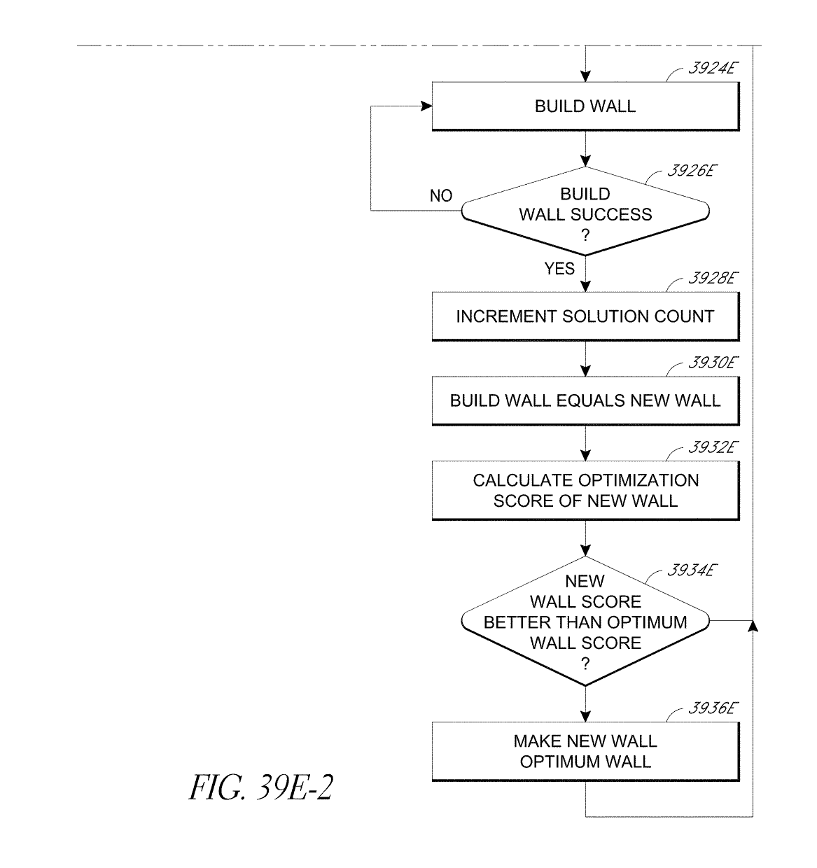

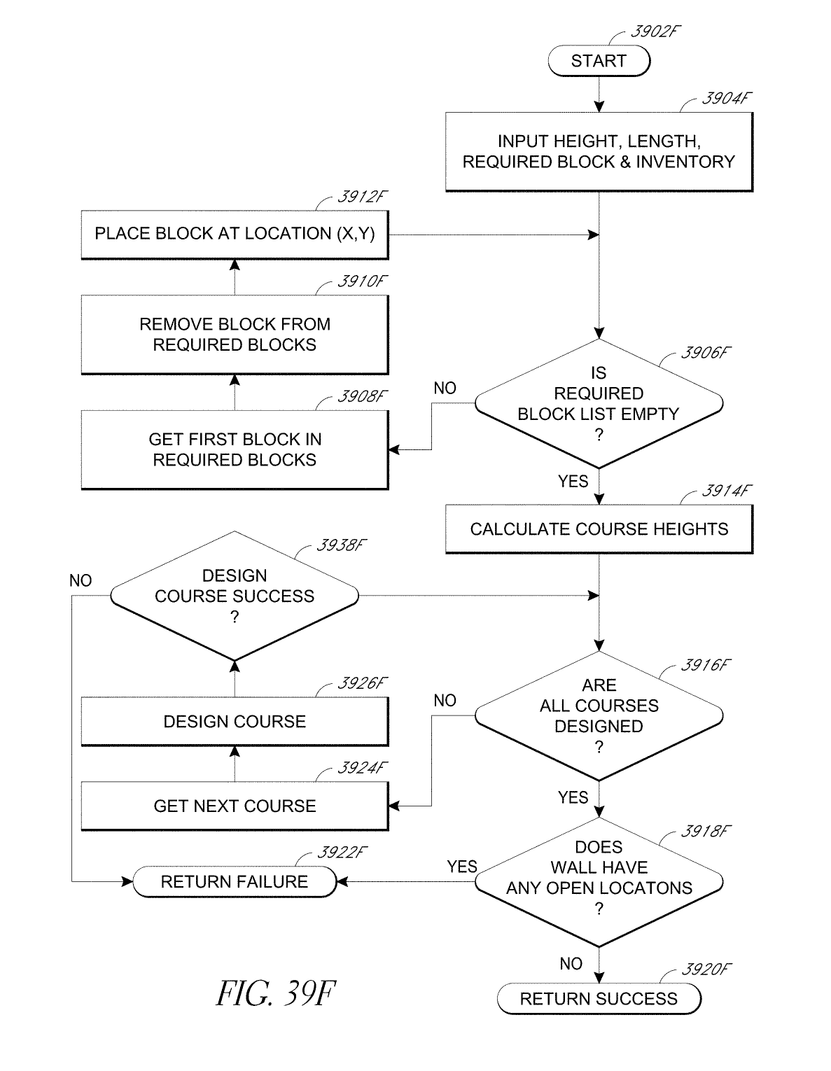

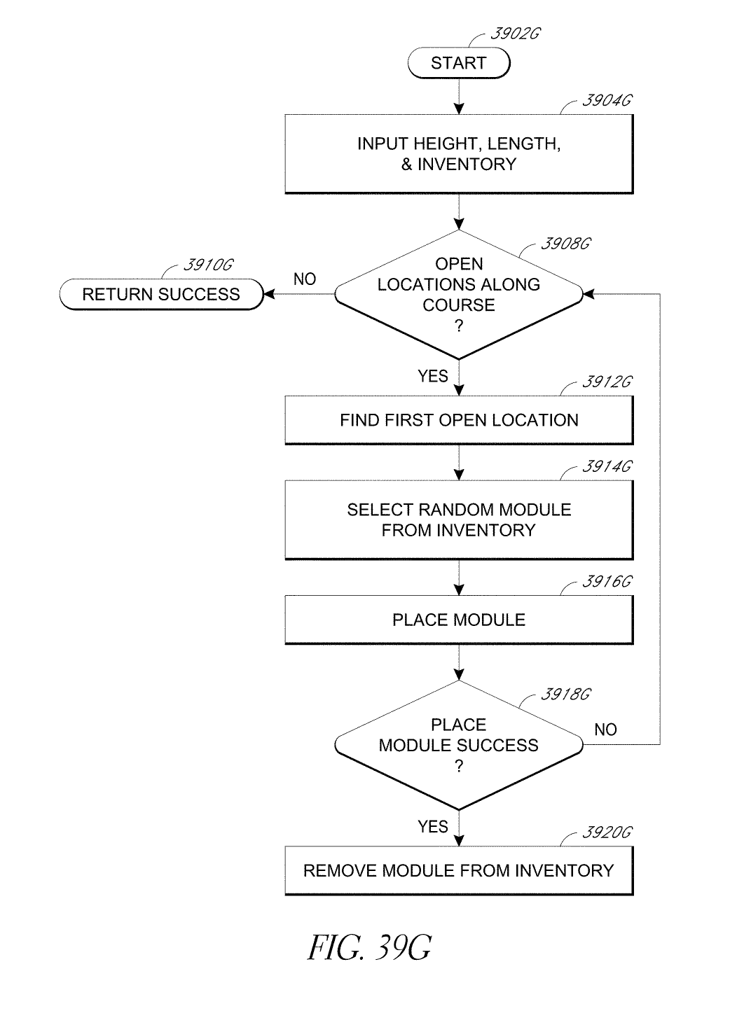

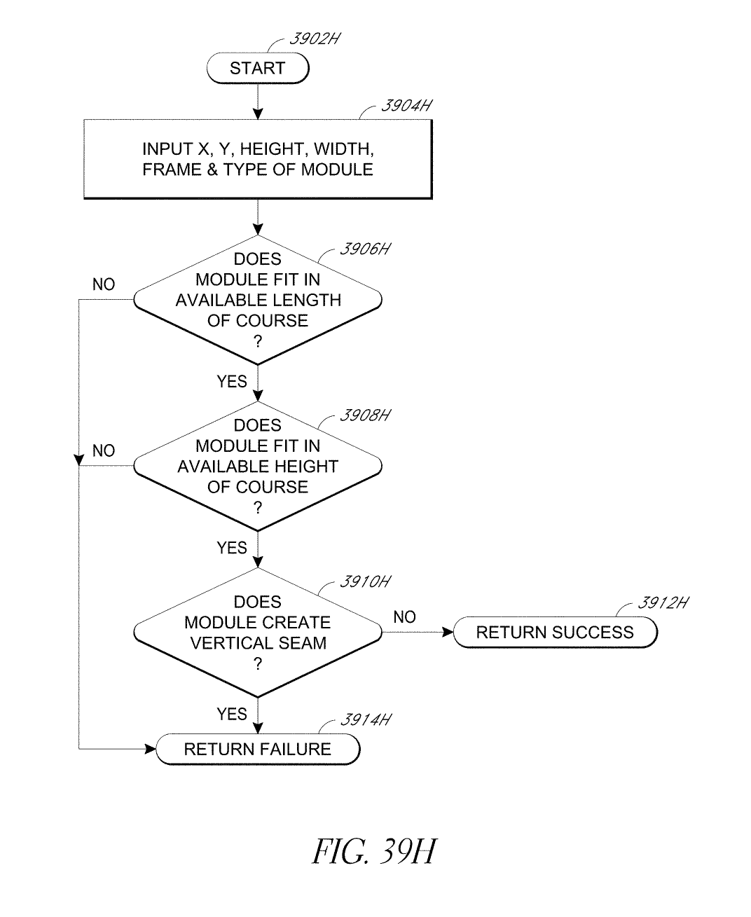

FIGS. 39K-a, 39K-b, 39K-c, 39K-d, 39K-e illustrate screen shot images from an example animation. As noted above, the system may generate an animation in a build pane showing the building of each wall, other structure, panel, header unit, door unit, other assembly, component, and/or the like.

The animation may show components (e.g., modules, skins, brackets, clamps, clips, leveling assemblies, and/or other components), “flying” through empty space, optionally in the correct assembly order, position, and/or orientation. The animation may similarly show the insertion of screws (e.g., through the panels into receiving screw holes in the corresponding blocks), nails, or other fastening devices in the correct order and at the correct positions.

Referring to FIG. 39K-a, a room into which the example modular structure is to be assembled is illustrated. The illustrated room may be a generic room (e.g., selected and accessed from a library of generic rooms of different types, such as office space, convention hall, etc.) or may accurately depict an actual room in which the example modular structure is to be assembled. For example, the room dimensions and features may optionally be imported from another system (e.g., a system that stores architectural plans of the room). The room dimensions and features may optionally be determined from photographs of the room, and/or using information from measurement devices such as 3D scanning cameras, laser range finders (e.g., LIDARs), sonar devices and/or from other measurement devices.

A field is provided via which a user may enter a plan identifier (e.g., an alphanumerical unique identifier). In response to user activation of a “load new plan” control, the system will search its database for a plan matching the plan identifier, and if a match is found, it will load the plan and display it, as illustrated in FIG. 39K-b. If more than one plan matches the identifier (e.g., because the user only entered in the first three identifier characters), the system may display all the plans that match the partial identifier, and may continuously and incrementally filter the plans displayed as the user enters additional identifier characters.

In the example illustrated in FIG. 39K-b, modules are flying though the room towards their proper location within the room, on the floor of the room. The user may rotate the view of the room. For example, if the user is utilizing a keyboard, the user may use the arrow keys or WASD letter keys to “move” through the animation so as to view the animation from any view point at a given elevation.

Referring to FIG. 39K-c, a free movement control is provided, which when activated enables the user to change the elevation viewpoint so as to “fly” up in the animation so as to view the structure from above. For example, activation of the “R” key may cause the viewpoint to be from an increasingly elevated position, while activation of the “F” key may cause the viewpoint to be from an increasingly lower position. If the user is utilizing a terminal with a touch screen, then fingers, stylus, or other touch inputs may be used to similarly enable the user to navigate the viewpoint through the animation. If the user is utilizing a device, such as a smart phone, tablet computer, with a gyroscope or other orientation sensor, the animation viewpoint may change in response to corresponding rotation or tilt of the device.

By way of further example, if the user is wearing a virtual reality (VR) or augmented reality (AR) headset, the user may simply turn the user's head, the head rotation may be detected, and the animation will be rotated so that the view corresponds to where the user's eyes are directed. The user may “walk” through the animation by activating corresponding handset controls, via head gestures, eye gestures, or otherwise. Depending on the VR or AR system being utilized, the user may be enabled to physically walk through the animation.

Referring to FIG. 39K-d, an apply skin control is provided, which when activated, causes a user specified skin to fly through the room and be visually applied to the modules so that the user can see how the skin with look after being applied.

Referring to FIG. 39K-e, a control may be provided which enables the user to command the user interface to hide menus, fields, and the like, to thereby enable the user to view the animation with no distractions or obscuring controls.

Thus, the foregoing user interfaces enable the user to view what the user-designed structure will actually look like when assembled in its intended location from different angles and elevations. If the user is dissatisfied with the structure design (e.g., with respect to its appearance, fit, functionality, and/or for other reasons), the user may access and modify the structure design via other user interfaces described herein.

FIG. 39A illustrates an example process utilizing an example CAD system, such as that discussed above. Aspects of the process may be performed by a client device and/or one or more servers remote from the client device. Although the following example refers to the placement of two windows, the process may be utilized for other types of components or combination of components, such as doors, shelves, other components described herein, and the like.

At block 3902A, user wall drawing instructions are received. As similarly discussed elsewhere herein, the wall drawing instructions may be received via a user manipulation of a wall drawing tool in a work area user interface. The process may cause the wall to be drawn in response to the user indicating a start point in the work area (e.g., by clicking on a pointing device control, by tapping on a touch sensitive screen, or otherwise) and cease drawing the wall in response to the user indicating an end point in the work area. At block 3904A, start and/or end point coordinates may be stored (e.g., xy coordinates) in memory, and optionally one or more wall dimensions are stored (e.g., wall length, wall height, and/or wall width) in memory. Optionally, only one of the start or end point coordinates is stored, in association with the wall length. Optionally, an angle orientation of the wall is stored.

At block 3906A, the process determines which predefined building modules (e.g., a combination of one or more 1 foot length, 2 foot length, 3 foot length, and/or 4 foot length building modules, which may be configured as the example wall modules described herein) are to be used to construct the wall, and the position of the building modules in the wall. Optionally, a placement routine will stagger courses of modules so that a seam between two modules in a first course does not line up with a seam between two modules on an adjacent course (directly above or below the first course).

At block 3910A, the process receives a first window placement on the wall (e.g., using techniques and tools described elsewhere herein). At block 3912A, the process records the window coordinates. For example, the XY coordinates of one or more window corners may be recorded, optionally in association with window dimensions (e.g., height and/or width dimensions). At block 3914A, the building module selection and positioning is modified to accommodate the window at its designated position. For example, if a window is added and the wall size is unchanged, the total surface area of the needed modules is reduced. However, the number of modules may increase or decrease, although if the number of modules is increased, the size of at least some of the modules is decreased to accommodate the window.

At block 3916A, the process detects placement of a second window (or other component) on the wall. At block 3918A, the process determines whether the placement of the second window violates a rule. For example, the process may determine that the placement of the second window causes the second window to overlap the first window, thereby causing an interference condition. By way of further example, the process may determine that the placement of the second window with respect to the first window is structurally unsafe, even if there is not an overlap between the first window and the second window. By way of example, to ensure structural integrity, a rule may specify that windows cannot be placed less than a threshold distance apart (e.g., 1 foot, 2 feet, or other distance). The rule may dynamically take into account the wall height and length, and/or the window(s) height and width, in determining whether a window position is unsafe.

If a rule is violated, at block 3222A a corresponding visual, audible, physical indication may be provided to the user via the user terminal. For example, if two windows are placed so that they overlap and interfere with each other, the outline of the window may have their color changed (e.g., to red or another color) and the overlap visually depicted. In addition or instead, a notification icon may be presented which when selected causes an explanation of the error condition to be presented. An audible sound (e.g., a beep, several notes, a spoken word, or the like) may in addition or instead be generated and played via the client system. In addition or instead, a haptic indication (e.g., using a vibration device comprising one or more actuators) may be provided via the user pointing device or display. The process may optionally inhibit the ordering of a set of building modules for the wall design until the window position is modified so that a rule is not violated.

At block 3914A, the building module selection and positioning is modified to accommodate the second window at its designated position. For example, if the second window is added and the wall size is unchanged, the total surface area of the needed modules is reduced. However, the number of modules may increase or decrease, although if the number of modules is increased, the size of at least some of the modules is decreased to accommodate the second window.

FIG. 39B illustrates an example process relating to generating wall detail data. At block 3902B, a wall detail request is received for at least a first selected wall (e.g., a wall selected in the work area as described elsewhere herein). For example, the wall detail request may be received as similarly discussed above with respect to FIG. 38B. At block 3904B, the process determines which predefined building modules (e.g., a combination of one or more 1 foot length, 2 foot length, 3 foot length, and/or 4 foot length building modules, which may be configured as the example wall modules described herein) are to be used to construct the wall, and the position of the building modules in the wall (e.g., as determined using processes illustrated in FIGS. 39E-39H). Optionally, the module selection will be limited to those that are determined to be available in an inventory of modules. Optionally, the module selection and placement have already been performed and stored in memory, and such data may be accessed from memory.

At block 3906B, a wall drawing (e.g., a wall schematic) may be generated using the module selection and placement, and provided for display via the user terminal. The wall drawing may include the selected building block types the system has determined as an efficient way to construct the wall and their position, as well as any components (e.g., doors and/or windows) included in the design. A given block may include a block-type identifier, which may be a block length (e.g., a 3 foot block, a 2 foot block, a 1 foot block, and the like). The wall drawing may also indicate the height of respective building blocks, or a portion thereof. The process may access and/or generate other wall details and provide them for display via the user terminal. For example, the wall details may include a wall identifier, wall length, wall height, window position (if any), door position (if any), skin identifier (if any) for the selected skin for a first side of the wall, and a skin identifier (if any) for the selected skin for a second side of the wall.

At block 3908B, a wall height modification may be received (e.g. via the wall height interface illustrated in FIG. 38B). At block 3910B, the building module selection and positioning is recalculated. If the change in wall height causes a rule violation, a notification may be generated and optionally, the building module selection and positioning are not modified. For example, if the wall includes a window module, and the process determined that the change in wall height would cause the wall to be shorter than the window, the process may cause a corresponding visual, audible, and/or haptic notification to be provided via the user terminal. Optionally, the wall height menu is dynamically modified so that it only includes wall heights that satisfy corresponding rules.

At block 3912B, a new wall drawing is generated reflecting the height change, and is provided for display on the user terminal. Optionally, the process may provide interfaces via which the user can specify a skin-type for one or both sides of the wall.

FIG. 39C illustrates an example process relating to generating wall list data. At block 3902C, a wall list request is received for one or more walls (e.g., all the walls, or all the non-preexisting walls) displayed in a work area user interface. For example, the wall list request may be received as similarly discussed above with respect to FIG. 38F. At block 3904C, the process determines which predefined building modules (e.g., a combination of one or more 1 foot length, 2 foot length, 3 foot length, and/or 4 foot length building modules, which may be configured as the example wall modules described herein) are to be used to construct the walls, and the position of the building modules in the walls. Optionally, the module selection and placement for the walls have already been performed and stored in memory, and such data may be accessed from memory.

At block 3906C a wall drawing (e.g., a wall schematic) may be generated for each wall using the module selection and placement, and the wall drawing may be provided for display via the user terminal. The wall drawing for a given wall may include the selected building block types the system has determined as an efficient way to construct the wall and their position, as well as components (e.g., doors and/or windows) included in the design. A given block may include a block-type identifier, which may be a block length (e.g., a 3 foot block, a 2 foot block, a 1 foot block, and the like). The wall drawing may also indicate the height of respective building blocks. The process may access and/or generate other wall details for each wall and provide them for display via the user terminal. For example, the wall details may include a wall identifier, wall length, wall height, window position (if any), door position (if any), skin identifier (if any) for the selected skin for a first side of the wall, and/or a skin identifier (if any) for the selected skin for a second side of the wall. If a wall has been designated as a preexisting wall, a corresponding visual indication may be generated and provided in association with the drawing of the preexisting wall. For example, the wall drawing for the preexisting wall may be in a different color than the other walls (e.g., a grey color). Optionally instead, no wall drawing is generated or provided for the preexisting wall.

FIG. 39D illustrates an example process relating to generating plan data. At block 3902D, a plan list request is received for one or more walls (e.g., all the walls, or all the non-preexisting walls) displayed in a work area user interface. For example, the plan request may be received as similarly discussed above with respect to FIG. 38G. At block 3904D, the process determines which predefined building modules (e.g., a combination of one or more 1 foot length, 2 foot length, 3 foot length, and/or 4 foot length building modules, which may be configured as the example wall modules described herein) are to be used to construct the walls, and the position of the building modules in the walls. Optionally, the module selection and placement for the walls have already been performed and stored in memory, and such data may be accessed from memory.

At block 3906D, a plan specification and a parts list are generated based on the design in the work area, and the specification and parts list are displayed via the user terminal. The specification may, for example, include the plan name (e.g., previously entered by the user via a plan name field), plan notes (e.g., previously entered by the user via a plan notes field), the name/identifier of the person who created the design, the total linear feet of the designed walls (optionally excluding the length of the existing wall) based on a summation of linear feet for each wall, the total area (e.g., the square feet one side of each wall) calculated based on the summation of the area for each wall (optionally excluding the area of the existing wall), the total number of blocks calculated based on the number of blocks for each wall, and the total number of courses. The parts list may include some or all of the following information: the quantity of each type of block based on a summation of each type of block for each wall, the number of door kits based on a summation of the number of door kits for each wall, the number of window kits based on a summation of the number of window kits for each wall, the number of other components for each other component type, the number of clips, the number of other components for each other component type (e.g., the number of wall hinges, shelves, shelf mounting hardware kits, leveling assemblies, conduits, floor support members, lights, and/or electrical controls), number of square feet of each type of skin based on a summation of the number of square feet of each type of skin for each wall.

Example pseudo code for wall module selection and placement for a wall design is provided below, although other techniques and other module selection and placement algorithms may be utilized:

PLACE_MODULE( ):
Inputs:
X: [int]—Desired horizontal distance between the bottom left corner of the Module and the bottom left corner of the Wall measured in inches.
Y: [int]—Desired vertical distance between the bottom left corner of the Module and the bottom left corner of the Wall measured in inches.
H: [int]—Height of the Wall in inches
L: [int]—Length of the Wall in inches
Frame: [boolean]—Indicates if the module has a frame around the edges
Type: Indicated the type of the module (i.e. “stock”, “door”, “window”, “wildcard”, etc.)
Method:
IF module width will fit in the available width of the course, AND
IF module height will fit in the available height of the course, AND
IF module will not align its vertical edges with another module in a course immediately above or below:
THEN place the module into the Wall at location (X,Y), AND
return SUCCESS
ELSE:
THEN do not place module, AND
return FAILURE BUILD_COURSE( ):
Inputs:
H: [int]—Height of the Wall in inches
L: [int]—Length of the Wall in inches
Inventory: [array]—An array containing all the available modules in the current inventory allotted to build the course. Note: The array can contain multiple instances of the same module.
Method:
WHILE the Course has open locations along its length,
FIND the first open location from the left edge of the course,
SELECT a Module from Inventory at random,
PLACE_MODULE at open location,
IF PLACE_MODULE( ) is SUCCESS:
REMOVE Module from Inventory & CONTINUE
ELSE IF PLACE_MODULE( ) is FAILURE:
CONTINUE
IF Course has no open locations along length:
return SUCCESS
ELSE:
return FAILURE

BUILD_WALL( ):
Inputs:
H: [int]—Height of the Wall in inches
L: [int]—Length of the Wall in inches
ReqBlocks: [array]—An array containing all required blocks as defined by the user
Inventory: [array]—An array containing all the available modules in the current inventory allotted to build the course. Note: The array can contain multiple instances of the same module.
Method:
WHILE the ReqBlocks is not empty,
GET first Block in ReqBlocks array,
PLACE_BLOCK( ) at prescribed (X,Y) location,
REMOVE Block from ReqBlocks
CALCULATE Courses based on the prescribed height of the wall using MAP function (i.e. 120″ Wall→Courses 41″, 41″, 38″)
FOR EACH Course in Wall:
BUILD_COURSE( )
IF BUILD_COURSE is SUCCESS:
CONTINUE
ELSE:
ABORT BUILD_WALL( ), AND
return FAILURE
IF Wall has no open locations along length:
return SUCCESS
ELSE:
return FAILURE

OPTIMIZE_WALL( ):
Inputs:
H: [int]—Height of the Wall in inches
L: [int]—Length of the Wall in inches
ReqBlocks: [array]—An array containing all required blocks as defined by the user
MAX_SOLS: [int]—The maximum number of solutions to calculate before returning an optimized Wall
Method:
SEARCH DATABASE for existing Wall solution
IF EXISTS Wall:
SET Wall as OPTIMUM WALL
ELSE:
SET None as OPTIMUM WALL
CALCULATE optimization score of OPTIMUM_WALL
Note: In this example, the optimization score of None is 0
OPTIONALLY CALCULATE Inventory based on 2-2-3 Block ratio
Note: 2-2-3 ratio aims to make any wall, regardless of length, from the same ratio of 2-1 ft blocks, 2-2 ft blocks, & 3-3 ft blocks. This improves the ability to control inventory, as optionally the same ratio of blocks may be shipped regardless of wall lengths being ordered. However, other ratios or no ratios may be used.
SET solution counter NUM_SOLS equal to zero
WHILE NUM_SOLS is less than MAX_SOLS:
BUILD_WALL( )
IF BUILD_WALL is SUCCESS:
INCREMENT NUM_SOLS counter
Store the new Wall as NEW_WALL
CALCULATE optimization score of NEW_WALL
IF the optimization score of NEW_WALL is greater than score of OPTIMUM_WALL:
NEW_WALL becomes OPTIMUM_WALL
CONTINUE
   RETURN OPTIMUM_WALL

Example processes will be described for optimizing a wall design, designing a wall, designing a course (sometimes referred to as a row or level), and placing a module (e.g., a wall module).

FIG. 39E (including FIGS. 39E-1, 39E-2) illustrates an example wall optimization process. Optionally, the optimization process utilizes Montes Carlo simulation that performs repeated random sampling to generate numerical results which may be ranked.

The process starts at block 3902E. At block 3904E, the process inputs various wall criteria that design needs to comply with. For example, the process may input a wall height (e.g., as specified by the user as described elsewhere herein), a wall length (e.g., as specified by the user as described elsewhere herein), blocks/modules/empty spaces with non-adjustable positions (sometimes referred to herein as “required blocks” or “wildcards”), and/or the maximum number of solutions that are to be generated prior to halting the wall optimization process.

A “required block” may be a door module, window module or open space (e.g., which may be used for a user-supplied component) which the user has specified is to be at a certain position in the wall (e.g., where the required block position may be specified using multiple xy positions (e.g., an xy position for respective corners of a square or rectangular “reserved” area, provided numerically or graphically)). The optimization process may design the wall around such required blocks, without changing the position of the required blocks. The maximum number of solutions criteria may be utilized to prevent the process going into an endless loop of wall optimization or spending an inordinate amount of computer resources and time in generating a vast number of wall design solution iterations, with a diminishing return in terms of improved design.

At block 3906E, the process accesses a database of existing wall designs (some or all of which may have been produced via a previously executed optimization process) and searches for an existing wall design that matches criteria inputted at block 3904E (e.g., has the specified height, length, and required blocks/reserved locations). If no matching wall is found, at block 3910E, the process creates an empty wall object (rather than using an existing wall design). If a match is found, the matching wall design solution is accessed. At block 3912E, the process sets the matching wall design or the empty wall object as the initial optimum solution. The use of an existing design, that had been produced via an optimization process, as a starting point may reduce the number of iterations needed (and the computer processing and memory resources utilized) to produce a final optimized design even if the current optimization process is different (e.g., improved or based on different module availability) as compared to the optimization process used to produce the previous optimized design being used as a starting point.

Changes in the optimization process may be the result of the utilization of artificial intelligence, such as machine learning. For example, the process may utilize a machine learning engine which monitors which wall designs (e.g., meeting a given set of criteria) are most frequently selected by users, or which have been manually designed by users, to train itself in determining which are preferred designs. The machine learning engine may utilize such information and training in optimizing wall designs. Changes in the optimization process may in addition or instead be the result of changes in available building modules. For example, if a previous design was optimized using only 1 foot long and 2 foot long wall modules, and a new 3 foot long wall module has since been introduced, the current optimization process may produce a different wall design using 3 foot long modules (possibly in addition to 1 foot and/or 2 foot long wall modules).

At block 3914E, an optimization score is calculated for the initial wall design. The optimization score may be a numerical score, where the higher the score the better the optimization, or where the lower the score the better optimization, depending on how the score is calculated. The score may be in the form of a letter score (e.g., A, B, C, D, . . . ), where the higher in the alphabet the better (e.g., A being the best score, B being the next best score, etc.). The optimization score may be based on one or more factors, and optionally, different optimization score equations may be used based on specific user preferences (e.g., which may be provided by the user via a user interface or inferred from a history of the user's selection of wall designs where alternative designs have been offered) and/or location. Thus, there may be a library of optimization score equations, and the process may select an optimization score equation based on one or more criteria (e.g., user preferences, location, component availability, etc.).

Example Optimization Criteria may include some or all of the following
A=Base Score is Length of Wall which may be multiplied by a first scaling factor (S₁)
B=Number of blocks which may be multiplied by a second scaling factor (S₂)
C=Number of blocks having a first length (e.g., number of 3 ft length blocks) which may be multiplied by a third scaling factor (S₃)
D=Number of blocks having a second length (e.g., number of 1 ft length blocks) which may be multiplied by a fourth scaling factor (S₄)
E=Number of blocks having the first length (e.g., 3 ft block length) on top course which may be multiplied by a fifth scaling factor (S₅)
F=Number of blocks having the first length (e.g., 3 ft block length) on bottom course which may be multiplied by a sixth scaling factor (S₆)
G=Number of blocks having the first length (e.g., 3 ft block length) on the end of all courses which may be multiplied by a seventh scaling factor (S₇)
H=Number of blocks having the second length (e.g., 1 ft block length) on the end of all courses which may be multiplied by an eighth scaling factor (S₈)

Optimization Score=S₁A−S₂B+S₃C−S₄D−S₅E+S₆F−S₇G+S₅H

(Note: Higher scores are better relative to lower scores in this example; all scaling factors may be 1, different scaling values may be used for different criteria, some scaling factors may be the same value while others may have different values).

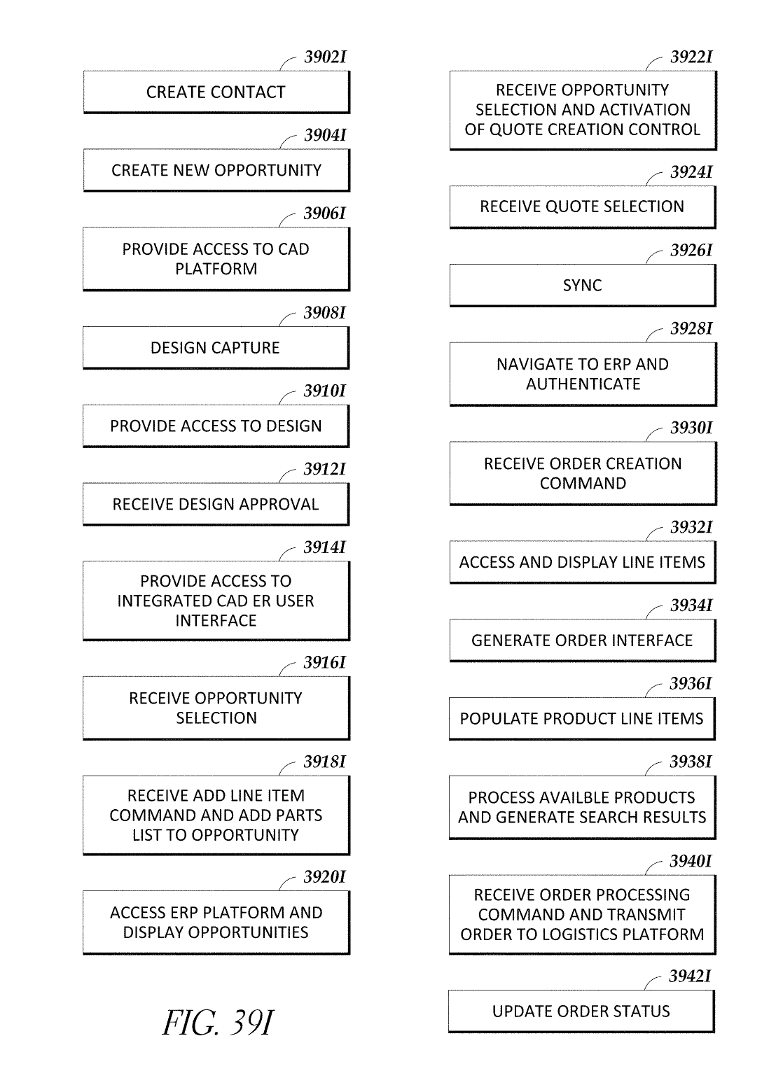

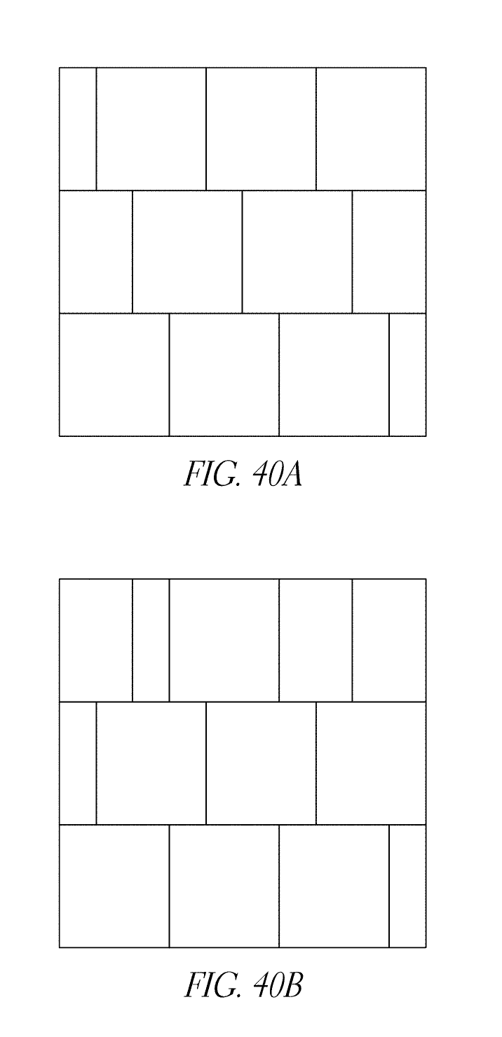

FIG. 40A illustrates an example wall design for Wall A with the following values:
A=10, B=12, C=8, D=2, E=3, F=3, G=2, H=2
If the scaling factors all have a value of 1, than the optimization score is as follows (using the example scoring formula above):

Wall A Optimization Score=10−12+8−2−3+3−2+2=4

FIG. 40B illustrates another example wall design for Wall B with the following values:

A=10, B=13, C=7, D=3, E=1, F=3, G=2, H=1
If the scaling factors all have a value of 1, than the optimization score is as follows (using the example scoring formula above):

Wall AB Optimization Score=10−13+7−3−1+3−3+1=1

Thus, the optimization process would select Wall A is selected over Wall B because Wall A has a better/higher optimization score.

By way of illustration, some users may express a preference for the use of smaller, easier to lift modules, and some users may express a preference for the use of the least number of modules to reduce the number of modules that need to be assembled.

Thus, for example, the optimization score equation may give better scores for those designs that use larger but fewer wall components (e.g., to reduce assembly time). By way of illustration, optionally the optimization score equation may assign a point for each wall module used in the design, where a lower score is a better score. By way of yet further example, the optimization score equation may generate a better score for a design that uses the more smaller modules (e.g., 1 foot long modules).

By way of further example, the optimization score equation may generate a better score for a design that uses the most larger modules (e.g., 3 foot long modules) on a bottom course, the most medium size modules (e.g., 2 foot long modules) on a second course, and the most small modules on the third course (e.g., 1 foot long modules), to balance the desire for fewest number of modules with the desire to reduce the number of heavy modules that need to be lifted to higher course. By way of still further example, users at different locations (e.g., in different states or in different countries) may tend to have different preferences with respect to module size, and hence different equations may be used based on a user's location (e.g., as determined from user registration information, from a user terminal IP address, or otherwise).

At block 3916E, the number of needed modules is calculated based at least in part on the wall height and length. At block 3918E, the solution count is set to zero (to indicate that a wall design solution has not yet been calculated by the current instance of the optimization process). At block 3920E, a determination is made as to whether the solution count is less than the specified maximum number of solutions. If the solution count is equal to (or greater than) than the specified maximum number of solutions, then at block 3922E, the process returns the wall design solution currently designated as the optimum wall design solution.

If the solution count is less than the specified maximum number of solutions, then the process, at block 3924E, generates a wall design via a build wall sub-process. The build wall sub-process is discussed greater detail below. At block 3926E, a determination is made as to whether the build wall sub-process successfully generated a wall design. If not, the process proceeds to block 3924E, and another attempt is made to successfully generate a wall design. If the build wall sub-process is successful, the resulting wall design is stored in memory, and, at block 3928E, the solution count is incremented (to indicate another wall design solution has been generated).

At block 3930E, the generated wall design solution is designated as the new wall. At block 3932E, an optimization score is calculated for the new wall design solution, as similarly discussed above with respect to block 3914E. The optimization score calculated for the new wall design solution may be stored in association with the new wall design solution for later access. At block 3934E, a determination is made as to whether the new wall optimization score is better than (e.g., greater than or less than depending on whether a better score is a higher score or a better score is a lower score) the optimization score for the optimum wall calculated at block 3914E. If the new wall optimization score is better than the optimization score for the currently designated optimum wall, then the new wall design solution is designated as the optimum wall design solution and the previous wall designated as the optimum wall design solution may have that designation removed. If the new wall optimization score is worse than the optimization score for the optimum wall, then the process proceeds back to block 3902E.

Optionally, the process generates a ranked set of design solutions, where the ranking is based at least in part on their respective optimization scores. The ranked set of solutions, including respective solution scores, may be provided to the user via the user terminal, and the user may select a design, which will then be designated as the selected design. Information regarding a selected design may be presented to the user (e.g., the number of parts, the area on one side of the wall, other information discussed herein, and the like).

FIG. 39F illustrates an example build wall process, which may correspond to block 3924E in FIG. 39E and may be a sub-process of the process illustrated in FIG. 39E. The process begins at block 3902F. At block 3904F, the process inputs various wall criteria that design needs to comply with. For example, the process may input a wall height (e.g., as specified by the user via a user interface as described elsewhere herein), a wall length (e.g., as specified by the user via a user interface as described elsewhere herein), blocks/modules/empty spaces with non-adjustable positions (sometimes referred to herein as “required blocks”), and the inventory of available modules of respective module types (e.g., 3 foot long wall modules, 2 foot long wall modules, 1 foot long wall modules). Available inventory may include those modules that are actually already manufactured and not yet purchased by a user or not currently on hold (e.g., used in a current user design that has not yet been purchased, where optionally modules in a user design may be held for specified period of time, such as 4 hours, 24 hours, 48 hours, etc.). Available inventory may also optionally include those modules that will become available (e.g., will be manufactured) within a threshold period of time (e.g., within 2 days, 4, days, 1 week, or other threshold time period) relative to the current time.

As similarly discussed above, a required block may be a door module or open space (e.g., which may be used for a user-supplied component) which the user has specified is to be at a certain position in the wall (e.g., where the required block position may be specified using multiple xy positions (e.g., an xy position for respective corners of a square or rectangular “reserved” area, provided numerically or graphically)). The example build wall process may design the wall around such required blocks, without changing the position of the required blocks.

At block 3906F, a determination is made as to whether the user has specified any required blocks (e.g., by determining whether a required blocks list or other data organization is empty or not). If the user has specified one or more required blocks, at block 3908F, the positioning information for a first listed block in the required block list is accessed, and at block 3910F, the first listed block is removed from the required block list and the first listed block is placed at the designated position specified by the user. The next block (if any) in the required blocks list becomes the first block, and the required block placement process is repeated until a determination is made at block 3906F that the required blocks list is empty.

At block 3914F, the course (sometimes referred to as a row or level) heights are determined via a course height determination process. Optionally, different courses may have different heights. The course heights are calculated using the wall height and the height of available wall module types. If different heights of modules are being used, the tallest height may be assigned to the lowest course and the smallest height course may be assigned to the highest course (e.g., to so that smaller, easier to lift modules are used for the highest course). For example, if the wall height is 108 inches, and the available wall module types have heights of 40 inches and 28 inches, the course height determination process may determine that the two bottom most courses shall each have a height of 40 inches, and that the third, topmost course, shall have a height of 28 inches.

At block 3916F, a determination is made as to whether all courses for the wall have been designed. For example, the determination may be made by comparing the number of courses designed versus the number of courses as determined at block 3914F, and if the number of courses designed is less than the number of courses as determined at block 3914F, then a determination is made that all the wall courses have not been designed. If all the courses have not been designed, the process proceeds to block 3924F, and the next not-yet-designed course is selected for design. For example, the first course to be designed may be the bottommost course, the next course to be designed may be the second course from the bottom, and so on. Optionally instead, the first course to be designed may be the topmost course, the next course to be designed may be the second course from the top, and so on.

At block 3926F, the selected course is designed. The course design may be performed using the build course sub-process illustrated in FIG. 39G, discussed in greater detail below. At block 3938F, a determination is made as to whether the course design was successful. If the course design was not successful, the process proceeds to block 392F, and a failure indication is returned.

If, at block 3916F, a determination is made that all the wall courses have been designed, at block 3918F, a determination is made as to whether the wall has any open locations (excluding required blocks) that were not successfully filled during course design. If there are no open locations, the process returns a success indication at block 3920F. If there are open locations, the process returns a failure indication at block 3922F.

FIG. 39G illustrates an example build course process, which may correspond to block 3926F in FIG. 39F and may be a sub-process of the process illustrated in FIG. 39F. The process begins at block 3902G. At block 3904G, the process inputs various criteria that design needs to comply with as similarly discussed above with respect to FIG. 39F. For example, the process may input a course height, a wall length, blocks/modules/empty spaces with non-adjustable positions (required blocks), and the inventory of available modules of respective module types (e.g., 3 foot long wall modules, 2 foot long wall modules, 1 foot long wall modules). Initially, any required blocks are placed at their respective specified locations.

At block 3908G, a determination is made as to whether there are any open locations along the course (where a required block location is not considered an open location). If there are no open course locations, at block 3910G a success indication is returned. If there are open locations, at block 3912G, a first open location is identified (e.g., the corresponding x or xy position of the beginning of the open location and/or the corresponding x or xy position of the end of the open location). Optionally, the process will identify the first open location starting from the left side of the course. Optionally instead, the process will identify the first open location starting from the right side of the course. Optionally instead, the process will identify the first open location starting at the middle of the course and proceeding first leftward to the left end, and then from the middle proceeding rightward to the right end.

At block 3914G, a module type (having a specified length, width, and height) is selected from inventory. The module type may be selected randomly, or the module type may be selected based on a priority assigned to the module type and recorded in association with the module type. Different priorities may be assigned for a given block type based on the course-type, where the optional process may attempt to place a higher priority module before trying to place a lower priority module. For example, if the course-type is the bottom course, then longer modules may be assigned a higher priority than shorter modules so as to increase the chances that the bottom course will be composed of longer courses (which means there will be relatively fewer modules that need be assembled to form the course). By way of further example, if the course-type is a course above a certain height (or not the bottom course), then shorter modules may be assigned a higher priority than longer modules so as to increase the chances that the course will be composed of shorter, lighter modules which are easier to handle and lift to place on the higher course.

At block 3916G, the selected module type is placed at the identified open location. The module placement may be performed using the module placement sub-process illustrated in FIG. 39H, discussed in greater detail below. At block 3918G, a determination is made as to whether the selected module type was successfully placed. If the selected module type is successfully placed, then corresponding location is marked as not empty, and the inventory of such modules types is correspondingly decremented. If the module type was not successfully placed, the process proceeds back to block 3908G, and another attempt may be made to find a module type that can be successfully placed in the open location.

FIG. 39H illustrates an example module placement process, which may correspond to block 3916G in FIG. 39G and may be a sub-process of the process illustrated in FIG. 39G. The process begins at block 3902H. At block 3904H, the process inputs various criteria that design needs to comply with. For example, the process may input a location of the open course location to be filled (e.g., the corresponding x or xy position of the beginning of the open location and/or the corresponding x or xy position of the end of the open location), the module type height (e.g., of the module selected via block 3914G in FIG. 39G), the module type width, whether the module type has a frame (e.g., if the module is a window unit or door unit the module may include a frame which increases the size of the unit), type of module (e.g., standard wall module, door unit, window unit, required block, etc.), course height, open location length, and the like.

At block 3906H, a determination is made as to whether the selected module fits into the available length of the open course location. For example, the length of the open location may be determined (e.g., by subtracting the x-position of the open location start from the x-position of the open location end) and may be compared with the length of the selected module type. Optionally, the following formula may be used to determine if the selected module fits into the available length of the open course location:

If module length is≤length of the open location, then module fits open location

If module length is>length of the open location, then module does not fit open location

At block 3908H, a determination is made as to whether the module fits the available height of course. For example, optionally, the following formula may be used to determine if the selected module fits into the available height of the open course location:

If module height is=height of the open location, then module fits open location

If module length is≠height of the open location, then module does not fit open location

Optionally, instead, the following formula may be used to determine if the selected module fits into the available height of the open course location:

If module height is≤height of the open location, then module fits open location

If module length is>height of the open location, then module does not fit open location

Optionally, a determination is made at block 3910H, as to whether the placement of the selected module will cause a vertical seam with respect to a module in an adjacent course (e.g., immediately above or below the current course). In some instances, such a vertical seams may be undesirable from a visual, cosmetic perspective and/or from a structural perspective. If a determination is made that a vertical seam has not been formed, the process proceeds to block 3912H, and a success indication is returned. If determinations are made that the selected module does not fit into the open location length, or does not first in the available course height, or optionally if the placement creates a vertical seam, a failure indication may be returned.

FIG. 39I illustrates an example process for managing and processing an order, including designing a structure for a customer. Example user interfaces will also be described that advantageously provide data and controls that inhibit user errors and that display data in an efficient, clear manner.

At block 3902I and with reference to the example user interface illustrated in FIG. 38L-a, a user may create a contact for an account (to be associated with the order) within an Enterprise Resource Planning (ERP)/Customer Relationship Management (CRM) platform (e.g., the SALESFORCE platform). For example, the user may enter a contact name, title, email address, is created, the ERP platform stores the new contact in memory, and enables the phone number, etc. into corresponding fields of a contact user interface. When the new contact to be displayed in a Contacts section of the user interface. The Contacts section may display the contact name, contact title, contact email address, and contact phone number. Optionally, the Contacts section may be presented at the same time as an Opportunities section that lists existing opportunities, including the opportunity name, stage (e.g., demo, cancelled, closed-lost, etc.), dollar amount of the opportunity, and close date.

A “new opportunity” control may be provided via which the user can create a new opportunity record, as discussed below. An Open Activities section may also optionally be displayed that lists open activities. The Open Activities section may optionally include a new task control, which may be activated to access a new task user interface and to define a new task. The Open Activities section may optionally include a new event control, which may be activated to access a new event user interface and to define a new event.

At block 3904I, the user can create a new opportunity (e.g., an order) to be associated with the contact. With reference to the example user interface illustrated in FIG. 38L-b, the user may activate a New Opportunity control, and provide, via fields of an Opportunities creation user interface, associated opportunity information (e.g., name, stage, amount, close date), which will be recorded by the ERP application. The Opportunities creation user interface may further enable the user to add related files, notes, case records, and activities. For example, the user may receive structure specifications from the customer (e.g., dimensions, skins, materials, etc.) in the form of an email, text file, or other document, which may be stored in association with the opportunity record.

At block 3906I and with reference to the example user interface illustrated in FIG. 38L-c, the user may then access the CAD application (e.g., by navigating a browser to a URL of the CAD application). The CAD application may optionally authenticate the user (e.g., via a user ID and password received via a login user interface, via a biometric sensor reading, etc.). At block 3908I, the user may then utilize the CAD application to design the structure. At block 3910I, the user may submit the design to the customer for approval. The submission may include 2D renderings, 3D renderings, animations, VR formatted presentations, AR formatted presentations, parts lists, quotes, and/or other data and depictions discussed herein. At block 3912I, approval may be received from the customer (e.g., via activation of an approval control, an email, text message, a voice call, and/or otherwise).

At block 3914I and with reference to the example user interface illustrated in FIG. 38L-d, the user may (e.g., after receipt of the approval), navigate to the design on the CAD system. The CAD system may be integrated with the ERP system, so that a select opportunity user interface is provided via which the user can select the opportunity that was recorded in the ERP system. In addition, optionally, at the same time as the select opportunity user interface is displayed, a CAD interface may be displayed (e.g., in the form of tabs or a menu) via which the user can access a wall details user interface, a wall list user interface, a plan details user interface, and/or a “my plans” user interface (that lists the plans associated with the user).

A drop down menu may be presented listing available opportunities on the ERP system, and a filter user interface may be provided via which the user can filter the displayed opportunities (e.g., by typing characters in a filter field, wherein the drop down menu will only display opportunities that match the types in characters). The user may then select a presented opportunity and activate a select opportunity control to access the opportunity.

At block 3918I, and with reference to the example user interface illustrated in FIG. 38L-e, the user may then activate an “add line item” control, and the parts list and associated costs will be added to the selected opportunity (e.g., based on the square footage for the plan accessed from the CAD application). A given line item may include an item name/identifier, a quantity, a unit price, and a total price (e.g., unit price multiplied by quantity). The line items may then be presented in association with the opportunity.

Advantageously, to provide enhanced context for the line item and to facilitate the identification of errors, the line item may be displayed at the same time as the plan specification. By way of example, the plan specification for a structure may optionally include a listing of the plan name, plan notes, an identifier associated with the plan creator, the total linear feet of the structure in the plan, the total area of the structure walls (e.g., in square feet for one side of each wall), the total area of the modules (e.g., in square feet for one side of each module) used to create the structure (including the structure walls), and skin information (e.g., an identifier for any skins included in the plan, total square footage of the skins, total square footage of any skin overage, etc.).

In addition, optionally at the same time the line item user interface and plan specifications are displayed, a part lists for the structure may be displayed. For example, the parts list may include part names/descriptions for each part and the quantities for each part. Optionally, a graphic rendition of the planned structure or portions thereof (e.g., the walls and/or other components) may be rendered at the same time. The graphic rendition may include metadata, such as an identifier and dimensions (e.g., length and height of each wall and/or module).

The line items may be displayed in association with delete controls, wherein a user can delete a line item from the opportunity, as illustrated in FIG. 38L-f.

At block 3920I and with reference to the example user interface illustrated in FIG. 38L-g, the user may navigate to the ERP application, and access the opportunity, which will include the added opportunity line items. For example, the user interface may present each product included in the opportunity, the quantity of each product, the sales price of each product, the total price for a given product-type, a list price for each product, and/or a product code for each product.

Advantageously, the user interface may also display contacts associated with the opportunity (e.g., contact name, account name, contact email address, contact phone number, and role or title). In addition, optionally the user interface presents a listing of existing quotes (e.g., including quote number, quote name, expiration date, subtotal price, total price, shipping and handling, tax, who created the quote, and/or status (e.g., accepted, draft, etc.)). Controls may be provided that enable a user to edit or delete the contact, one or more products, and/or one or more quotes. Controls may be provided that enable the user to create a new contact, add a product, choose a price book, or sort a listing. In addition, a new quote control may be provided which enables a user to generate a new quote.

At block 3922I and with reference to the example user interface illustrated in FIG. 38L-h, the user can select an opportunity and activate a create quote control (e.g., a “New Quote” control). If there are blank fields (e.g., quote name, shipping and handling, etc.), the user can provide the data for such fields. At block 3924I and with reference to the example user interface illustrated in FIG. 38L-i, a link (e.g., a URL) to the corresponding plan may be included in the quote and/or may be otherwise shared.

At block 3924I and with reference to the example user interface illustrated in FIG. 38L-i, the user can select a plan quote from a quote listing (e.g., by clinking on a quote name/number which links to the actual quote), and a corresponding quote information user interface may be presented. For example, the quote information may include a quote number, ERP (Enterprise Resource Planning) order reference number, quote name, opportunity name, account name, description, notes, industry, expiration date, status (e.g., accepted, pending, cancelled), payment terms (e.g., the amount of deposit), a link to the CAD plan corresponding to the opportunity, a desired delivery date, delivery hours, an indication as to whether there is a loading dock or forklift at the delivery destination, and/or an indication as to whether inside delivery is needed. Quote save and cancel controls may be provided that enable a user to save or cancel a quote, respectively. As illustrated in FIG. 38L-j, if the customer has accepted the quote, the user may select a status, via the status field, of “accepted.”

At block 3926I and with reference to the example user interface illustrated in FIG. 38L-k, the user can the sync the accepted quote to the opportunity by activating a sync control which enables the quote data to be tracked by the ERP platform.

At block 3928I, the user may navigate to an ERP system interface at a corresponding URL. The user may be authenticated (e.g., via user ID, password, biometric sensor reading, or otherwise). At block 3930I and with reference to the example user interface illustrated in FIG. 38L-1, the user may navigate (e.g., by selecting an orders tab) to an orders user interface (which may list existing orders, including order identifiers, total amounts, company name, industry, production status, and/or invoice status), and may activate a “Create New Order” control.

At block 3932I and with reference to the example user interface illustrated in FIG. 38L-m, the user is navigated to the order. The user may select the “Accepted Quote/Invoice” user interface (E.g., by selecting a corresponding tab), and invoice line items may be displayed, as illustrated in FIG. 38L-n. An add control may be provided via which the user may add the accepted quote by quote name. An interface may be presented via which the user may enter the accepted quote name from the ERP platform opportunity.

After the opportunity name is entered, a list of accepted quotes may be presented. The user may select a quote, and the user interface will be populated with the quote information from the ERP system. The user may then review the form, ensure that the fields are appropriately filled out, and save the order as a draft order by activating a “Save Draft Order”, as illustrated in FIG. 38L-o. After reviewing the generated invoice, the user may submit the order for invoicing to the invoicing application by activating a “Submit Order For Invoicing” control. The invoice may be automatically sent to the customer (e.g., as an electronic file via email) or a user may manually initiate the transmission of the invoice as described below. At block 3934I, in response to the submission of the invoice, the order user interface may be presented, an example of which is illustrated in FIG. 38L-p. The order user interface may list a plurality of orders with associated order number, total amount of order, customer name, project-type/industry, production status (e.g., draft, processing, completed, etc.), and indication as to payment status (e.g., not invoiced, down payment requested, down payment received, payment complete, etc.).

When the user is ready to have the invoice transmitted by the system, the user may return to the user interface illustrated in FIG. 38L-m, and select a production tab, as illustrated in FIG. 38L-q. At block 3936I, product line items may be populated by activating an “Add wall builder Plans by Name” and the user enter the name of the corresponding plan, as illustrated in FIG. 38L-r. Optionally, the user may access a list of available plans and select a corresponding plan. Optionally, as the user types in characters of a plan name, the process incrementally, in real time, filters the displayed plans to those that match the characters. The user may select the desired plan and the process will populate production line items using the selected plan. The user can also add products by activating an Add Product by Name control.

At block 3938I, a search field user interface may be provided that enables the user to search for products available for production. The user can select one or more products ready for production and add the selected products to a production line for manufacturing. Once the user has selected the desired items for product, the user may activate the “Save Draft Order” to save the selections. At block 3940I, and with reference to the user interface illustrated in FIG. 38L-s, the user may activate a “Submit Order For Processing” control and the order is transmitted to a logistics application, tracking application, and production system for processing. At block 3942I and as illustrated in FIG. 38L-t, the ERP platform updates changes in order status periodically (e.g., once a minute, once an hour, etc.) and/or in response to detecting a status change, and may provide status updates to designated users.

Optionally, the weight of a given order (or a portion thereof) may be determined by weighing some or all of the components included in the order. For example, one or more components or an entire order may be weighed utilizing one or more specialized scales. For example, the weighing me be performed utilizing platform, drum, floor, and/or bench scales.

Optionally, a shipping algorithm may be utilized to estimate the weight and/or shipping cost of an order or a portion thereof. The shipping algorithm may utilize historical information, such as historical shipments, where the shipment weight (e.g., as determined utilizing a specialized scale such as those disclosed herein) is correlated to shipment cost on a cost/unit weight basis (e.g., a dollar per pound basis, a Euro to kilogram basis, etc.). By using a large enough data set and assuming uniformly distributed delivery locations, the estimated shipping cost becomes independent of destination and is instead primarily a function of shipment weight of core materials (e.g., block, panels, etc.) included in orders, even taking into account the pallets and packaging materials. Thus, for example, the shipping cost may be estimated utilizing the following derived equation:

Y=((5.2*x̂−0.425+0.03)*x)*0.95

where, Y is the shipping cost is U.S. dollars, and x is the shipment weight in pounds.

When items other than core materials are shipped to a customer (which may include such materials as insulation, doors, local lumber, etc.), further equations and boundary conditions are included in the algorithm to represent the additional shipping charges from those individual deliveries. When added together, the result is a blended shipping cost estimate that can be quoted (e.g., by the system or a sales representative) without needing a fully accurate live quote from a supply chain department for each customer quote. The final true shipping cost may differ from the cost estimate but such difference is typically within an acceptable margin of error.

For example, the following equation may be utilized to estimate the shipping cost for insulation:

y=20.786x−0.477

where, Y is the shipping cost is U.S. dollars, and x is the shipment weight in pounds.

A flat charge may be made for certain items included in an order (e.g., for end caps, trim, skins, acoustic panels, etc.).

Thus, techniques are described herein that address the challenges posed by modular construction systems. Systems and methods are described relating to the design of safe construction of structures using modular building units, and providing for the efficient use of modular building units to reduce wasted materials and the amount of materials that needs to be shipped. It is understood that aspects of the foregoing disclosure are not limited for use in designing walls, but may be used in designing other types of structures or designs using modular and/or non-modular components.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integer to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the phrase “click” may be used with respect to a user selecting a control, menu selection, or the like, other user inputs may be used, such as voice commands, text entry, gestures, etc. User inputs may, by way of example, be provided via an interface or in response to a prompt (e.g., a voice or text prompt). By way of example an interface may include text fields, wherein a user provides input by entering text into the field. By way of further example, a user input may be received via a menu selection (e.g., a drop down menu, a list or other arrangement via which the user can check via a check box or otherwise make a selection or selections, a group of individually selectable icons, a menu selection made via an interactive voice response system, etc.). When the user provides an input or activates a control, a corresponding computing system may perform a corresponding operation (e.g., store the user input, process the user input, provide a response to the user input, etc.). Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise.

The user terminals described herein may be in the form of a mobile communication device (e.g., a cell phone, a VoIP equipped mobile device, etc.), laptop, tablet computer, interactive television, game console, media streaming device, head-wearable display, virtual reality display/headset, augmented reality display/headset, networked watch, etc. The user terminals may optionally include displays, user input devices (e.g., touchscreen, keyboard, mouse, voice recognition, etc.), network interfaces, etc.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

What is claimed is:

1. A computer-implemented method of designing a structure, the method comprising:
providing, by a computer aided design (CAD) system comprising hardware, a user interface comprising:
a wall drawing tool;
a window module placement tool;
a door unit placement tool;
a working area;
detecting a user selection of the wall drawing tool;
detecting a user start wall indication provided at a first coordinate in the work area;
detecting a user end wall indication provided at a second coordinate in the work area;
causing a wall to be drawn in the work area between the first coordinate and the second coordinate;
accessing a wall height;
accessing dimensional information for a plurality of pre-defined wall module types having predefined dimensions, including a first wall module type having a first length and a second wall module type having a second length;
selecting and determining positioning of one or more wall module types from the pre-defined wall module types to provide a model of an assembly of the wall with the accessed wall height;
generating a rendering of the model of the assembly for the wall, the rendering of the model of the assembly indicating the position of the selected module-types used to form the drawn wall;
generating a parts list comprising a quantity of each of the selected module-types; and
enabling the parts list to be utilized to package and ship parts in the parts list.

2. The method as defined in claim 1, the method further comprising:
accessing data regarding a first structure;
causing a three dimensional rendering of the first structure and a three dimensional rendering of the wall within the rendering of the first structure to be displayed for a first viewpoint; and
enabling the user to modify change the viewpoint from the first viewpoint to a second viewpoint.

3. The method as defined in claim 1, the method further comprising:
providing, using an augmented reality headset or a virtual reality headset, a three dimensional rendering of the wall from a first viewpoint; and
dynamically changing the viewpoint in response to detecting a head movement of the user.

4. The method as defined in claim 1, the method further comprising:
accessing data regarding a first structure;
causing a three dimensional rendering of the first structure to be displayed;
generating an animation of an assembly process for the wall; and
causing the animation of the assembly process for the wall to be rendered within the three dimensional rendering of the first structure.

5. The method as defined in claim 1, the method further comprising:
generating a rendering of an assembly of at least a first wall module, including an orientation of a plurality of blocks comprising connector members,
wherein the rending renders at least a first block having connector members positioned upwards, and a second block having connector members pointing downwards.

6. The method as defined in claim 1, wherein the accessed wall height was selected by the user from a menu of a plurality of wall heights.

7. The method as defined in claim 1, the method further comprising:
determining how many internal seams are present on corresponding wall courses;
based at least in part on the determination as to how many internal seams are present on corresponding wall courses, determining a first quantity of clips configured to interconnect wall modules,
wherein the parts lists comprises the first quantity of clips.

8. The method as defined in claim 1, the method further comprising:
receiving a user addition of a first window on the wall;
receiving a user addition of a second window on the wall;
determining that the relative placements of the first window and the second window violates a first rule; and
providing a visual indication regarding the violation of the first user.

9. The method as defined in claim 1, the method further comprising:
receiving a change in wall height from the user;
re-selecting and re-determining positioning of one or more wall module types from the pre-defined wall module types to provide a rendering of a model of an assembly of the wall with the changed wall height; and
generating a second parts list comprising a quantity of each of the selected module-types for the model of the assembly of the wall with the changed wall height.

10. The method as defined in claim 1, the method further comprising:
detecting a user selection of the window tool;
detecting a user indicated position for a window module on the drawn wall;
re-selecting and re-determining positioning of one or more wall module types from the pre-defined wall module types to provide a model of an assembly of the wall with the window module; and
using the re-selection of one or more wall module types, generating a second parts list.

11. The method as defined in claim 1, wherein a given wall module comprises a plurality of blocks to which panels are to be affixed, the method further comprising:
generating a first optimization score equation for the model of the assembly of the wall based on criteria comprising: how many blocks are included in the wall, and a quantity of blocks having a first length and a quantity of blocks having a second length;
generating a second optimization score equation for a second model of the assembly of the based on criteria comprising: how many blocks are included in the wall, and a quantity of blocks having a first length and a quantity of blocks having a second length;
determining whether the first model or the second model has the better optimization score; and
identifying the model having the better optimization score.

12. The method as defined in claim 1, the method further comprising:
accessing inventory information for the pre-defined wall module types; and
excluding pre-defined wall module types that have a first inventory status from the acts of selecting and determining positioning of one or more wall module types from the pre-defined wall module types to provide a model of an assembly of the drawn wall with the accessed wall height.

13. The method as defined in claim 1, the method further comprising:
providing a user interface enabling the user to select a material for at least one module component; and
causing the parts list to indicate the selected material.

14. The method as defined in claim 1, the method further comprising:
providing a user interface enabling the user to select a wall module skin; and
causing the skin to be rendered on a rendering of the wall.

15. The method as defined in claim 1, the method further comprising:
providing a user interface enabling the user to indicate whether a cleat component is needed;
providing a user interface enabling the user to indicate whether a levelling assembly is needed;
providing a user interface enabling the user to indicate whether a cap component is needed;
receiving user indications as to whether a cleat component, a levelling assembly, and/or a cap component are needed; and
causing the parts list to indicate the user indications as to whether a cleat component, a levelling assembly, and/or a cap component are needed.

16. The method as defined in claim 1, the method further comprising:
generating a first identifier for the wall;
rendering a second wall in response to the user drawing the second wall;
generating a second identifier for the second wall;
displaying the first identifier in association with the wall and displaying the second identifier in association with the second wall.

17. The method as defined in claim 1, the method further comprising:
accessing opportunity data from an enterprise resource system;
displaying the opportunity data from the enterprise resource system at the same time as displaying a wall details user interface of the computer aided design system.

18. A computer-implemented method of designing a structure, the method comprising:
providing, by a computer system comprising hardware, a user interface comprising:
a wall drawing tool;
a working area;
detecting a user selection of the wall drawing tool;
detecting a user start wall indication provided at a first coordinate in the work area;
detecting a user end wall indication provided at a second coordinate in the work area;
causing a wall to be drawn between the first coordinate and the second coordinate;
accessing a wall height;
accessing dimensional information for a plurality of pre-defined wall module types having predefined dimensions, including a first wall module type having a first length and a second wall module type having a second length;
selecting and determining positioning of one or more wall module types from the pre-defined wall module types to provide a model of an assembly of the drawn wall with the accessed wall height;
generating a drawing of the model of the assembly for the drawn wall, the drawing of the model of the assembly indicating the position of the selected module-types used to form the drawn wall; and
generating a parts list comprising a quantity of each of the selected module-types.

19. The method as defined in claim 18, the method further comprising:
receiving a change in wall height;
re-selecting and re-determining positioning of one or more wall module types from the pre-defined wall module types to provide a model of an assembly of the drawn wall with the changed wall height; and
generating a second parts list comprising a quantity of each of the selected module-types for the model of the assembly of the drawn wall with the changed wall height.

20. The method as defined in claim 18, the method further comprising:
detecting a user selection of a door or window tool;
detecting a user indicated position for a door or window module on the drawn wall;
re-selecting and re-determining positioning of one or more wall module types from the pre-defined wall module types to provide a model of an assembly of the drawn wall with the door or window module;
using the re-selection of one or more wall module types, generating a second parts list.

21. The method as defined in claim 18, the method further comprising:
determining how many internal seams are present on corresponding wall courses;
based at least in part on the determination as to how many internal seams are present on corresponding wall courses, determining a first quantity of clips configured to interconnect wall modules,
wherein the parts lists comprises the first quantity of clips.

22. The method as defined in claim 18, wherein a given wall module comprises a plurality of blocks to which panels are to be affixed, the method further comprising:
generating a first optimization score equation for the model of the assembly of the wall based on criteria comprising: how many blocks are included in the wall, and a quantity of blocks having a first length and a quantity of blocks having a second length;
generating a second optimization score equation for a second model of the assembly of the based on criteria comprising: how many blocks are included in the wall, and a quantity of blocks having a first length and a quantity of blocks having a second length;
determining whether the first model or the second model has the better optimization score; and
identifying the model having the better optimization score.

23. A system comprising:
at least one computing device;
non-transitory memory that stores program instructions that when executed by the at least one computing device cause the same system to perform operations comprising;
provide a user interface comprising:
a wall drawing tool;
a working area;
detect a user selection of the wall drawing tool;
detect a user drawing of a wall within the working area utilizing the wall drawing tool and cause the wall to be rendered within the working area;
access a wall height;
select one or more wall module types from a plurality of wall module types having one or more different dimensions and determine positioning of the selected wall module types;
generate a rendering of the wall utilizing the selected wall module types and determined wall module positions; and
generate a parts list comprising a quantity of each of the selected module-types.

24. The system as defined in claim 23, the operations further comprising:
determine how many internal seams are present on corresponding wall courses;
based at least in part on the determination as to how many internal seams are present on corresponding wall courses, determine a first quantity of clips configured to interconnect wall modules, wherein the parts lists comprises the first quantity of clips.

25. The system as defined in claim 23, the operations further comprising:
detect a user selection of the window tool;
detect a user indicated position for a window module on the drawn wall;
based at least in part on the user indicated position for the window module, perform a second selection of one or more wall module types and determine positioning of the second selection of one or more module types; and
using the second selection of one or more wall module types, generate a second parts list.

26. The system as defined in claim 23, wherein a given wall module comprises a plurality of blocks to which panels are to be affixed, the operations further comprising:
generating a first optimization score equation for the model of the assembly of the wall based on criteria comprising: how many blocks are included in the wall, and a quantity of blocks having a first length and a quantity of blocks having a second length;
generating a second optimization score equation for a second model of the assembly of the based on criteria comprising: how many blocks are included in the wall, and a quantity of blocks having a first length and a quantity of blocks having a second length;
determining whether the first model or the second model has the better optimization score; and
identifying the model having the better optimization score.

27. The system as defined in claim 23, the operations further comprising:
access data regarding a first structure;
cause a three dimensional rendering of the first structure to be displayed;
generate an animation of an assembly process for the wall; and
cause the animation of the assembly process for the wall to be rendered within the three dimensional rendering of the first structure.
